(19) United States
(12) Patent Application Publication
(10) Pub. No.: US 2008/0090694 A1
(43) Pub. Date: Apr. 17, 2008

(54) Torque transfer system, method of using the same, method of fabricating the same, and apparatus for monitoring the same

(75) Inventors: Richard J. Wise, Kelowna (CA); William R. Richards, Springfield, VA (US); Richard P. Snaider, Reston, VA (US); Howard L. Nevin, Ellicott City, MD (US)

Correspondence Address: MORGAN LEWIS & BOCKIUS LLP, 1111 PENNSYLVANIA AVENUE NW, WASHINGTON, DC, 20004, US

(73) Assignee: Magnetic Torque International, Ltd.

(21) Appl. No.: 11/580,303

(22) Filed: Oct. 13, 2006

(51) Int. Cl. F16H 13/12

(52) U.S. Cl. 476/11; 475/152

(57) ABSTRACT

A system for transferring torque includes a first rotary plate coupled to a first rotational shaft extending along a first axial direction from a first plane of rotation of the first rotary plate, and a second rotary plate coupled to a second rotational shaft disposed along a second axial direction from a second plane of rotation of the second rotary plate, the second rotary plate spaced apart from the first rotary plate, wherein the first rotary plate is magnetically coupled to the second rotary plate by a plurality of magnet holding members, such that the torque applied to the first rotational shaft is transferred to the second rotational shaft.

### BACKGROUND OF THE INVENTION

1. Field of the Invention

The present invention relates to a torque transfer system, a method of using a torque transfer system, a method of fabricating a torque transfer system, and an apparatus for monitoring a torque transfer system, and more particularly, to a system and a method for transferring torque between physically disconnected rotating shafts, a method of fabricating a torque transfer system for transferring torque between physically disconnected rotating shafts, and an apparatus for monitoring the system.

2. Discussion of the Related Art

In general, transmission of rotational motion is accomplished by coupling rotating shafts using a combination of physically connected members. For example, in order to transfer rotational motion from a first rotational shaft to a second rotational shaft, gears, belts, or chain members are connected to the first and second rotational shafts and mechanically interconnected. However, due to mechanical friction between the mechanically interconnected members, significant amounts of heat are generated that causes premature failure of the mechanically interconnected members and increases costs and loss of productivity due to repairs. Moreover, although the mechanical friction may be reduced by supplying a lubricant to the mechanically interconnected members, operational speed of the interconnected members has a maximum upper limit, thereby severely limiting transfer of the rotational motion between the first and second rotational shafts.

Furthermore, alignment of the first and second rotational shafts must be maintained at all times in order to prevent any shearing stresses on the rotational shafts. In addition, any misalignment of the first and second rotational shafts will result in a transfer of corresponding shearing stresses to the interconnected members.

Finally, the interconnected members generate a significant amount of noise due to the mechanical interaction. Accordingly, by replacing the interconnected members with an improved system that is not mechanically interconnected, the noise may be significantly, if not completely, mitigated. Thus, the improved system may prevent the necessity of providing noise abatement materials or segregation from noise sensitive devices.

### SUMMARY OF THE INVENTION

Accordingly, the present invention is directed to a torque transfer system that substantially obviates one or more of the problems due to limitations and disadvantages of the related art.

An object of the present invention is to provide a system and method for transferring rotational motion and torque that prevents generation of noise, friction, and heat.

Another object of the present invention is to provide a system and method for improving the transferring of rotational motion and torque.

Another object of the present invention is to provide a method of fabricating a system for improving the transferring of rotational motion and torque.

Another object of the present invention is to provide a system and method for transferring rotational motion and torque that accommodates large amounts of shaft misalignment.

Another object of the present invention is to provide features for an in situ measurement of both torque and speed, through use of an auxiliary external sensor and by which allowing “health monitoring” of the drive train configuration.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system for transferring torque includes a first rotary plate coupled to a first rotational shaft extending along a first axial direction from a first plane of rotation of the first rotary plate, and a second rotary plate coupled to a second rotational shaft disposed along a second axial direction from a second plane of rotation of the second rotary plate, the second rotary plate spaced apart from the first rotary plate, wherein the first rotary plate is magnetically coupled to the second rotary plate by respective magnet holding members on each of the first rotary plate and the second rotary plate, such that the torque applied to the first rotational shaft is transferred to the second rotational shaft.

In another aspect, a torque transfer system includes a first rotary plate coupled to a first rotational shaft extending along a first axial direction from a first plane of rotation of the first rotary plate, the first rotary plate having a first plurality of magnet holding members extending from the first rotary plate, and a second rotary plate coupled to a second rotational shaft disposed along a second axial direction from a second plane of rotation of the second rotary plate, the second rotary plate having a second plurality of magnet holding members extending from the second rotary plate toward the first rotary plate, wherein the first and second rotary plates are spaced apart from each other with the first and second pluralities of magnet holding members interdigitated therebetween, and torque applied to the first rotational shaft is transferred to the second rotational shaft by repulsive magnetic forces between the first and second pluralities of magnet holding members.

In another aspect, a torque transfer system includes a first rotary assembly rotatable about a first rotational axis within a first plane of rotation, the first rotary assembly including a first plurality of magnets extending from the first plane of rotation, and a second rotary assembly rotatable about a second rotational axis within a second plane of rotation, the second rotary assembly including a second plurality of magnets extending from the second plane of rotation, wherein the first plurality of magnets are interdigitated with the second plurality of magnets in opposition to produce a plurality of repulsive magnet forces between each of the first and second pluralities of magnets.

In another aspect, a method of transferring motion between rotational shafts includes providing a first rotary plate coupled to a first rotational shaft extending along a first axial direction from a first plane of rotation of the first rotary plate, providing a second rotary plate coupled to a second rotational shaft disposed along a second axial direction, the second rotary plate spaced apart from the first rotary plate, and transferring torque from the first rotational shaft to the second rotational shaft by magnetically repulsive forces coupling magnets attached to the first rotary plate to the second rotary plate.

In another aspect, a method of transferring torque includes providing a first rotary plate attached to a first rotational shaft extending along a first axial direction from a first plane of rotation of the first rotary plate, the first rotary plate having a first plurality of magnet holding members extending from the first rotary plate parallel to the first axial direction, and providing a second rotary plate attached to a second rotational shaft disposed along a second axial direction from a second plane of rotation of the second rotary plate, the second rotary plate having a second plurality of magnet holding members extending from the second rotary plate toward the first rotary plate along the second axial direction, and placing the first and second rotary plates to be spaced apart from each other with the first and second pluralities of magnet holding members interdigitated therebetween, and magnetically transferring torque applied to the first rotational shaft is transferred to the second rotational shaft by repulsive magnetic forces between the first and second pluralities of magnet holding members.

In another aspect, a method of transferring torque includes rotating a first rotary assembly about a first rotational axis within a first plane of rotation, the first rotary assembly including a first plurality of magnets extending from the first plane of rotation, and providing a second rotary assembly rotatable about a second rotational axis within a second plane of rotation, the second rotary assembly including a second plurality of magnets extending from the second plane of rotation, wherein the first plurality of magnets are interdigitated with the second plurality of magnets in opposition to produce a plurality of repulsive magnet forces between the first and second pluralities of magnets to transfer the torque from the first rotary assembly to the second rotary assembly.

In another aspect, an apparatus for transferring torque includes a first plurality of magnets coupled to a first rotating shaft, the first plurality of magnets rotating within a first rotational plane, and a second plurality of magnets coupled to a second rotating shaft, the second plurality of magnets rotating within a second rotational plane, wherein the first and second plurality of magnets are interdigitated and have interacting, repulsive magnetic fields to transmit an input torque applied to the first rotating shaft as an output torque to the second rotating shaft.

In another aspect, a method of magnetically transferring rotation of a first shaft to a second shaft includes coupling magnetic fields of a first plurality of magnets attached to the first shaft to repulsive magnetic fields of a second plurality of magnets attached to the second shaft, and rotating the first shaft to cause rotation of the second shaft by the magnetic repulsive fields between the first plurality of magnets and the second plurality of magnets.

In another aspect, an apparatus for monitoring performance parameters of a system for transferring torque includes a sensor portion disposed adjacent to the system for transferring torque, the system including a first rotary plate coupled to a first rotational shaft extending along a first axial direction from a first plane of rotation of the first rotary plate and a second rotary plate coupled to a second rotational shaft disposed along a second axial direction from a second plane of rotation of the second rotary plate, the second rotary plate spaced apart from the first rotary plate, wherein the first rotary plate is magnetically coupled to the second rotary plate by respective magnet holding members on each of the first rotary plate and the second rotary plate, such that the torque applied to one of the first rotational shaft and the second rotational shaft is transferred to the other of the first rotational shaft and the second rotational shaft, a sensor signal processor conditioning and processing an output of the sensor, a calculator portion calculating performance parameters of the torque transfer system using the processed output of the sensor, and an output portion outputting the calculated output of the sensor, wherein the sensor measures a passing of the magnet holders as the first and second rotational shafts rotate.

In another aspect, a method of fabricating a system for transferring torque includes forming a first rotary plate having a first plurality of magnet holding members, each member extending from the first rotary plate along a first direction, coupling the first rotary plate to a first rotational shaft extending along a second direction opposite to the first direction, forming a second rotary plate having a second plurality of magnet holding members, each extending member extending from the second rotary plate along the second direction, coupling the second rotary plate to a second rotational shaft extending along the first direction, and assembling the first rotary plate with the second rotary plate using the magnetic forces of the first and second plurality of magnet holding members.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a plan view of an exemplary rotary plate according to the present invention;

FIGS. 2A-C are multiple views of a first exemplary magnet holding member according to the present invention;

FIGS. 3A-C are multiple views of a second exemplary magnet holding member according to the present invention;

FIGS. 4A-C are multiple views of a third exemplary magnet holding member according to the present invention;

FIGS. 5A-C are multiple views of a fourth exemplary magnet holding member according to the present invention;

FIGS. 6A-C are multiple views of a fifth exemplary magnet holding member according to the present invention;

FIG. 7 is a plan view of an exemplary rotary assembly according to the present invention;

FIG. 8 is a side view of an exemplary torque transfer system in a forward-convention mode of operation according to the present invention;

FIGS. 9A and 9B are side views of first and second exemplary relative assemblies according to the present invention;

FIG. 10 is a plan view of another exemplary rotary plate according to the present invention;

FIGS. 11A-C are multiple views of a sixth exemplary magnet holding member according to the present invention;

FIGS. 12A-C are multiple views of a seventh exemplary magnet holding member according to the present invention;

FIGS. 13A-C are multiple views of an eighth exemplary magnet holding member according to the present invention;

FIG. 14 is a plan view of another exemplary rotary assembly according to the present invention;

FIGS. 15A-C are various views of another exemplary torque transfer system in a forward-convention mode of operation according to the present invention;

FIGS. 16A-C are various views of another exemplary torque transfer system in a forward-convention mode of operation according to the present invention;

FIG. 17 is another exemplary torque transfer system in a reverse-convention mode of operation according to the present invention;

FIGS. 18A-C are multiple views of a ninth exemplary magnet holding member according to the present invention;

FIGS. 19A-C are multiple views of a tenth exemplary magnet holding member according to the present invention;

FIGS. 20A-C are multiple views of another exemplary torque transfer system in a reverse-convention mode of operation according to the present invention;

FIGS. 21A-C are multiple views of another exemplary torque transfer system in a reverse-convention mode of operation according to the present invention;

FIGS. 22A-C are multiple views of an eleventh exemplary magnet holding member according to the present invention;

FIGS. 23A-C are various exemplary magnet holding adapters according to the present invention;

FIGS. 24A-C are multiple views of a twelfth exemplary magnet holding member according to the present invention;

FIGS. 25A-C are various exemplary magnet holding adapters according to the present invention;

FIGS. 26A-C are multiple views of a thirteenth exemplary magnet holding member according to the present invention;

FIGS. 27A-D are various exemplary magnet holding adapters according to the present invention;

FIG. 28 is a side view of an exemplary torque transfer system operating in a first angular offset configuration in a forward-convention mode of operation according to the present invention;

FIG. 29 is a side view of another exemplary torque transfer system operating in a second angular misalignment configuration in a forward-convention mode of operation according to the present invention;

FIG. 30 is a side view of another exemplary torque transfer system operating in a third angular misalignment configuration in a forward-convention mode of operation according to the present invention;

FIG. 31 is a side view of an exemplary torque transfer system operating in a first parallel misalignment configuration in a forward-convention mode of operation according to the present invention;

FIG. 32 is a side view of an exemplary torque transfer system operating in a first angular misalignment and parallel misalignment configuration in a forward-convention mode of operation according to the present invention;

FIG. 33 is a side view of an exemplary torque transfer system operating in a second angular misalignment and parallel misalignment configuration in a forward-convention mode of operation according to the present invention;

FIG. 34 is a side view of an exemplary torque transfer system operating in a third angular misalignment and parallel misalignment configuration in a forward-convention mode of operation according to the present invention;

FIG. 35 is a side view of an exemplary torque transfer system operating in a first angular misalignment configuration in a reverse-convention mode of operation according to the present invention;

FIG. 36 is a side view of another exemplary torque transfer system operating in a second angular misalignment configuration in a reverse-convention mode of operation according to the present invention;

FIG. 37 is a side view of another exemplary torque transfer system operating in a third angular misalignment configuration in a reverse-convention mode of operation according to the present invention;

FIG. 38 is a side view of an exemplary torque transfer system operating in a first parallel misalignment configuration in a reverse-convention mode of operation according to the present invention;

FIG. 39 is a side view of an exemplary torque transfer system operating in a first angular misalignment and parallel misalignment configuration in a reverse-convention mode of operation according to the present invention;

FIG. 40 is a side view of an exemplary torque transfer system operating in a second angular misalignment and parallel misalignment configuration in a reverse-convention mode of operation according to the present invention;

FIG. 41 is a side view of an exemplary torque transfer system operating in a third angular misalignment and parallel misalignment configuration in a reverse-convention mode of operation according to the present invention;

FIG. 42 is a graphical representation of the magnetic flux density as a function of magnet separation during a forward-convention mode of operation of an exemplary torque transfer system according to the present invention;

FIG. 43 is a graphical representation of the magnetic flux density as a function of magnet separation during a reverse-convention mode of operation of an exemplary torque transfer system according to the present invention;

FIG. 44 is a schematic diagram of an exemplary monitoring system for a torque transfer system according to the present invention; and

FIG. 45 is a side view of another exemplary rotary assembly for a torque transfer system according to the present invention.

### DETAILED DESCRIPTION OF THE PREFERRED EMBODIMENTS

Reference will now be made in detail to the preferred embodiments of the present invention, examples of which are illustrated in the accompanying drawings.

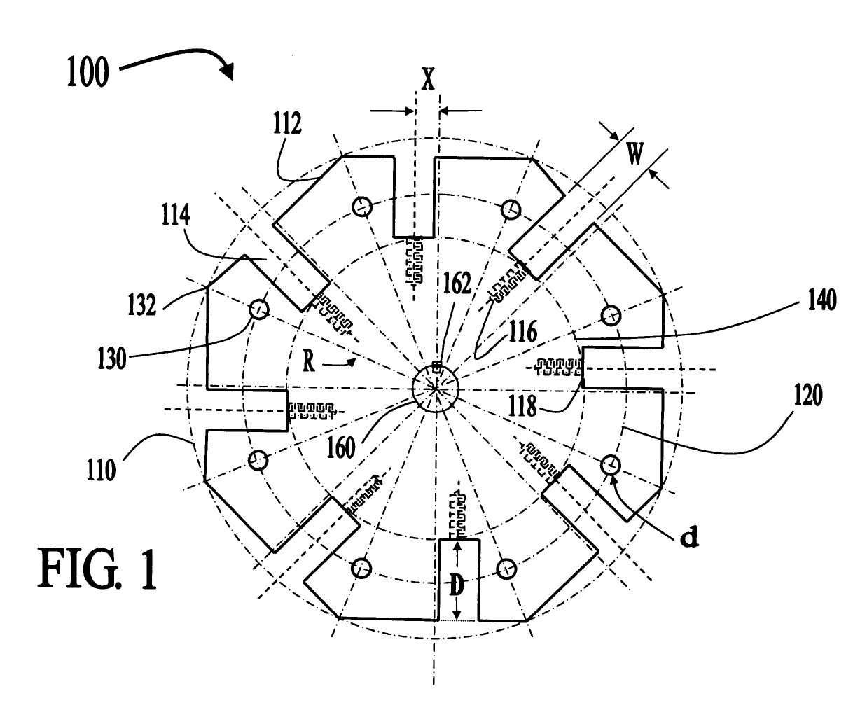

FIG. 1 is a plan view of an exemplary rotary plate according to the present invention. In FIG. 1, a rotary plate 100 may have a major diameter 110, a minor diameter 140, major outer surfaces 112, alignment holes 130, and a through hole 160. Each of the major outer surfaces 112 may include at least one channel region 114 that extends from the major outer surface 112 to the minor diameter 140 by a depth D. Accordingly, the channel regions 114 are radially disposed along the rotary plate 100 and are offset from the radius of the rotary plate 100 by a distance X, and each channel region may have a width W. In addition, the through hole 160 is disposed at a center of the rotary plate 100 and may include a keyway 162 for coupling to a rotational shaft (not shown).

In FIG. 1, each of the channel regions 114 include a threaded hole 116 extending from a bottom portion 118 of the channel region 114, and centered upon the bottom portion 118 of the channel region 114. The depth and size of the threaded hole 116 may be adjusted based upon the depth D and width W of the channel regions 114, as well as the size of the major and minor diameters 110 and 140 of the rotary plate 100.

In FIG. 1, although eight major surfaces 112 are shown, the rotary plate 100 may include more or less than eight major surfaces 112. In addition, although the rotary plate 100 may include relatively flat major surfaces 112, the rotary plate 100 may have a single circular major surface having the plurality of channel regions 114. Moreover, each of the eight major surfaces 112 of the rotary plate 100 may include more than one of the channel regions 114.

As shown in FIG. 1, the rotary plate 100 may include the plurality of alignment holes 130. These alignment holes 130 may facilitate alignment of the rotary plate 100 with another rotary plate, as will be detailed below. In addition, the alignment holes 130 may reduce the overall mass of the rotary plate along the major diameter 110, thereby reducing the moment of inertia of the rotary plate 100. Accordingly, the alignment holes 130 may be positioned between the major and minor diameters 110 and 140 of the rotary plate 100 along a diameter 120. Each of the alignment holes 130 may be disposed along a radial line R from a corner region 132 of the rotary plate 100 located between adjacent major surfaces 112.

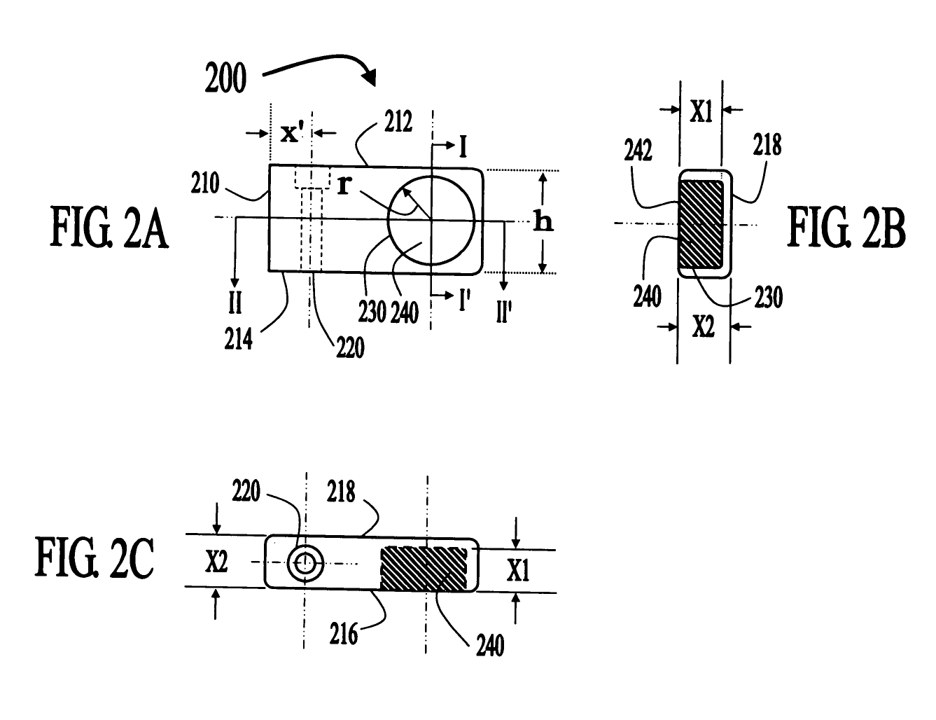

FIGS. 2A-C are multiple views of a first exemplary magnet holding member according to the present invention. FIG. 2A is a side view of the first exemplary magnet holding member, FIG. 2B is a cross sectional view of the first exemplary magnet holding member of FIG. 2A along I-I′, and FIG. 2C is a cross sectional view of the first exemplary magnet holding member of FIG. 2A along II-II′.

In FIG. 2A, a first exemplary magnet holding member 200 may include a body portion 210 including a through hole 220 disposed at a distance x′ from the first end of the body portion 210 extending from a first surface 212 of the body portion 210 to a second surface 214 of the body portion 210, and through a thickness h of the body portion 210. In addition, the body portion 210 may include a magnet mounting portion 230 disposed at a second end of the body portion 210 opposite to the first end of the body portion 210.

As shown in FIGS. 2B and 2C, the magnet mounting portion 230 of the body portion 210 extends from a third surface 216 into the body portion 210 by a distance X1 that is less than a thickness X2 of the body portion 210, and does not extend completely through to a fourth surface 218 of the body portion 210. Accordingly, when a circular magnet 240 having a radius r is mounted into the magnet mounting portion 230 of the body portion 210, an outer surface 242 (i.e., exposed surface) of the circular magnet 240 may be substantially flush (coplanar) with the third surface 216 of the body portion 210.

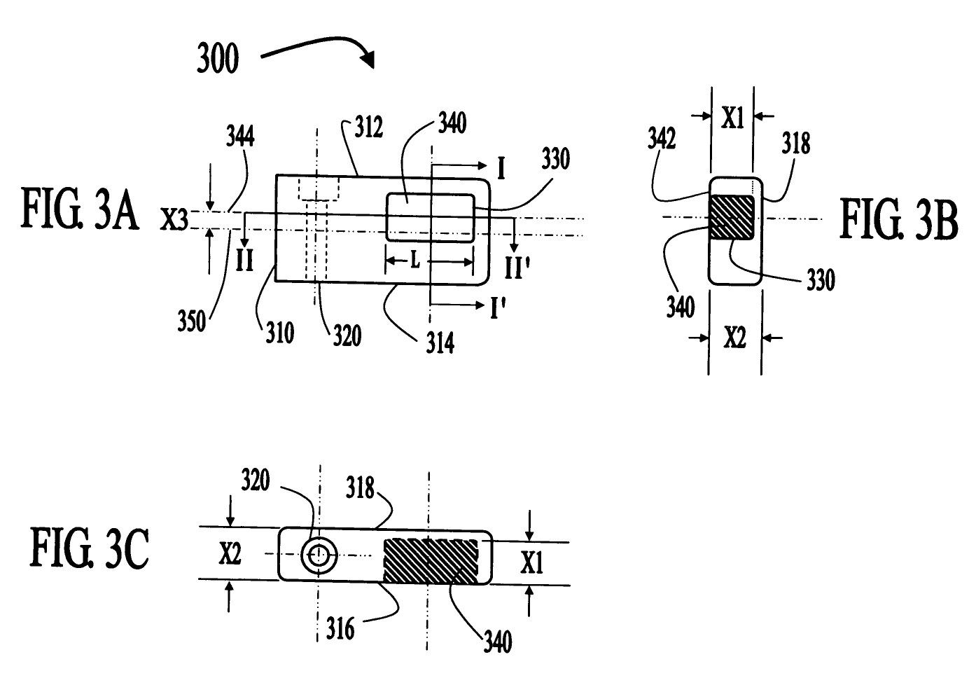

FIGS. 3A-C are multiple views of a second exemplary magnet holding member according to the present invention. FIG. 3A is a side view of the first exemplary magnet holding member, FIG. 3B is a cross sectional view of the first exemplary magnet holding member of FIG. 3A along I-I′, and FIG. 3C is a cross sectional view of the first exemplary magnet holding member of FIG. 3A along II-II′. The second exemplary magnet holding member may include dimensions similar to those of the first exemplary magnet holding member.

In FIG. 3A, the second exemplary magnet holding member 300 may include a body portion 310 including a through hole 320 disposed at a first end of the body portion 310 extending from a first surface 312 of the body portion 310 to a second surface 314 of the body portion 310. In addition, the body portion 310 may include a magnet mounting portion 330 disposed at a second end of the body portion 310 opposite to the first end of the body portion 310.

As shown in FIGS. 3B and 3C, the magnet mounting portion 330 of the body portion 310 extends from a third surface 316 into the body portion 310 by a distance X1 that is less than a thickness X2 of the body portion 310, and does not extend completely through to a fourth surface 318 of the body portion 310. Accordingly, when a rectangular magnet 340 is mounted into the magnet mounting portion 330 of the body portion 310, an outer surface 342 of the rectangular magnet 340 may be substantially flush (coplanar) with the third surface 316 of the body portion 310. The magnet 340 may have a length L (in FIG. 3A) that extends toward the through hole 320 corresponding to a bar-shaped geometry.

In FIG. 3A, a centerline 344 of the rectangular magnet 340 may be offset from a centerline 350 of the body portion 310 by a distance X3. Accordingly, the mass M of the rectangular magnet 340 is displaced from the centerline 350 of the body portion toward the first surface 312, as well as toward an upper corner region 313 of the body portion 310.

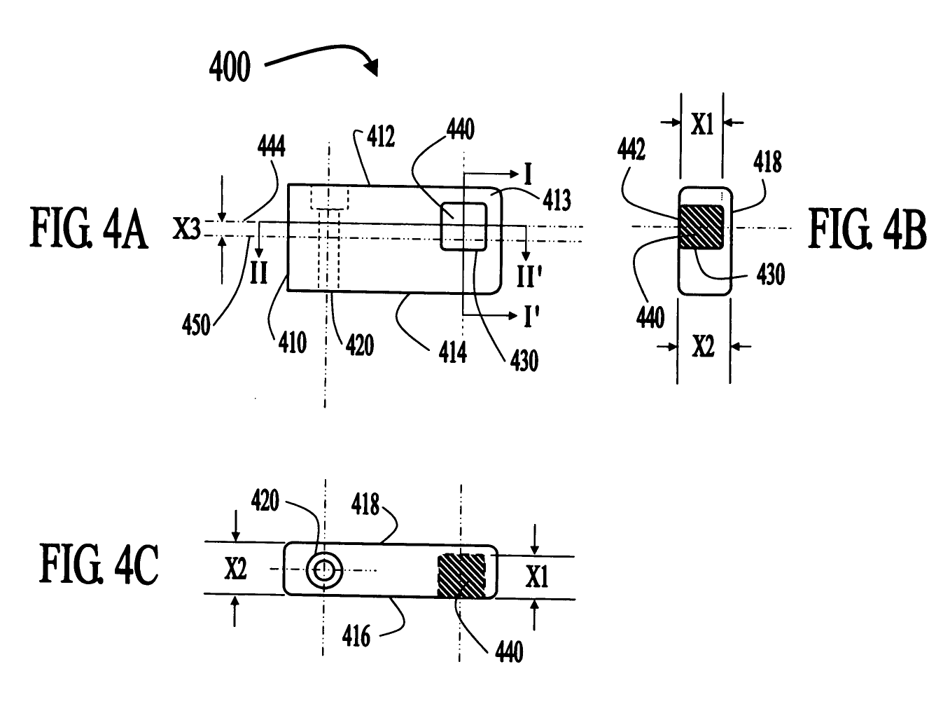

FIGS. 4A-C are multiple views of a third exemplary magnet holding member according to the present invention. FIG. 4A is a side view of the third exemplary magnet holding member, FIG. 4B is a cross sectional view of the third exemplary magnet holding member of FIG. 4A along I-I′, and FIG. 4C is a cross sectional view of the third exemplary magnet holding member of FIG. 4A along II-II′. The third exemplary magnet holding member may include dimensions similar to those of the first and second exemplary magnet holding members.

In FIG. 4A, the third exemplary magnet holding member 400 may include a body portion 410 including a through hole 420 disposed at a first end of the body portion 410 extending from a first surface 412 of the body portion 410 to a second surface 414 of the body portion 410. In addition, the body portion 410 may include a magnet mounting portion 430 disposed at a second end of the body portion 410 opposite to the first end of the body portion 410.

As shown in FIGS. 4B and 4C, the magnet mounting portion 430 of the body portion 410 extends from a third surface 416 into the body portion 410 by a distance X1 that is less than a thickness X2 of the body portion 410, and does not extend completely through to a fourth surface 418 of the body portion 410. Accordingly, when a square magnet 440 is mounted into the magnet mounting portion 430 of the body portion 410, an outer surface 442 (i.e., exposed surface) of the square magnet 440 may be substantially flush (coplanar) with the third surface 416 of the body portion 410.

In FIG. 4A, a centerline 444 of the square magnet 440 may be offset from a centerline 450 of the body portion 410 by a distance X3. Accordingly, the mass M of the rectangular magnet 440 is displaced from the centerline 450 of the body portion toward the first surface 412, as well as toward an upper corner region 413 of the body portion 410.

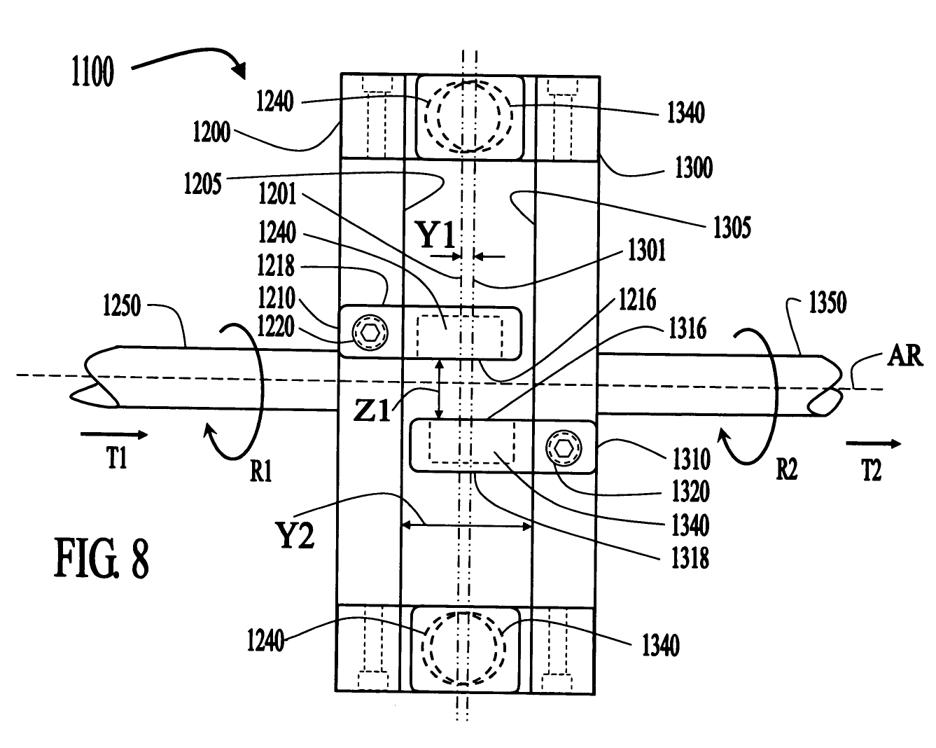

According to the present invention, and as shown in FIGS. 3A-C, by placing the magnets 340 of the magnet holding members 300 at positions offset from a center of the magnet holding members 300, when attaching the magnet holding members 300 into the left and right side rotary plates 1200 and 1300, in FIG. 8, the opposing forces between the magnets 340 may be disposed at a farther distance from the axis of rotation AR. Accordingly, the amount of torque transmitted from/to the rotational shafts 1250 and 1350 may be increased.

According to the present invention, and as shown in FIGS. 4A-C, by placing the magnets 440 of the magnet holding members 400 at positions offset from a center of the magnet holding members 400, when attaching the magnet holding members 400 into the left and right side rotary plates 1200 and 1300, in FIG. 8, the opposing forces between the magnets 440 may be disposed at a farther distance from the axis of rotation AR. Accordingly, the amount of torque transmitted from/to the rotational shafts 1250 and 1350 may be increased.

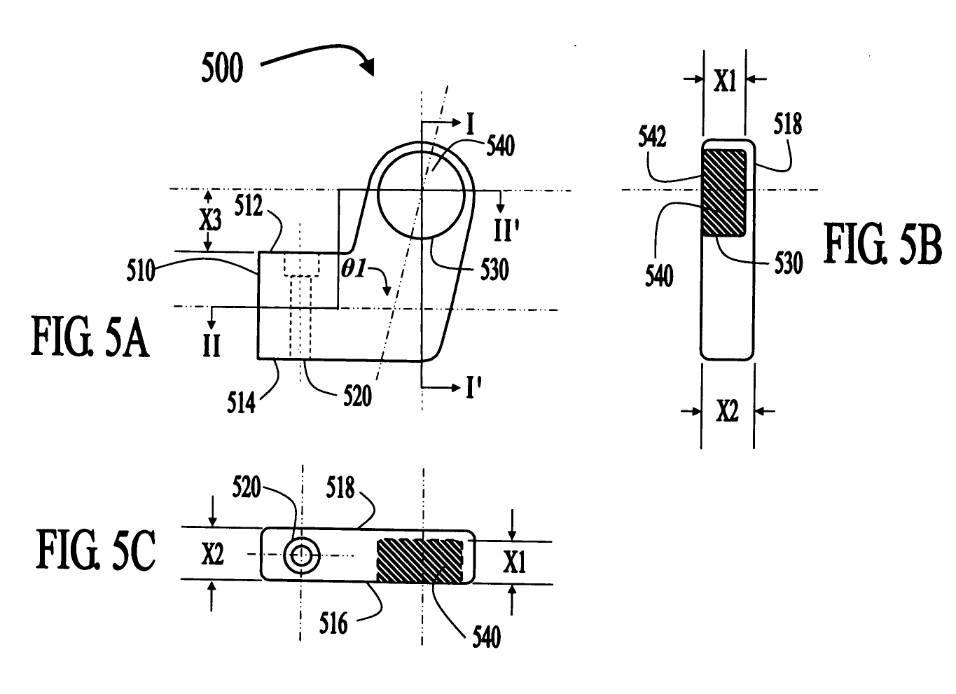

FIGS. 5A-C are multiple views of a fourth exemplary magnet holding member according to the present invention. FIG. 5A is a side view of the fourth exemplary magnet holding member, FIG. 5B is a cross sectional view of the fourth exemplary magnet holding member of FIG. 5A along I-I′, and FIG. 5C is a cross sectional view of the fourth exemplary magnet holding member of FIG. 5A along II-II′.

In FIG. 5A, the fourth exemplary magnet holding member 500 may include a body portion 510 including a through hole 520 disposed at a first end of the body portion 510 extending from a first surface 512 of the body portion 510 to a second surface 514 of the body portion 510. In addition, the body portion 510 may include a magnet mounting portion 530 disposed at a second end of the body portion 510 opposite to the first end of the body portion 510.

As shown in FIGS. 5B and 5C, the magnet mounting portion 530 of the body portion 510 extends from a third surface 516 into the body portion 510 by a distance X1 that is less than a thickness X2 of the body portion 510, and does not extend completely through to a fourth surface 518 of the body portion 510. Accordingly, when a round magnet 540 is mounted into the magnet mounting portion 530 of the body portion 510, an outer surface 542 (i.e., exposed surface) of the round magnet 540 may be substantially flush (coplanar) with the third surface 516 of the body portion 510.

In FIG. 5A, the magnet mounting portion 530 is disposed at the second end of the body portion 510 at an angle 0 from a first centerline of the body portion 510 extending normal to the through hole 520 to a second centerline of the magnet mounting portion 530. Although the angle θ in FIG. 5A may be shown to be slightly greater than 90 degrees, the angle θ may be within the range of about 90 degrees to about 180 degrees.

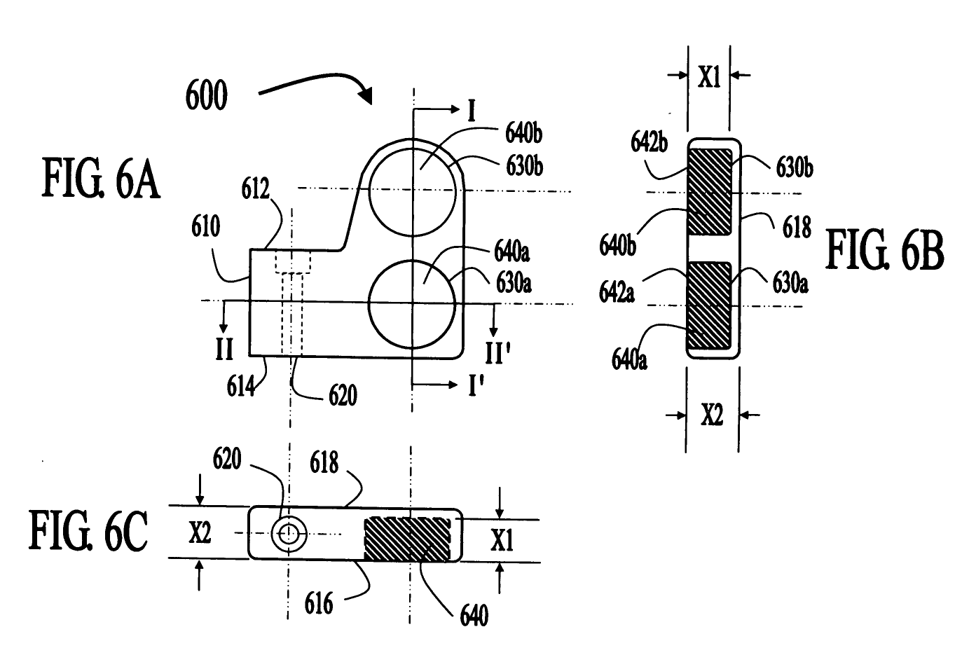

FIGS. 6A-C are multiple views of a fifth exemplary magnet holding member according to the present invention. FIG. 6A is a side view of the fifth exemplary magnet holding member, FIG. 6B is a cross sectional view of the fifth exemplary magnet holding member of FIG. 6A along I-I′, and FIG. 6C is a cross sectional view of the fifth exemplary magnet holding member of FIG. 6A along II-II′.

In FIG. 6A, a fifth exemplary magnet holding member 600 may include a body portion 610 including a through hole 620 disposed at a first end of the body portion 610 extending from a first surface 612 of the body portion 610 to a second surface 614 of the body portion 610. In addition, the body portion 610 may include a first magnet mounting portion 630a and a second magnet mounting portion 640a disposed at a second end of the body portion 610 opposite to the first end of the body portion 610. As shown, the first and second magnet mounting portions 630a and 640a may be mutually aligned perpendicular from the second surface 614 of the body portion 610.

As shown in FIGS. 6B and 6C, the first and second magnet mounting portions 630a and 640a of the body portion 610 extend from a third surface 616 into the body portion 610 by a distance X1 that is less than a thickness X2 of the body portion 610, and does not extend completely through to a fourth surface 618 of the body portion 610. Accordingly, when a first round magnet 640a is mounted into the first magnet mounting portion 630a and a second round magnet 640b is mounted into the second magnet mounting portion 630b of the body portion 610, outer surfaces 642a and 642b (i.e., exposed surfaces) of the first and second round magnets 640a and 640b may be substantially flush (coplanar) with the third surface 616 of the body portion 610.

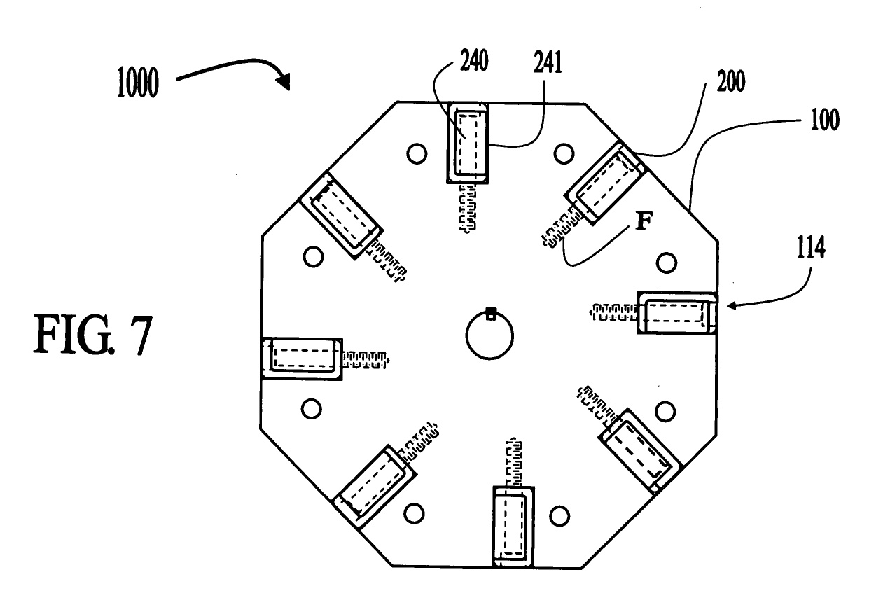

FIG. 7 is a plan view of an exemplary rotary assembly according to the present invention. In FIG. 7, an exemplary rotary assembly 1000 may include a rotary plate 100 having a plurality of the magnet holding members 200, each disposed within one of the channel regions 114 using a fastener F. In addition, any of the exemplary magnet holding members 200-600 may be used in the exemplary assembly of FIG. 7.

As shown in FIG. 7, each magnet 240 of the magnet holding member 200 is disposed to have a face region 241 aligned in the same direction. Accordingly, each of the face regions 241 of the magnets 240 is substantially coplanar with sidewalls of the channel regions. In addition, due to the fastener F and the relatively close tolerances of the width W of the channel regions 114 (in FIG. 1), each of the magnet holding members 200 is completely constrained within the channel regions 114.

FIG. 8 is a side view of an exemplary torque transfer system according to the present invention. In FIG. 8, the exemplary torque transfer system 1100 may function in a forward-convention mode, and includes a left side rotary assembly 1200 and a right side rotary assembly 1300, each respectively coupled to left side and right side rotational shafts 1250 and 1350. Accordingly, the left side rotary assembly 1200 includes a plurality of magnet holding members 1210 each having a first portion coupled to the left side rotary assembly 1200 via a fastener 1220, wherein the magnets 1230 have face regions 1216 (i.e., exposed surfaces) facing a first rotational direction R1. Similarly, the right side rotary assembly 1300 includes a plurality of magnet holding members 1310 each having a first portion coupled to the right side rotary assembly 1300 via a fastener 1320, wherein the magnets 1330 have face regions 1316 (i.e., exposed surfaces) facing a second rotational direction opposite to the first rotational direction R1. Here, the face regions 1216 and 1316 all have similar magnetic poles. For example, the face regions 1216 and 1316 may have North magnetic poles, or the face regions 1216 and 1316 may have South magnetic poles.

In addition, the fourth surfaces 1218 and 1318 of the magnet holding members 1210 and 1310 may face each other such that surfaces of the magnets 1230 and 1330 opposite to the face regions 1216 and 1316 are positioned adjacent to each other. Accordingly, since the face regions 1216 and 1316 of the magnets 1240 and 1340 all have similar magnetic poles, then the surfaces of the magnets 1240 and 1340 opposite to the face regions 1216 and 1316 also have similar magnetic poles. Thus, each of the magnets 1240 of the magnet holding members 1210 repel each of the magnets 1340 of the magnet holding members 1310 along opposing sides of each of the magnet pairs 1240/1340.

In FIG. 8, each of the magnets 1240 of the magnet holding members 1210 have a central region disposed along a first common circumferential axis 1201, and each the magnets 1340 of the magnet holding members 1310 have a central region disposed along a second common circumferential axis 1301. Accordingly, the magnets 1240 rotate about a first plane centered on the first common circumferential axis 1201, and the magnets 1340 rotate above a second plane centered on the second common circumferential axis 1301. However, due to the instability of directly aligning repulsive magnetic poles, the first common circumferential axis 1201 is offset from the second common circumferential axis 1301 by a distance Y1 that may be within a range of about 0.030 inches to about 0.060 inches. Thus, the distance Y1 prevents generation of unstable axial loads along the axis of rotation AR, and may be varied depending upon the magnetic strength of the magnets 1240 and 1340, as well as the geometries of the magnets 1240 and 1340.

For example, as a first rotational torque TI is applied to the left side rotational shaft 1250 about the axis of rotation AR along a first rotational direction R1, the magnetic force of the magnetic polar orientation of the face regions 1216 of the magnet holding members 1210 repel the magnetic force of the magnetic polar orientation of the face regions 1316 of the magnet holding members 1310. Thus, the first rotational torque T1 may be transmitted to the right side rotational shaft 1350 along a second rotational direction R2 as a second rotational torque T2. In other words, the magnetic repulsion forces of the face regions 1216 and 1316 will transmit the first rotational torque T1 applied to the left side rotational shaft 1250 to the right side rotational shaft 1350 as the second rotational torque T2.

In addition, a distance Z1 between the face regions 1216 of the magnet holding members 1210 and the face regions 1316 of the magnet holding members 1310 may decrease proportional to the first rotational torque T1. Accordingly, as the first rotational torque T1 increases, the distance Z1 may be reduced while continuing to transmit the first rotational torque T1 to the right side rotational shaft 1350 as the second rotational torque T2. Conversely, as the first rotational torque T1 decreases, the distance Z1 may increase while continuing to transmit the first rotational torque T1 to the right side rotational shaft 1350 as the second rotational torque T2. Thus, varying the first rotational torque T1 will still result in continuous transmission of the varied first rotational torque T1 as the second rotational torque T2. Here, the first rotational torque T1 is approximately equal to the second rotational torque T2, such that T1=T2. Furthermore, since variations in the first rotational torque T1 are nearly simultaneously transmitted as the second rotational torque T2, the first rotational torque T1 at a time “t” is approximately equal to the second rotational torque T2 at the time “t”, such that T1(t)=T2(t). Accordingly, the distance Z1 is proportional to the transmission of the first rotational torque T1, such that Z1≅T1 and Z1≅T2. In addition, the magnetic repulsive force between the exposed face regions 1216 and 1316 is exponentially related.

In FIG. 8, the left and right side rotary assemblies 1200 and 1300 are separated from each other by a distance Y2, which may be about 0.250 inches. Specifically, the inner faces 1205 and 1305 of the left and right side rotary assemblies 1200 and 1300 are separated from each other by the distance Y2. The distance Y2 may be dependent upon both the distance Y1, as well as the overall dimensions of the magnet holding members 1210 and 1310. Thus, the left side rotary assembly 1200 rotates within a first rotary plane, and the right side rotary assembly 1300 rotates within a second rotary plane.

Of course, in FIG. 8, the distances Y1, Y2, and Z1 may be increased or decreased depending upon an overall size of the torque transfer system 1100, as well as the size of the magnets 1240 and 1340. Moreover, each of the physical dimensions of the individual components of the exemplary torque transfer system of FIG. 8 may be proportionally scaleable. Furthermore, an upper limit of the axial misalignment Y2 may be determined by the physical geometry of the magnets and/or the magnet holding members 1210 and 1310.

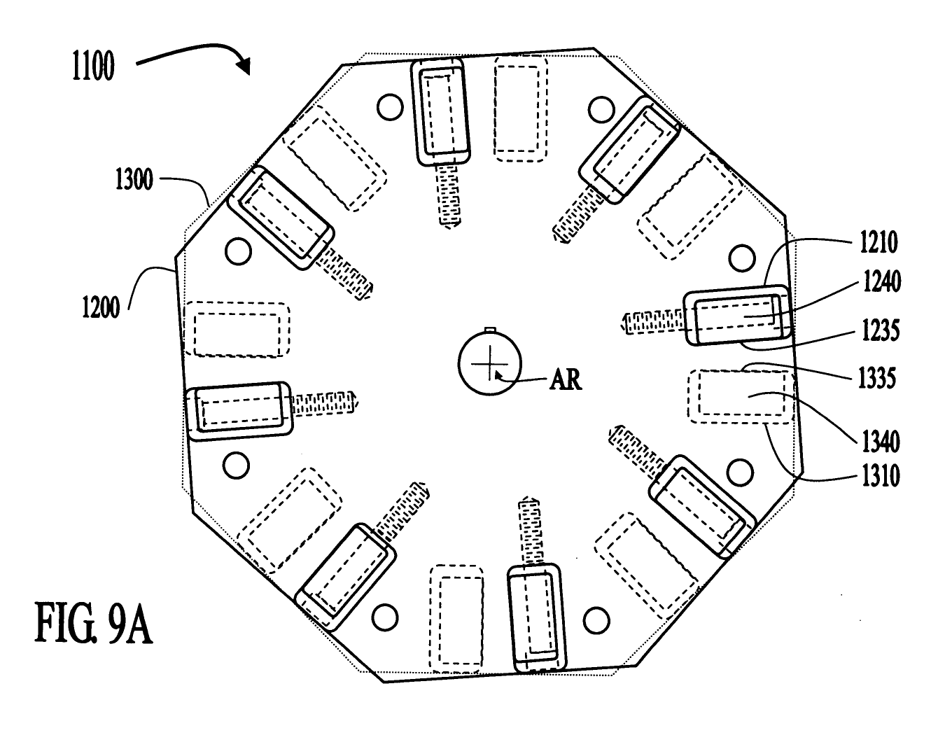

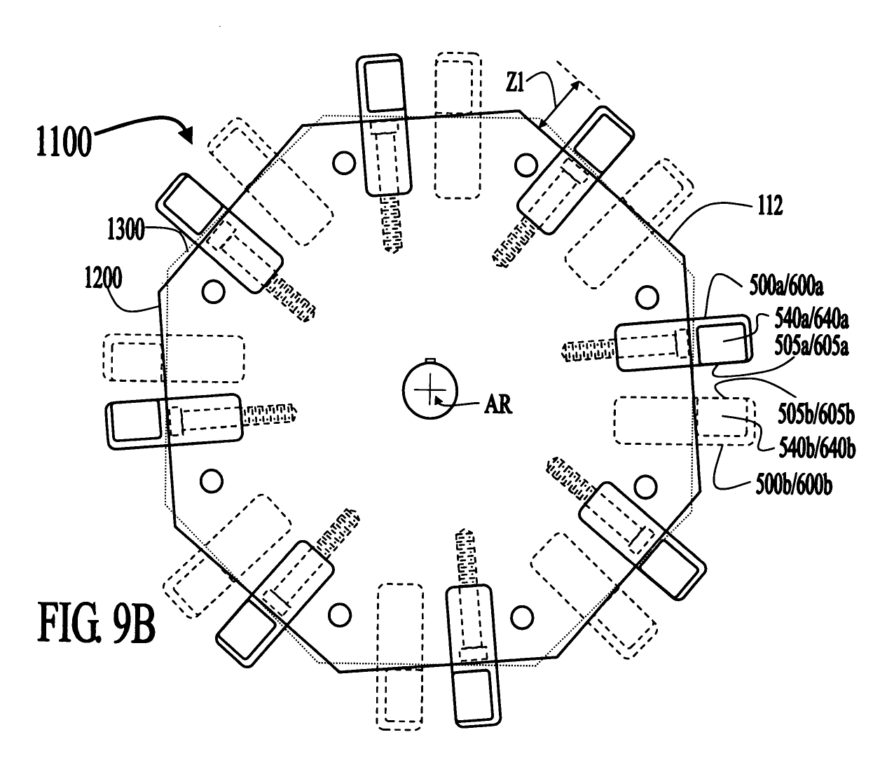

FIGS. 9A and 9B are side views of first and second exemplary relative assemblies according to the present invention. Although the following explanations may use “left” and “right” conventions, the explanations are merely exemplary and do not imply any specific drive/load configurations or modes of operation. In FIG. 9A, for example, each of the magnets 1240 and 1340 may be mounted in the magnet holding members 1210 and 1310 of the left and right side rotary assemblies 1200 and 1300, respectively, and may have their opposing face regions 1235 and 1335 to have a magnetic North orientation. Thus, as the face regions 1235 of the magnets 1230 of the left side rotary assembly 1200 approach the face regions 1335 of the magnets 1330 of the right side rotary assembly 1300, the magnet repulsion force between the face regions 1235 and 1335 of each of the magnets 1240 and 1340 will induce a torque upon the right side rotational shaft 1350 about an axis of rotation AR. Conversely, each of the magnets 1240 and 1340 may be mounted in the magnet holding members 1210 and 1310, respectively, having their opposing face regions 1235 and 1335 to have a magnetic South orientation. However, in the Northern Hemisphere, the North-North magnetic repulsion force is relatively stronger than in the Southern Hemisphere. Accordingly, the specific magnetic polar orientation of the magnetic repulsion force between each of the magnets 1240 and 1340 may be determined by the intended location of operation of the torque transfer system of the present invention.

In addition, since there are a plurality of the magnet holding members 1210 and 1310 mechanically coupled to the left and right side rotary assemblies, an additive torque is transferred from the left side rotational shaft 1250 to the right side rotational shaft 1350. In other words, the total amount of torque transferred from the left side rotational shaft 1250 to the right side rotational shaft 1350 is a product of each of the individual repulsive forces between the magnets 1240 and 1340 and the total number of magnets 1240 and 1340. Accordingly, by increasing the total number of magnets 1240 and 1340 or increasing the magnet strength of some or all of the magnets 1240 and 1340, the total amount of torque transferred from the left side rotational shaft 1250 to the right side rotational shaft 1350 may be increased. Moreover, by disposing the repulsion between the face regions of the magnets 1240 and 1340 at an increased distance from the axis of rotation AR, an increase in the total amount of torque may be accomplished.

In FIG. 9B, each of the magnets 540a/640a and 540b/640b may be mounted in the magnet holding members 500a/600a and 500b/600b of the left and right side rotary assemblies 1200 and 1300, respectively, and may have their opposing face regions 505a/605a and 505b/605b to have a magnetic North orientation. Conversely, the opposing face regions 505a/605a and 505b/605b may have a magnetic South orientation, as explained above. However, as shown in FIG. 9B, the magnets 540a/640a and 540b/640b may be displaced from the major outer surfaces 112 of the left and right side rotary assemblies 1200 and 1300 by a distance Z1. Accordingly, by disposing the magnetic repulsion force between the face regions 505a/605a and 505b/605b of the magnets 540a/640a and 540b/640b at an increased distance from the axis of rotational AR, the total amount of torque transferred from the left side rotational shaft 1250 (in FIG. 8) to the right side rotational shaft 1350 (in FIG. 8) may be increased.

In FIGS. 9A, although one magnet holding member 1210 is shown to be positioned on a single major surface of the left side rotary assembly 1200, a plurality of magnet holding members 1210 may be disposed on a single major surface of the left side rotary assembly 1200. Conversely, although one magnet holding member 1310 is shown to be positioned on a single major surface of the right side rotary assembly 1300, a plurality of magnet holding members 1310 may be disposed on a single major surface of the right side rotary assembly 1300. Similarly, In FIG. 9B, although one magnet holding member is shown to be positioned on a single major surface of the left side rotary assembly 1200, a plurality of magnet holding members may be disposed on a single major surface of the left side rotary assembly 1200. Conversely, although one magnet holding member is shown to be positioned on a single major surface of the right side rotary assembly 1200, a plurality of magnet holding members may be disposed on a single major surface of the right side rotary assembly 1200.

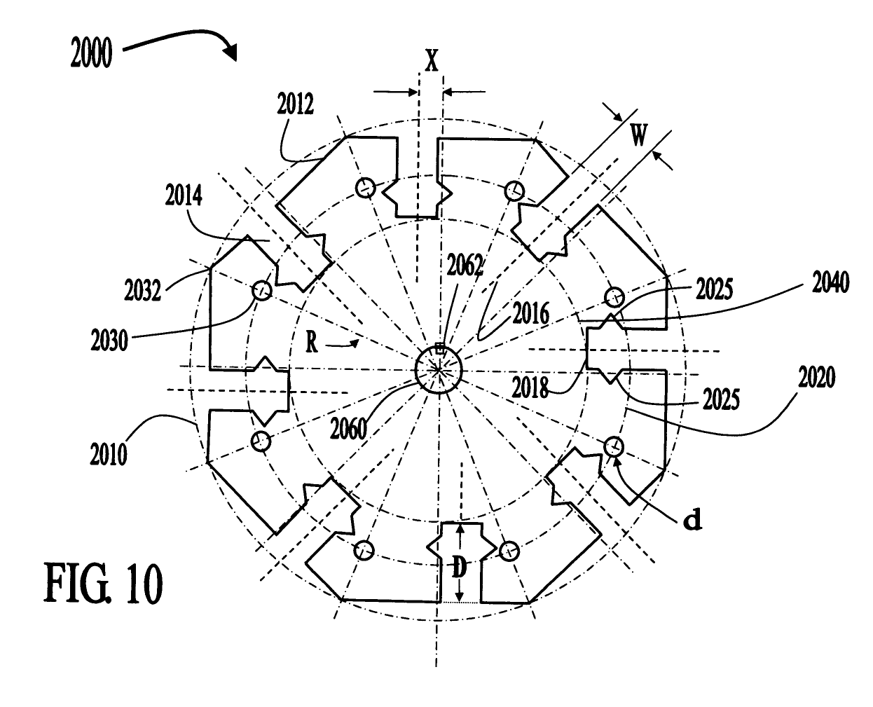

FIG. 10 is a plan view of another exemplary rotary plate according to the present invention. In FIG. 10, an exemplary rotary plate 2000 may have a major diameter 2010, a minor diameter 2040, major outer surfaces 2012, alignment holes 2030, and a through hole 2060. Each of the major outer surfaces 2012 may include at least one channel region 2014 that extends from the major outer surface 2012 to the minor diameter 2040 by a depth D. Accordingly, the channel regions 2014 are radially disposed along the rotary plate 2000 and are offset from the radius of the rotary plate 2000 by a distance X, and each channel region may have a width W. In addition, the through hole 2060 is disposed at a center of the rotary plate 2000 and may include a keyway 2062 for coupling to a rotational shaft (not shown).

In FIG. 10, each of the channel regions 2014 may extend from a bottom portion 2018 of the channel region 2014, and centered upon the bottom portion 2018 of the channel region 2014. In addition, each of the channel regions 2014 include opposing sidewall grooves 2025 disposed toward the bottom portions 2018 of the channel regions 2014. The size and shape of the opposing sidewall grooves 2025 may be adjusted based upon the depth D and width W of the channel regions 2014, as well as the size of the major and minor diameters 2010 and 2040 of the rotary plate 2000.

In FIG. 10, although eight major surfaces 2012 are shown, the rotary plate 2000 may include more or less than eight major surfaces 2012. In addition, although the rotary plate 2000 may include relatively flat major surfaces 2012, the rotary plate 2000 may have a single circular major surface having the plurality of channel regions 2014.

As shown in FIG. 10, the rotary plate 2000 may include the plurality of alignment holes 2030. These alignment holes 2030 facilitate alignment of the rotary plate 2000 with another rotary plate, as will be detailed below. In addition, the alignment holes 2030 may reduce the overall mass of the rotary plate along the major diameter 2010, thereby reducing the moment of inertia of the rotary plate 2000. Accordingly, the alignment holes 2030 may be positioned between the major and minor diameters 2010 and 2040 of the rotary plate 2000 along a diameter 2020. Each of the alignment holes 2030 may be disposed along a radial line R from a corner region 2032 of the rotary plate 2000 located between adjacent major surfaces 2012.

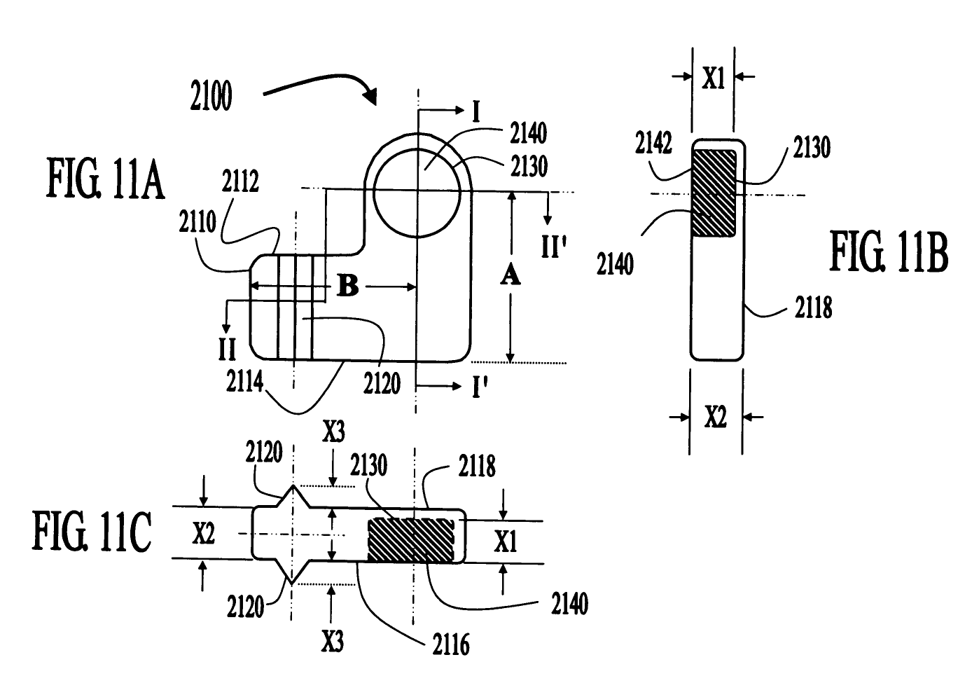

FIGS. 11A-C are multiple views of a sixth exemplary magnet holding member according to the present invention. FIG. 11A is a side view of the sixth exemplary magnet holding member, FIG. 11 B is a cross sectional view of the sixth exemplary magnet holding member of FIG. 11A along I-I′, and FIG. 11C is a cross sectional view of the sixth exemplary magnet holding member of FIG. 11 A along II-II′.

In FIG. 11A, a sixth exemplary magnet holding member 2100 may include a body portion 2110 having opposing protrusions 2120 disposed at a first end of the body portion 2110. In addition, the body portion 2110 may include a magnet mounting portion 2130 disposed at a second end of the body portion 2110 opposite to the first end of the body portion 2110. As shown, the central portion of the magnet mounting portion 2130 may be displaced from the second surface 2114 of the body portion 2110 by a distance A and may be displaced from the first surface 2112 of the body portion 2110 by a distance B.

As shown in FIGS. 11B and 11C, the magnet mounting portion 2130 of the body portion 2110 extends from a third surface 2116 into the body portion 2110 by a distance X1 that is less than a thickness X2 of the body portion 2110, and does not extend completely through to a fourth surface 2118 of the body portion 2110. Accordingly, when a round magnet 2140 is mounted into the magnet mounting portion 2130, an outer surface 2142 (i.e., exposed surface) of the round magnet 2140 may be substantially flush (coplanar) with the third surface 2116 of the body portion 2110. In addition, as shown in FIG. 11C, the opposing sidewall protrusions 2120 extend from the third and fourth surfaces 2116 and 2118 by a distance X3.

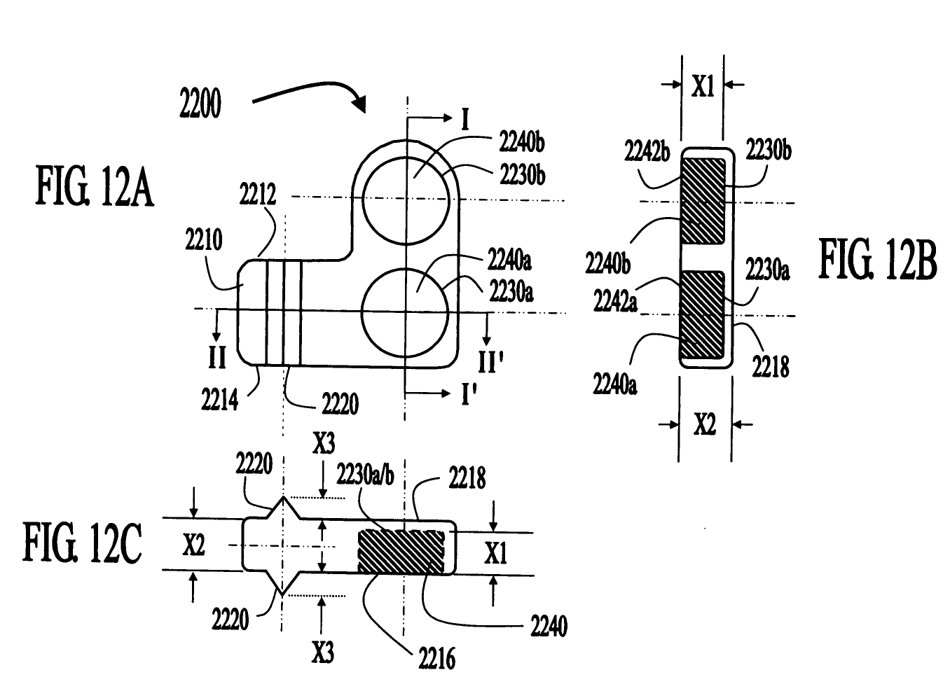

FIGS. 12A-C are multiple views of a seventh exemplary magnet holding member according to the present invention. FIG. 12A is a side view of the seventh exemplary magnet holding member, FIG. 12B is a cross sectional view of the seventh exemplary magnet holding member of FIG. 12A along I-I′, and FIG. 12C is a cross sectional view of the seventh exemplary magnet holding member of FIG. 12A along II-II′.

In FIG. 12A, a seventh exemplary magnet holding member 2200 may include a body portion 2210 having opposing protrusions 2220 disposed at a first end of the body portion 2210. In addition, the body portion 2210 may include a first magnet mounting portion 2230a and a second magnet mounting portion 2240a disposed at a second end of the body portion 2210 opposite to the first end of the body portion 2210. As shown, the first and second magnet mounting portions 2230a and 2240a may be mutually aligned perpendicular from the second surface 2214 of the body portion 2210.

As shown in FIGS. 12B and 12C, the first and second magnet mounting portions 2230a and 2240a of the body portion 2210 extend from a third surface 2216 into the body portion 2210 by a distance X1 that is less than a thickness X2 of the body portion 2210, and do not extend completely through to a fourth surface 2218 of the body portion 2210. Accordingly, when a first round magnet 2240a is mounted into the first magnet mounting portion 2230a and a second round magnet 2240b is mounted into the second magnet mounting portion 2230b of the body portion 2210, outer surfaces 2242a and 2242b (i.e., exposed surfaces) of the first and second round magnets 2240a and 2240b may be substantially flush (coplanar) with the third surface 2216 of the body portion 2210. In addition, as shown in FIG. 12C, the opposing sidewall protrusions 2220 extend from the third and fourth surfaces 2216 and 2218 by a distance X3.

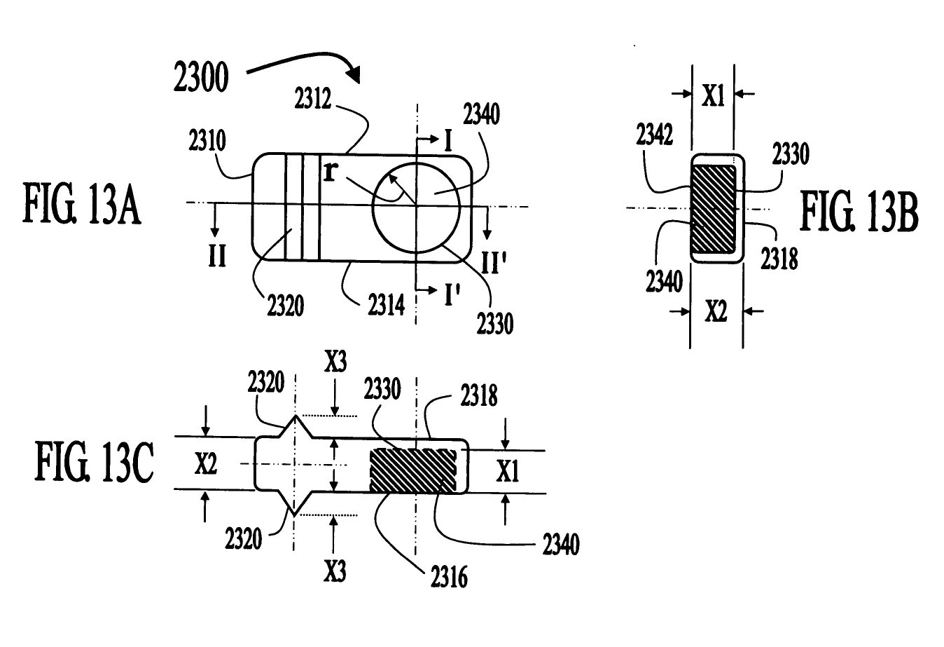

FIGS. 13A-C are multiple views of an eighth exemplary magnet holding member according to the present invention. FIG. 13A is a side view of the eighth exemplary magnet holding member, FIG. 13B is a cross sectional view of the eighth exemplary magnet holding member of FIG. 13A along I-I′, and FIG. 13C is a cross sectional view of the eighth exemplary magnet holding member of FIG. 13A along II-II′.

In FIG. 13A, a first exemplary magnet holding member 2300 may include a body portion 2310 having opposing protrusions 2320 disposed at a first end of the body portion 2310. In addition, the body portion 2310 may include a magnet mounting portion 2330 disposed at a second end of the body portion 2310 opposite to the first end of the body portion 2310.

As shown in FIGS. 13B and 13C, the magnet mounting portion 2330 of the body portion 2310 extends from a third surface 2316 into the body portion 2310 by a distance X1 that is less than a thickness X2 of the body portion 2310, and does not extend completely through to a fourth surface 2318 of the body portion 2310. Accordingly, when a circular magnet 2340 having a radius r is mounted into the magnet mounting portion 2330 of the body portion 2310, an outer surface 2342 (i.e., exposed surface) of the circular magnet 2340 may be substantially flush (coplanar) with the third surface 2316 of the body portion 2310. In addition, as shown in FIG. 13C, the opposing sidewall protrusions 2320 extend from the third and fourth surfaces 2316 and 2318 by a distance X3.

In each of FIGS. 11A-C, 12A-C, and 13A-C, although the magnets 2140, 2240a/b, and 2340 are shown having circular geometries, other geometries may be implemented. For example, the geometries shown in FIGS. 2A-C, 3A-C, and 4A-C may be implemented with the magnet holding members 2100, 2200, and 2300 shown in FIGS. 11A-C, 12A-C, and 13A-C. Moreover, other geometry combinations may be implemented. For example, combinations of curved and rectilinear magnets may be implemented in the magnet holding members 2100, 2200, and 2300 shown in FIGS. 11A-C, 12A-C, and 13A-C.

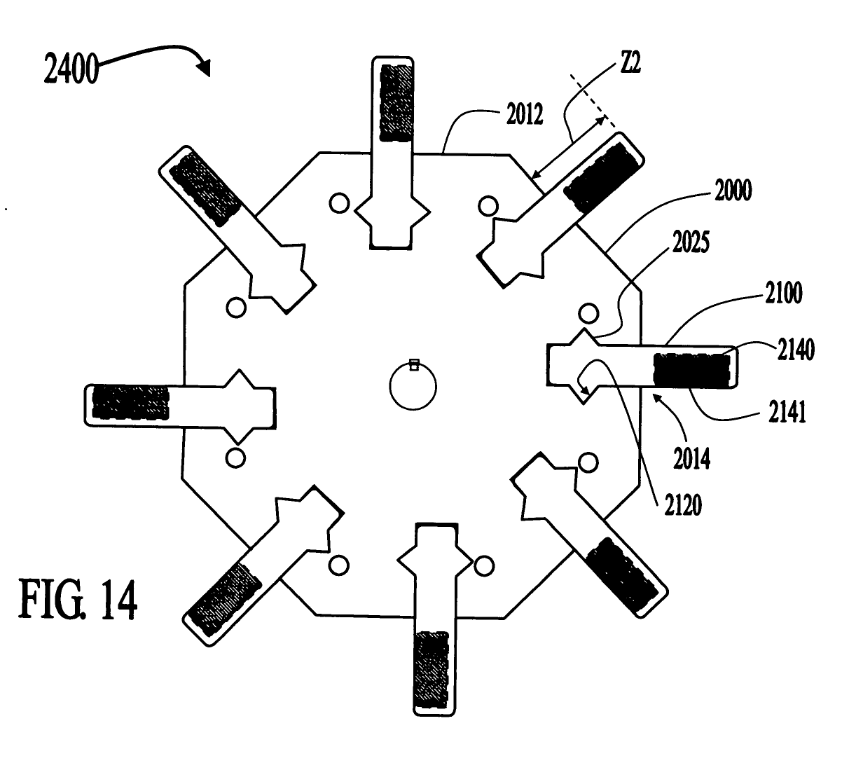

FIG. 14 is a plan view of another exemplary rotary assembly according to the present invention. In FIG. 14, an exemplary rotary assembly 2400 may include a rotary plate 2000 having a plurality of the magnet holding members 2100, each disposed within one of the channel regions 2014. Accordingly, each of the magnet holding members 2100 may be secured within the channel regions 2014 by insertion of the opposing sidewall protrusions 2120 of the magnet holding members 2100 within the sidewall grooves 2025 of the channel regions 2014. Although not specifically shown, each of the magnet holding members 2100 may be further secured to the channel regions 2014 using a mechanical fastening system. However, each of the magnet holding members 2100 may be positively mechanically fixed into the channel regions 2014, thereby providing a simplified positive mechanical coupling to the rotary plate 2000. In other words, a permanent mechanical junction may be provided between the magnet holding members 2100 and the rotary plate 2000.

In FIG. 14, the magnets 2140 may be displaced from the major outer surfaces 2012 of the rotary plate 2000 by a distance Z2. Accordingly, by disposing the face region 2141 of each of the magnets by the distance Z2, repulsion forces of the face regions 2141 at an increased distance from an axis of rotational of the rotary plate 2000 may be increased. Thus, the total amount of torque transferred from a rotational shaft coupled to the rotary plate 2000 may be increased.

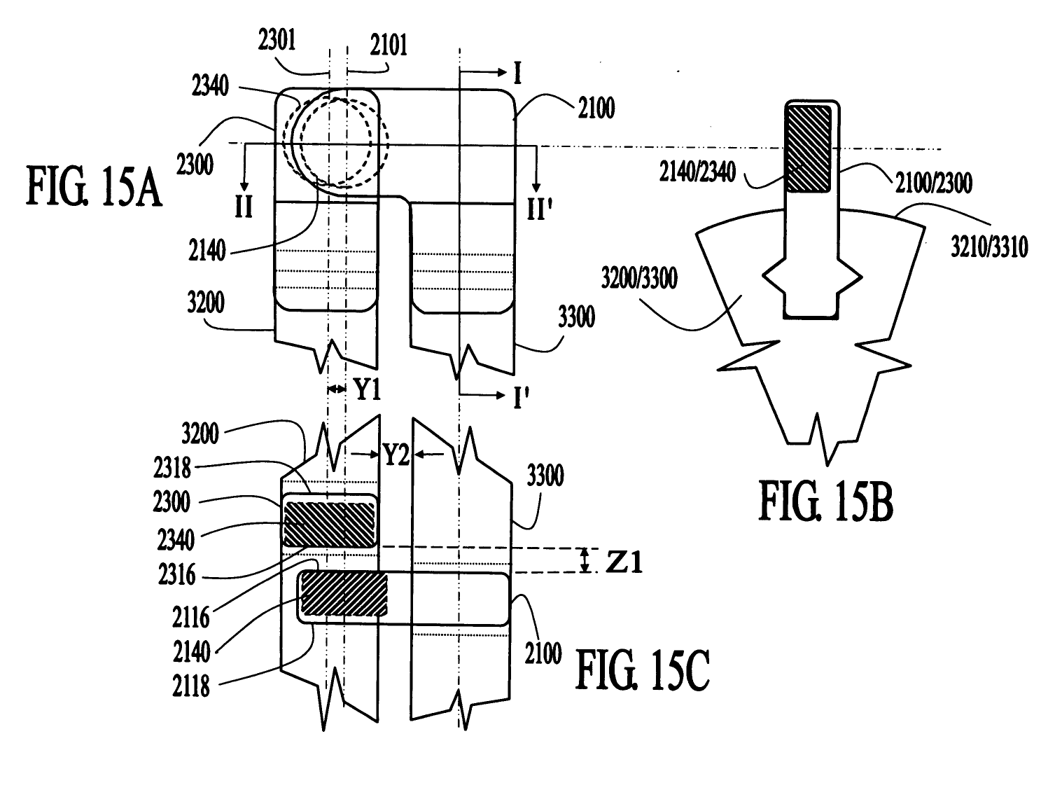

FIGS. 15A-C are various views of another exemplary torque transfer system in a forward-convention mode of operation according to the present invention. FIG. 15A is a partial circumferential view of an exemplary torque transfer system according to the present invention, FIG. 15B is a partial side view of the exemplary torque transfer system of FIG. 15A along I-I′, and FIG. 15C is a partial top view of the exemplary torque transfer system of FIG. 15A along II-II′.

In FIG. 15A, an exemplary torque transfer system may function in a forward-convention mode, and includes a left side rotary assembly 3200 and a right side rotary assembly 3300. The left side rotary assembly 3200 includes a plurality of magnet holding members 2300, although only a single magnet holding member 2300 is shown, and the right side rotary assembly 3300 includes a plurality of magnet holding members 2100, although only a single magnet holding member 2100 is shown.

In FIGS. 15A-C, the left and right side assemblies 3200/3300 may be identical with regard to the rotary plate configurations, but the magnet holding members implemented in the left side assembly 3200 may be different from the magnet holding members implemented in the right side assembly 3300. Specifically, each of the left and right side assemblies 3200/3300 may include the rotary plate 2000 of FIG. 10, and the magnet holding members 2100/2200 may include the exemplary eighth magnet holding member shown in FIGS. 13A-C, and each of the magnet holding members 2100 may be similar to the exemplary sixth magnet holding member shown in FIGS. 13A-C.

As shown in FIG. 15B, each of the magnet holding members 2100/2300 are constrained in the rotary assemblies 3200/3300, respectively, and each of the corresponding magnets 2140/2340 is disposed above major surfaces 3210/3310 of the rotary assemblies 3200/3300. As previously disclosed, the major surfaces 3210/3310 of the rotary assemblies 3200/3300 may be either flat surfaces, such as the exemplary rotary assemblies 100 and 2000 shown in FIGS. 1 and 10, or may have a single continuous round circumferential surface. Accordingly, although FIG. 15B shows the rotary assemblies 3200/3300 as a single continuous round circumferential surface having the major surfaces 3210/3310, the rotary assemblies 3200/3300 may, instead, have a plurality of major surfaces, such as those shown in FIGS. 1 and 10.

In FIG. 15C, the magnet holding members 2100 and 2300 include magnets 2140 and 2340 that are aligned over the rotary assembly 3200. Each of the magnets 2140 of the magnet holding members 2100 have a central face region (i.e., exposed surface) 2116 disposed along a first common circumferential axis 2101, and each the magnets 2340 of the magnet holding members 2300 have a central face region (i.e., exposed surface) 2316 disposed along a second common circumferential axis 2301. Accordingly, the magnets 2140 rotate within a first plane centered on the first common circumferential axis 2101, and the magnets 2340 rotate within a second plane centered on the second common circumferential axis 2301. In addition, the first common circumferential axis 2101 and the second common circumferential axis 2301 are both disposed above the rotary assembly 3200. However, due to the instability of directly aligning the repulsive magnetic poles, the first common circumferential axis 2101 is offset from the second common circumferential axis 2301 by a distance Y1. Thus, the distance Y1 prevents generation of unstable axial loads along an axis of rotation (not shown), and may be varied depending upon the magnetic strength of the magnets 2140 and 2340, as well as the geometries of the magnets 2140 and 2340.

As shown in FIG. 15C, the central face regions 2116 and 2316 of the magnets 2140 and 2340 are separated by a distance Z1 that varies based upon an applied torque load. For example, upon application of a rotational torque load to the rotary assembly 3200, the central face regions 2116 and 2316 of the magnets 2140 and 2340 repel each other due to facing like magnetic poles, and the distance Z1 decreases, thereby transferring the rotational torque load to the rotary assembly 3300. Accordingly, as the applied torque increases, the distance Z1 will proportionally decrease.

The rotary assemblies 3200/3300 may be separated by a distance Y2. Thus, by implementing the configuration of FIGS. 15A-C, and using the exemplary magnet holding members 2100 and 2300, the distance Y2 may be significantly less than the distance Y2 between the left and right side rotary assemblies 1200 and 1300, shown in FIG. 8, which implement the exemplary magnet holding members 200-600 of FIGS. 2A-C to 6A-C, respectively. Moreover, by placing the repulsive forces between the face regions of the magnets 2140 and 2340 above the major surface(s) of the rotary assemblies 3200/3300, the amount of torque transferred by the rotary assemblies 3200/3300 may be increased.

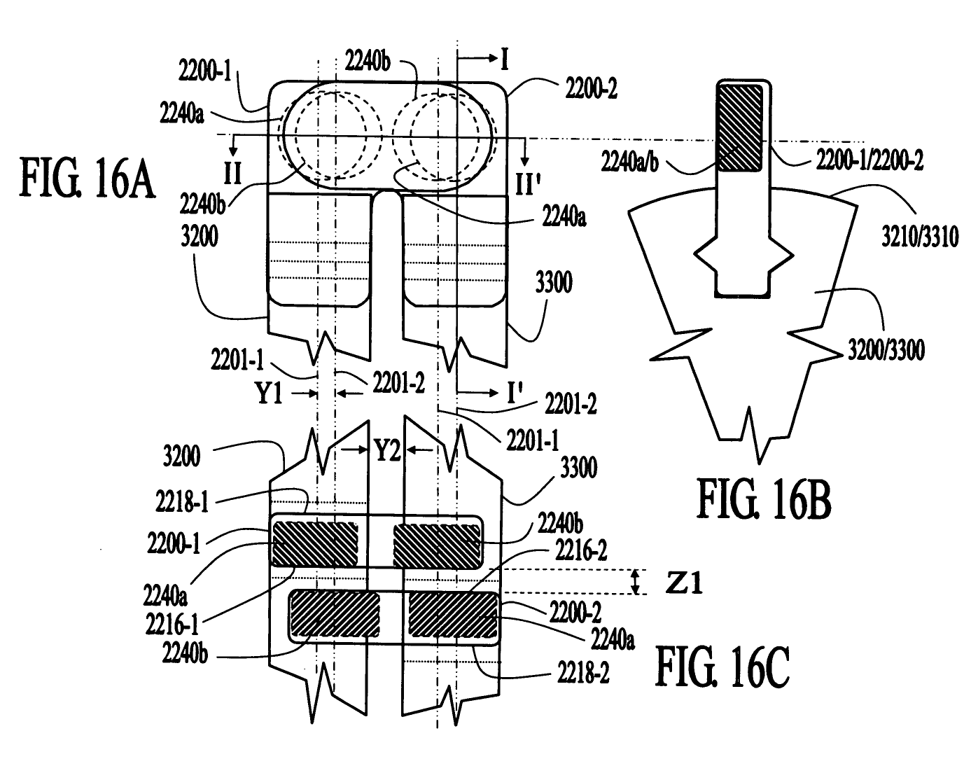

FIGS. 16A-C are various views of another exemplary torque transfer system in a forward-convention mode of operation according to the present invention. FIG. 16A is a partial circumferential view of an exemplary torque transfer system according to the present invention, FIG. 16B is a partial side view of the exemplary torque transfer system of FIG. 16A along I-I′, and FIG. 16C is a partial top view of the exemplary torque transfer system of FIG. 16A along II-II′.

In FIG. 16A, an exemplary torque transfer system may function in a forward-convention mode, and includes a left side rotary assembly 3200 and a right side rotary assembly 3300. The left side rotary assembly 3200 includes a plurality of magnet holding members 2200-1, although only a single magnet holding member 2200-1 is shown, and the right side rotary assembly 3300 includes a plurality of magnet holding members 2200-2, although only a single magnet holding member 2200-2 is shown. According to the present invention, the left and right side assemblies 3200/3300 may be identical with regard to the rotary plate configurations and magnet holding members. Specifically, each of the left and right side assemblies 3200/3300 may include the rotary plate 2000 of FIG. 10, and the magnet holding members 2200-1/2200-2 may include the magnet holding member 2200 of FIGS. 12A-C.

As shown in FIG. 16B, each of the magnet holding members 2200-1/2200-2 are constrained in the rotary assemblies 3200/3300, respectively, and each of the corresponding magnets 2240a/b and 2340a/b are disposed above major surfaces 3210/3310 of the rotary assemblies 3200/3300. As previously disclosed, the major surfaces 3210/3310 of the rotary assemblies 3200/3300 may be either flat surfaces, such as the exemplary rotary assemblies 100 and 2000 shown in FIGS. 1 and 10, or may have a single continuous round circumferential surface. Accordingly, although FIG. 16B shows the rotary assemblies 3200/3300 as a single continuous round circumferential surface having the major surfaces 3210/3310, the rotary assemblies 3200/3300 may, instead, may a plurality of major surfaces, such as those shown in FIGS. 1 and 10.

In FIG. 16C, the magnet holding members 2200-1 and 2200-2 include magnets 2240a and 2240b that are aligned over the rotary assemblies 3200 and 3300. Each of the magnets 2240a/b of the magnet holding members 2200-1 have a central region disposed along a first common circumferential axis 2201-1, and each the magnets 2240a/b of the magnet holding members 2200-2 have a central region disposed along a second common circumferential axis 2201-2. Accordingly, the magnets 2240a/b of the magnet holding members 2200-1 rotate about a first plane centered on the first common circumferential axis 2201-1, and the magnets 2240a/b of the magnet holding members 2200-2 rotate about a second plane centered on the second common circumferential axis 2201-2. However, due to the instability of directly aligning the repulsive magnetic poles, each of the first common circumferential axes 2201-1 is offset from each of the second common circumferential axis 2201-2 by a distance Y1. Thus, the distance Y1 prevents generation of unstable axial loads along an axis of rotation (not shown), and may be varied depending upon the magnetic strength of the magnets 2240a/b, as well as the geometries of the magnets 2240a/b.

As shown in FIG. 16C, the central face regions 2216-1 and 2216-2 of the magnets 2240a and 2240b are separated by a distance Z1 that varies based upon an applied torque load. For example, upon application of a rotational torque load to the rotary assembly 3200, the central face regions 2216-1 and 2216-2 of the magnets 2240a and 2240b repel each other due to facing like magnetic poles, and the distance Z1 decreases, thereby transferring the rotational torque load to the rotary assembly 3300. Accordingly, as the applied torque increases, the distance Z1 will proportionally decrease.

The rotary assemblies 3200 and 3300 may be separated by a distance Y2, and provide substantially twice the repulsive magnetic force as compared to the configuration of FIGS. 15A-C. Thus, by implementing the configuration of FIGS. 16A-C, and using the exemplary magnet holding members 2200-1 and 2200-2, the distance Y2 may be significantly less than the distance Y2 between the left and right side rotary assemblies 1200 and 1300, shown in FIG. 8, which implement the exemplary magnet holding members 200-600 of FIGS. 2A-C to 6A-C, respectively. Moreover, by placing the repulsive forces between the face regions (i.e., exposed surfaces) 2216-1 and 2216-2 of the magnets 2240a and 2240b above each of the major surface(s) of the rotary assemblies 3200/3300, the amount of torque transferred by the torque transfer system of FIGS. 16A-C may be further increased more than the amount of torque transferred by the exemplary torque transfer system of FIGS. 15A-C proportional to the additional magnet repulsive forces between the additional magnetic repulsion of the magnets 2240a and 2240b above the second rotary assembly 3300.

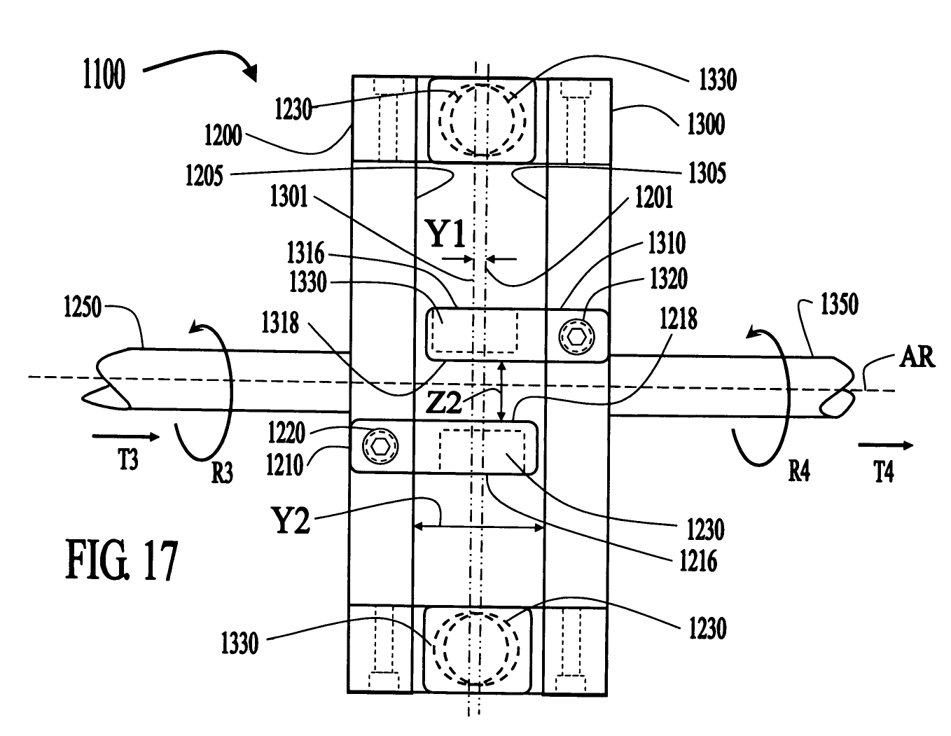

FIG. 17 is another exemplary torque transfer system in a reverse-convention mode of operation according to the present invention. FIG. 17 includes the individual features of FIG. 8, but functions to transmit torque using repulsive magnetic forces of opposite magnet faces (i.e., covered faces) of those shown in FIG. 8. In FIG. 17, the torque transfer system may be considered to function in a reverse-convention mode of operation, wherein a third rotational torque T3 is applied to the left side rotational shaft 1250 about the axis of rotation AR along a third rotational direction R3, which is opposite to the first rotational direction R1 of FIG. 8. Accordingly, the magnetic forces of the magnetic polar orientation of the opposite face regions 1218 (i.e., covered faces) of the magnet holding members 1210 repel the magnetic force of the magnetic polar orientation of the opposite face regions 1318 (i.e., covered faces) of the magnet holding members 1310. Thus, the third rotational torque T3 may be transmitted to the right side rotational shaft 1350 along a fourth rotational direction R4, which is opposite to the second rotational direction R2 of FIG. 8, as a fourth rotational torque T2. In other words, the magnetic repulsion forces of the opposite face regions 1218 and 1318 will transmit the third rotational torque T3 applied to the left side rotational shaft 1250 to the right side rotational shaft 1350 as the fourth rotational torque T4.

In addition, a distance Z2 between the opposite face regions 1218 of the magnet holding members 1210 and the opposite face regions 1318 of the magnet holding members 1310 may decrease proportional to the third rotational torque T3. Accordingly, as the third rotational torque T3 increases, the distance Z2 may be reduced while continuing to transmit the third rotational torque T3 to the right side rotational shaft 1350 as the fourth rotational torque T4. Conversely, as the third rotational torque T3 decreases, the distance Z2 may increase while continuing to transmit the third rotational torque T3 to the right side rotational shaft 1350 as the fourth rotational torque T4. Thus, varying the third rotational torque T3 will still result in continuous transmission of the varied third rotational torque T3 as the fourth rotational torque T4. Here, the third rotational torque T3 is approximately equal to the fourth rotational torque T4, such that T3=T4. Furthermore, since variations in the third rotational torque T3 are nearly simultaneously transmitted as the fourth rotational torque T4, the third rotational torque T3 at a time “t” is approximately equal to the fourth rotational torque T4 at the time “t”, such that T3(t)=T4(t). However, due to the relative configuration of the magnet holding members 1210 and 1310 with regard to the left and right side rotary assemblies 1200 and 1300, additional clearance may be provided to prevent physical contact between adjacent pairs of the magnet holding members 1210 and 1310.

Of course, in FIG. 17, the distances Y1, Y2, and Z2 may be increased or decreased depending upon an overall size of the torque transfer system 1100, as well as the size of the magnets 1240 and 1340. Moreover, each of the physical dimensions of the individual components of the exemplary torque transfer system of FIG. 17 may be proportionally scaleable.

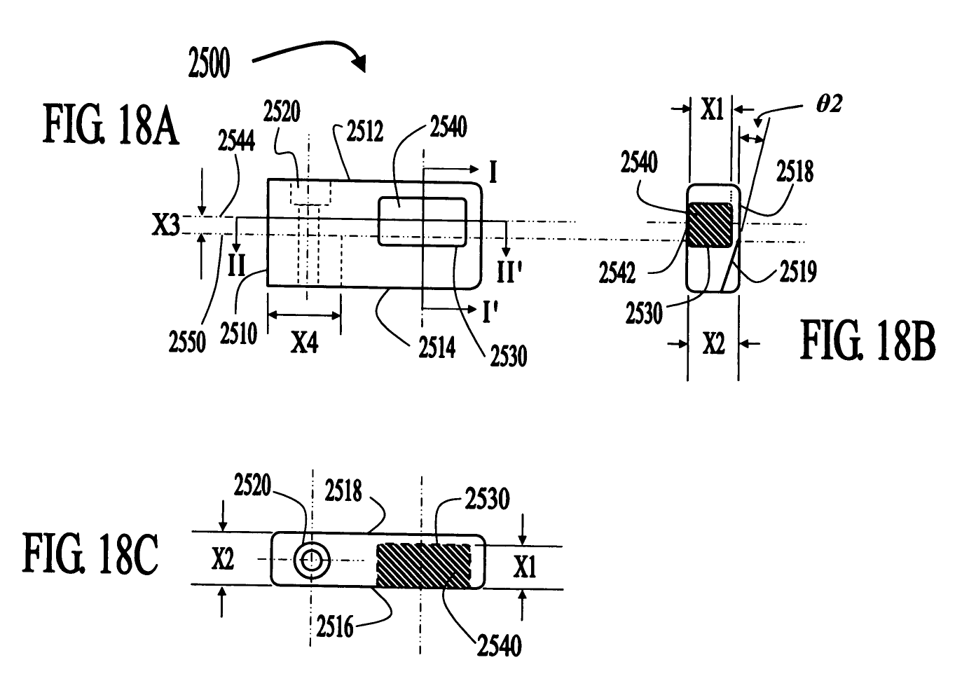

FIGS. 18A-C are multiple views of a ninth exemplary magnet holding member according to the present invention. FIG. 18A is a side view of the ninth exemplary magnet holding member, FIG. 18B is a cross sectional view of the ninth exemplary magnet holding member of FIG. 18A along I-I′, and FIG. 18C is a cross sectional view of the ninth exemplary magnet holding member of FIG. 18A along II-II′.

In FIG. 18A, a ninth exemplary magnet holding member 2500 may include a body portion 2510 including a through hole 2520 disposed at a distance x′ from the first end of the body portion 2510 extending from a first surface 2512 of the body portion 2510 to a second surface 2514 of the body portion 2510, and through a thickness h of the body portion 2510. In addition, the body portion 2510 may include a magnet mounting portion 2530 disposed at a second end of the body portion 2510 opposite to the first end of the body portion 2510.

As shown in FIGS. 18B and 18C, the magnet mounting portion 2530 of the body portion 2510 extends from a third surface 2516 into the body portion 2510 by a distance X1 that is less than a thickness X2 of the body portion 2510, and does not extend completely through to a fourth surface 2518 of the body portion 2510. Accordingly, when a rectangular magnet 2540 is mounted into the magnet mounting portion 2530 of the body portion 2510, an outer surface 2542 of the magnet 2540 may be substantially flush (coplanar) with the third surface 2516 of the body portion 2510.

In FIG. 18B, the body portion 2510 includes a chamfered portion 2519 that extends between the second surface 2514 and the fourth surface 2518 of the body portion 2510 at an angle a from the fourth surface 2518. The angle a may be about 22.5° to ensure that reduction of the distance Z2 (in FIG. 17) due to transmission of the third torque T3 will not cause the magnet holding members 1210 and 1310 to undergo undue stresses when physically contacting each other.

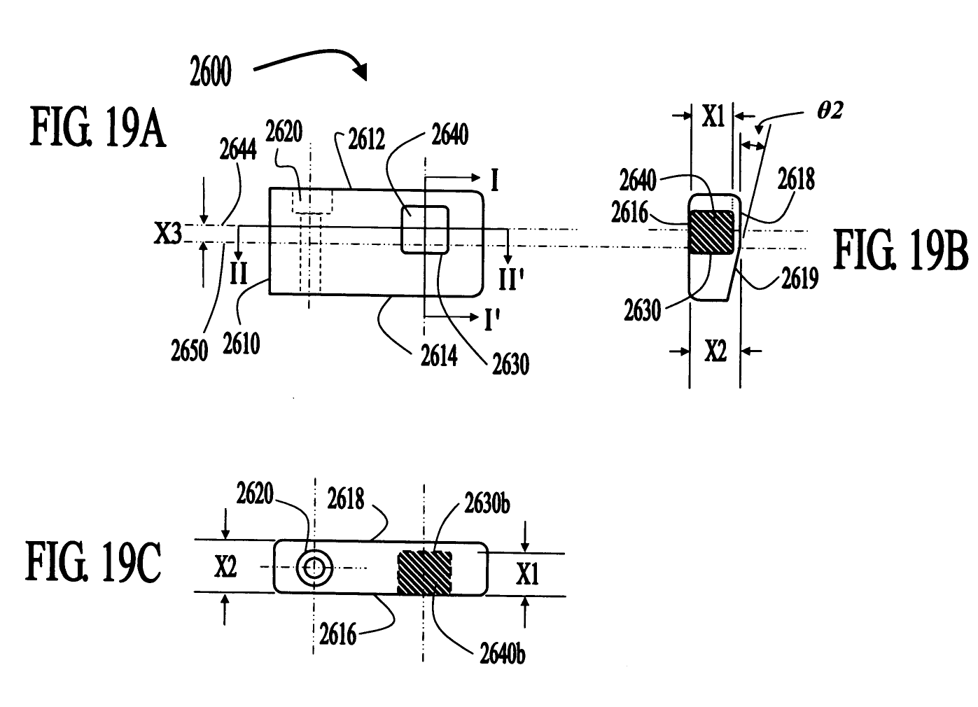

In FIGS. 18A and 18B, the chamfered portion 2519 may extend along a lengthwise direction of the fourth surface 2518, and may terminate before the through hole 2520. Accordingly, the body portion 2510 may maintain a relatively rectangular cross section along a distance X4 from the first end of the body portion 2510, and then transition to the chamfered portion 2519. Thus, the distance X4 may correspond to a thickness of the left/right rotary assembly 1200/1300. Alternatively, the chamfered portion 2519 may extend along an entire length of the fourth surface 2518, as will be shown in FIGS. 19A-C.

According to the present invention, and as shown in FIGS. 18A-C, by placing the magnets 2540 of the magnet holding members 2500 at positions offset from a center of the magnet holding members 2500 by a distance X3, when attaching the magnet holding members 2500 into the left and right side rotary plates 1200 and 1300, in FIG. 8, the opposing forces between the magnets 2540 may be disposed at a farther distance from the axis of rotation AR. Accordingly, the amount of torque transmitted from/to the rotational shafts 1250 and 1350 may be increased.

FIGS. 19A-C are multiple views of a tenth exemplary magnet holding member according to the present invention. FIG. 19A is a side view of the tenth exemplary magnet holding member, FIG. 19B is a cross sectional view of the tenth exemplary magnet holding member of FIG. 19A along I-I′, and FIG. 19C is a cross sectional view of the tenth exemplary magnet holding member of FIG. 19A along II-II′.

In FIG. 19A, the tenth exemplary magnet holding member 2600 may include a body portion 2610 including a through hole 2620 disposed at a first end of the body portion 2610 extending from a first surface 2612 of the body portion 2610 to a second surface 2614 of the body portion 2610. In addition, the body portion 2610 may include a magnet mounting portion 2630 disposed at a second end of the body portion 2610 opposite to the first end of the body portion 2610.

As shown in FIGS. 19B and 19C, the magnet mounting portion 2630 of the body portion 2610 extends from a third surface 2616 into the body portion 2610 by a distance X1 that is less than a thickness X2 of the body portion 2610, and does not extend completely through to a fourth surface 2618 of the body portion 2610. Accordingly, when a square magnet 2640 is mounted into the magnet mounting portion 2630 of the body portion 2610, an outer surface 2642 of the square magnet 2640 may be substantially flush (coplanar) with the third surface 2616 of the body portion 2610.

In FIG. 19A, a centerline 2644 of the square magnet 2640 may be offset from a centerline 2650 of the body portion 2610 by a distance X3. Accordingly, the mass M of the rectangular magnet 2640 is displaced from the centerline 2650 of the body portion toward the first surface 2612, as well as toward an upper corner region 2613 of the body portion 2610.

In FIG. 19B, the body portion 2610 includes a chamfered portion 2619 that extends between the second surface 2614 and the fourth surface 2618 of the body portion 2610 at an angle a from the fourth surface 2618. The angle a may be about 22.5° to ensure that reduction of the distance Z2 (in FIG. 17) due to transmission of the third torque T3 will not cause the magnet holding members 1210 and 1310 to undergo undue stresses when physically contacting each other.

In FIGS. 19A and 19B, the chamfered portion 2619 may extend along an entire lengthwise direction of the fourth surface 2618. Accordingly, the body portion 2610 may maintain a relatively rectangular cross section along a distance X4 from the first end of the body portion 2610, and then transition to the chamfered portion 2619. Thus, the distance X4 may correspond to a thickness of the left/right rotary assembly 1200/1300. Alternatively, the chamfered portion 2619 may extend only along a portion of the length of the fourth surface 2618 to terminate at a region corresponding to the through hole 2620, as shown in FIGS. 18A-C.

According to the present invention, and as shown in FIGS. 19A-C, by placing the magnets 2640 of the magnet holding members 2600 at positions offset from a center of the magnet holding members 2600 by a distance X3, when attaching the magnet holding members 2600 into the left and right side rotary plates 1200 and 1300, in FIG. 8, the opposing forces between the magnets 2640 may be disposed at a farther distance from the axis of rotation AR. Accordingly, the amount of torque transmitted from/to the rotational shafts 1250 and 1350 may be increased.

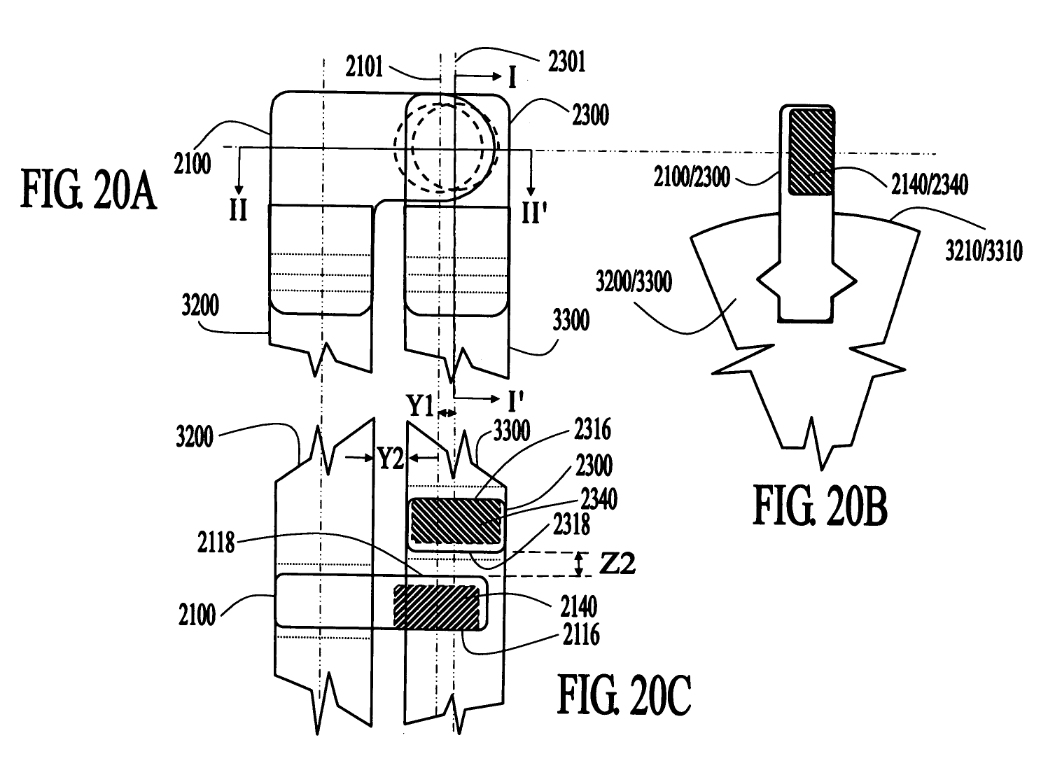

FIGS. 20A-C are multiple views of another exemplary torque transfer system in a reverse-convention mode of operation according to the present invention. FIGS. 20A-C include the individual features of FIGS. 15A-C, but functions to transmit torque using repulsive magnetic forces of opposite magnet faces of those shown in FIGS. 15A-C. In FIG. 20A, the exemplary torque transfer system may function in a reverse-convention mode, wherein the magnetic forces of the magnetic polar orientation of the opposite face regions 2118 (i.e., covered faces) of the magnets 2140 repel the magnetic forces of the magnetic polar orientation of the opposite face regions 2318 (i.e., covered faces) of the magnets 2340. Thus, rotational torque supplied to the left side rotary assembly 3200 may be transmitted along a rotational direction that is opposite to the rotational direction corresponding to the torque transfer system of FIGS. 15A-C. In other words, the magnetic repulsion forces of the opposite face regions 2118 and 2318 will transmit the rotational torque supplied to the left side rotary assembly 3200 to the right side rotary assembly 3300.

In addition, a distance Z2 between the opposite face regions 2118 of the magnet holding members 2100 and the opposite face regions 2318 of the magnet holding members 2300 may decrease proportional to the rotational torque supplied to the left side assembly 3200. Accordingly, as the rotational torque supplied to the left side assembly 3200 increases, the distance Z2 may be reduced while continuing to transmit the rotational torque to the right side rotary assembly 3300. Conversely, as the rotational torque decreases, the distance Z2 may increase while continuing to transmit the rotational torque to the right side rotary assembly 3300. Thus, varying the rotational torque supplied to the left side rotary assembly 3200 will still result in continuous transmission of the varied rotational torque to the right side rotary assembly 3300. Here, the rotational torque supplied to the left side rotary assembly 3200 is approximately equal to the rotational torque supplied to the right side rotary assembly 3300. Furthermore, since variations in the rotational torque supplied to the left side rotary assembly 3200 (i.e., input torque) are nearly simultaneously transmitted to the right side rotary assembly 3300 (i.e., output torque), the input rotational torque at a time “t” is approximately equal to the output rotational torque at the time “t”, such that Tin(t)=Tout(t).

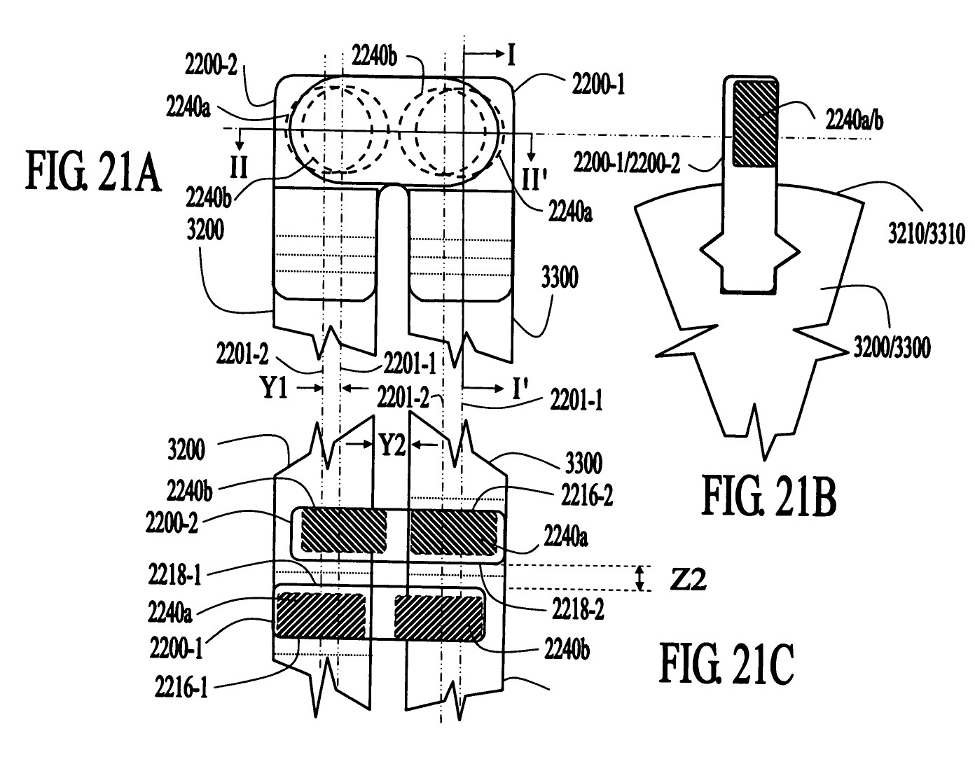

FIGS. 21A-C are various views of another exemplary torque transfer system in a reverse-convention mode of operation according to the present invention. FIGS. 21A-C include the individual features of FIGS. 16A-C, but functions to transmit torque using repulsive magnetic forces of opposite magnet faces of those shown in FIGS. 16A-C. In FIG. 21A, the exemplary torque transfer system may function in a reverse-convention mode, wherein the magnetic forces of the magnetic polar orientation of the opposite face regions 2218-1 (i.e., covered faces) of the magnets 2240a/b of the magnet holding members 2200-1 repel the magnetic forces of the magnetic polar orientation of the opposite face regions 2218-2 (i.e., covered faces) of the magnets 2240a/b of the holding members 2200-2. Thus, rotational torque supplied to the left side rotary assembly 3200 may be transmitted along a rotational direction that is opposite to the rotational direction corresponding to the torque transfer system of FIGS. 16A-C. In other words, the magnetic repulsion forces of the opposite face regions 2218-1 and 2218-2 will transmit the rotational torque supplied to the left side rotary assembly 3200 to the right side rotary assembly 3300.

In addition, a distance Z2 between the opposite face regions 2218-1 of the magnet holding members 2200-1 and the opposite face regions 2218-2 of the magnet holding members 2200-2 may decrease proportional to the rotational torque supplied to the left side assembly 3200. Accordingly, as the rotational torque supplied to the left side assembly 3200 increases, the distance Z2 may be reduced while continuing to transmit the rotational torque to the right side rotary assembly 3300. Conversely, as the rotational torque decreases, the distance Z2 may increase while continuing to transmit the rotational torque to the right side rotary assembly 3300. Thus, varying the rotational torque supplied to the left side rotary assembly 3200 will still result in continuous transmission of the varied rotational torque to the right side rotary assembly 3300. Here, the rotational torque supplied to the left side rotary assembly 3200 is approximately equal to the rotational torque supplied to the right side rotary assembly 3300. Furthermore, since variations in the rotational torque supplied to the left side rotary assembly 3200 (i.e., input torque) are nearly simultaneously transmitted to the right side rotary assembly 3300 (i.e., output torque), the input rotational torque at a time “t” is approximately equal to the output rotational torque at the time “t”, such that Tin(t)=Tout(t).

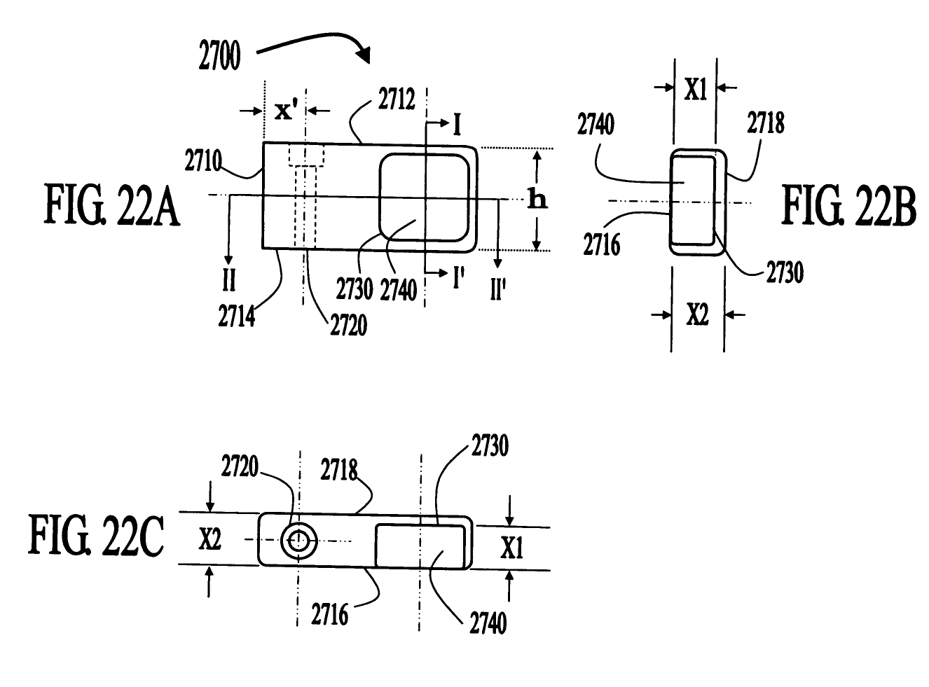

FIGS. 22A-C are multiple views of an eleventh exemplary magnet holding member according to the present invention. FIG. 22A is a side view of the eleventh exemplary magnet holding member, FIG. 22B is a cross sectional view of the eleventh exemplary magnet holding member of FIG. 22A along I-I′, and FIG. 22C is a cross sectional view of the eleventh exemplary magnet holding member of FIG. 22A along II-II′.

In FIG. 22A, an eleventh exemplary magnet holding member 2700 may include a body portion 2710 including a through hole 2720 disposed at a distance x′ from the first end of the body portion 2710 extending from a first surface 2712 of the body portion 2710 to a second surface 2714 of the body portion 2710, and through a thickness h of the body portion 2710. In addition, the body portion 2710 may include a magnet mounting adapter portion 2730 disposed at a second end of the body portion 2710 opposite to the first end of the body portion 2710.

As shown in FIGS. 22B and 22C, the magnet mounting adapter portion 2730 of the body portion 2710 extends from a third surface 2716 into the body portion 2710 by a distance X1 that is less than a thickness X2 of the body portion 2710, and does not extend completely through to a fourth surface 2718 of the body portion 2710. Accordingly, when a magnet holding adapter 2740 is mounted into the magnet mounting adapter portion 2730 of the body portion 2710, an outer surface 2742 of the magnet holding adapter 2740 may be substantially flush (coplanar) with the third surface 2716 of the body portion 2710. By using the magnet holding adapter 2740, a variety of different magnets and/or magnet geometries may be implemented without having to change each of the magnet holding members 2700. Thus, time for reconfiguring the torque transfer system to accommodate different rotational torque loads or operating conditions may be reduced.

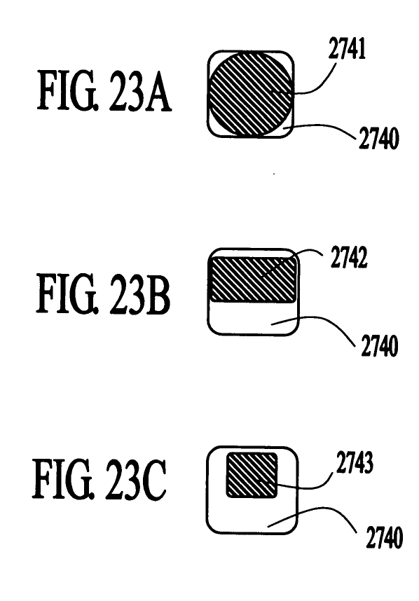

FIGS. 23A-C are various exemplary magnet holding adapters according to the present invention. In FIG. 23A, an exemplary magnet holding adapter 2740 may include a circular magnet 2741 concentrically disposed within the magnet holding adapter 2740. In FIG. 23B, the exemplary magnet holding adapter 2740 may include a rectangular magnet 2742 disposed toward an upper portion of the magnet holding adapter 2740. In FIG. 23C, the exemplary magnet holding adapter 2740 may include a square magnet 2743 disposed toward an upper portion of the magnet holding adapter 2740. Accordingly, since the magnets 2742 and 2743 may be considered to be relatively oriented within the magnet holding adapters 2740, addition adjustments may be made regarding the location of the repulsive magnet forces between adjacent pairs of the magnets 2742 and or between adjacent pairs of the magnets 2743. For example, the magnet 2742 within the magnet holding adapter 2740 may be placed within the magnet mounting adapter portion 2730 of the magnet holding member 2700 (in FIGS. 22A-C) at any one of four different clock-like orientations. Thus, the repulsive magnet forces may be positioned toward the first end of the body portion 2710, the second end of the body portion 2710, the first surface 2712, or the second surface 2714.

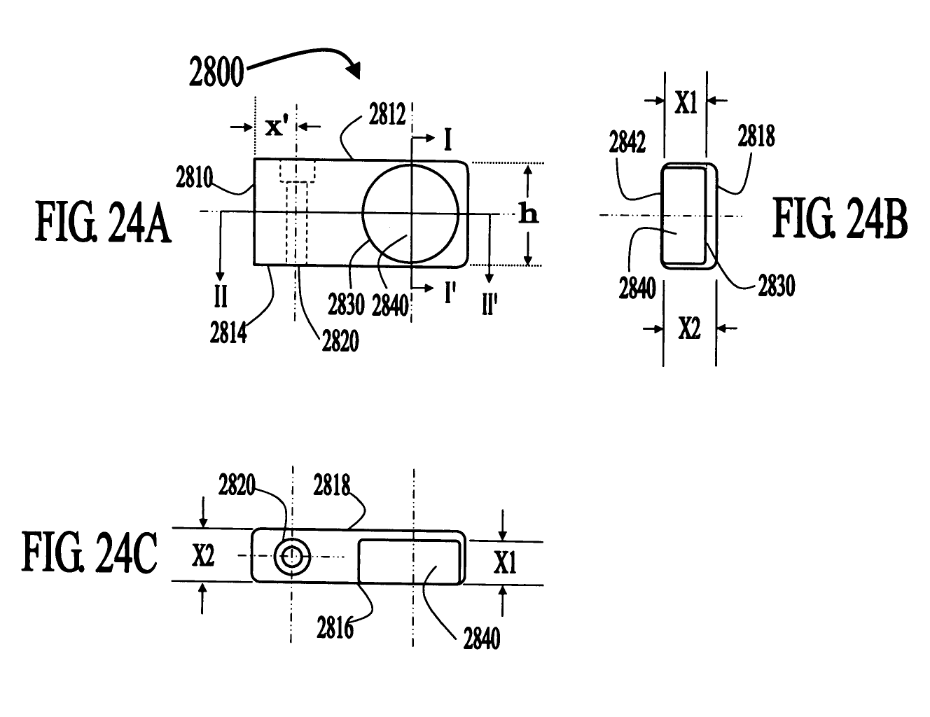

FIGS. 24A-C are multiple views of a twelfth exemplary magnet holding member according to the present invention. FIG. 24A is a side view of the twelfth exemplary magnet holding member, FIG. 24B is a cross sectional view of the twelfth exemplary magnet holding member of FIG. 24A along I-I′, and FIG. 24C is a cross sectional view of the twelfth exemplary magnet holding member of FIG. 24A along II-II′.

In FIG. 24A, a twelfth exemplary magnet holding member 2800 may include a body portion 2810 including a through hole 2820 disposed at a distance x′ from the first end of the body portion 2810 extending from a first surface 2812 of the body portion 2810 to a second surface 2814 of the body portion 2810, and through a thickness h of the body portion 2810. In addition, the body portion 2810 may include a magnet mounting adapter portion 2830 disposed at a second end of the body portion 2810 opposite to the first end of the body portion 2810.

As shown in FIGS. 24B and 24C, the magnet mounting adapter portion 2830 of the body portion 2810 extends from a third surface 2816 into the body portion 2810 by a distance X1 that is less than a thickness X2 of the body portion 2810, and does not extend completely through to a fourth surface 2818 of the body portion 2810. Accordingly, when a magnet holding adapter 2840 is mounted into the magnet mounting adapter portion 2830 of the body portion 2810, an outer surface 2842 of the magnet holding adapter 2840 may be substantially flush (coplanar) with the third surface 2816 of the body portion 2810. By using the magnet holding adapter 2840, a variety of different magnets and/or magnet geometries may be implemented without having to change each of the magnet holding members 2800. Thus, time for reconfiguring the torque transfer system to accommodate different rotational torque loads or operating conditions may be reduced.

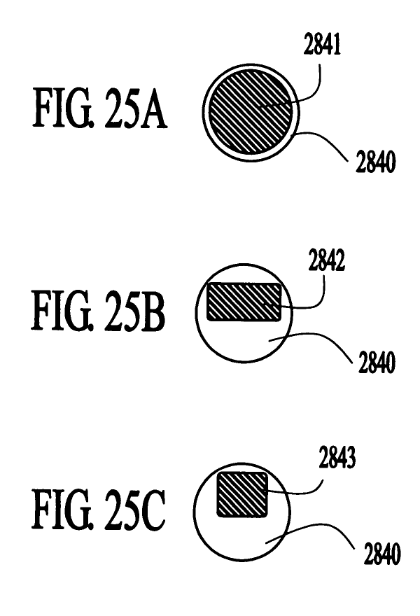

FIGS. 25A-C are various exemplary magnet holding adapters according to the present invention. In FIG. 25A, an exemplary magnet holding adapter 2840 may include a circular magnet 2841 concentrically disposed within the magnet holding adapter 2840. In FIG. 25B, the exemplary magnet holding adapter 2840 may include a rectangular magnet 2842 disposed toward an upper portion of the magnet holding adapter 2840. In FIG. 25C, the exemplary magnet holding adapter 2840 may include a square magnet 2843 disposed toward an upper portion of the magnet holding adapter 2840. Accordingly, since the magnets 2842 and 2843 may be considered to be relatively oriented within the magnet holding adapters 2840, addition adjustments may be made regarding the location of the repulsive magnet forces between adjacent pairs of the magnets 2842 and or between adjacent pairs of the magnets 2843. For example, the magnet 2842 within the magnet holding adapter 2840 may be placed within the magnet mounting adapter portion 2830 of the magnet holding member 2800 (in FIGS. 24A-C) at any one of four different clock-like orientations. Thus, the repulsive magnet forces may be positioned toward the first end of the body portion 2810, the second end of the body portion 2810, the first surface 2812, or the second surface 2814.

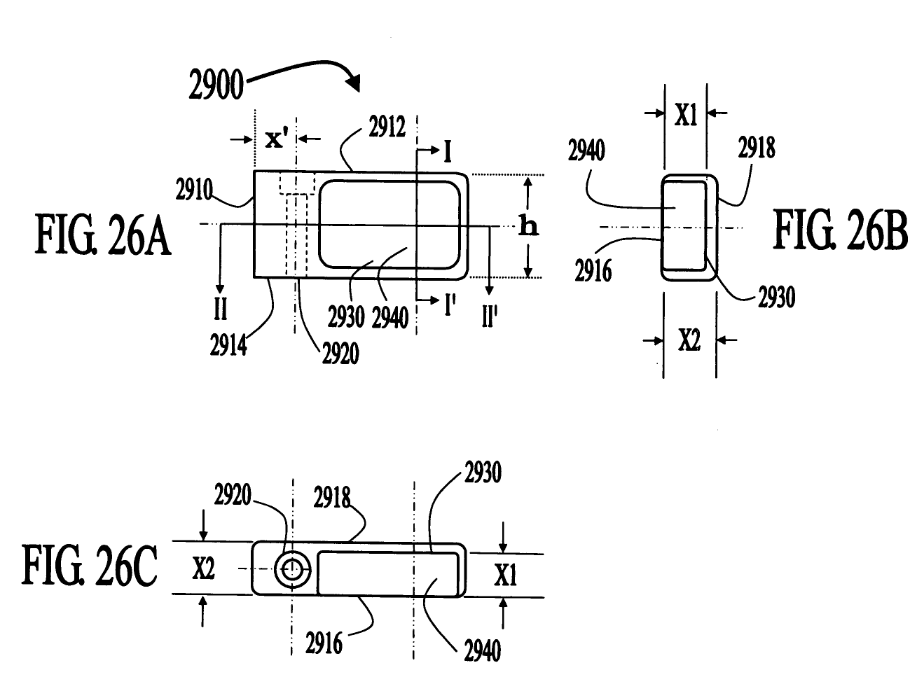

FIGS. 26A-C are multiple views of a thirteenth exemplary magnet holding member according to the present invention. FIG. 26A is a side view of the thirteenth exemplary magnet holding member, FIG. 26B is a cross sectional view of the thirteenth exemplary magnet holding member of FIG. 26A along I-I′, and FIG. 26C is a cross sectional view of the thirteenth exemplary magnet holding member of FIG. 26A along II-II′.

In FIG. 26A, a thirteenth exemplary magnet holding member 2900 may include a body portion 2910 including a through hole 2920 disposed at a distance x′ from the first end of the body portion 2910 extending from a first surface 2912 of the body portion 2910 to a second surface 2914 of the body portion 2910, and through a thickness h of the body portion 2910. In addition, the body portion 2910 may include a rectangular magnet mounting adapter portion 2930 disposed at a second end of the body portion 2910 opposite to the first end of the body portion 2910.

As shown in FIGS. 26B and 26C, the rectangular magnet mounting adapter portion 2930 of the body portion 2910 extends from a third surface 2916 into the body portion 2910 by a distance X1 that is less than a thickness X2 of the body portion 2910, and does not extend completely through to a fourth surface 2918 of the body portion 2910. Accordingly, when a rectangular magnet holding adapter 2940 is mounted into the rectangular magnet mounting adapter portion 2930 of the body portion 2910, an outer surface 2942 of the magnet holding adapter 2940 may be substantially flush (coplanar) with the third surface 2916 of the body portion 2910. By using the rectangular magnet holding adapter 2940, a variety of different magnets and/or magnet geometries may be implemented without having to change each of the magnet holding members 2900. Thus, time for reconfiguring the torque transfer system to accommodate different rotational torque loads or operating conditions may be reduced.

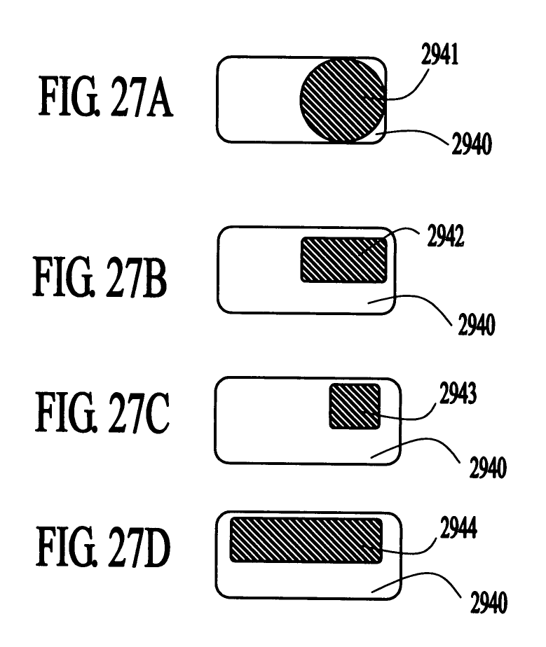

FIGS. 27A-D are various exemplary magnet holding adapters according to the present invention. In FIG. 27A, an exemplary rectangular magnet holding adapter 2940 may include a circular magnet 2941 concentrically disposed within the rectangular magnet holding adapter 2940. In FIG. 27B, the exemplary rectangular magnet holding adapter 2940 may include a rectangular magnet 2942 disposed toward an upper portion of the rectangular magnet holding adapter 2940. In FIG. 27C, the exemplary rectangular magnet holding adapter 2940 may include a square magnet 2943 disposed toward an upper portion of the rectangular magnet holding adapter 2940. In FIG. 27D, the exemplary rectangular magnet holding adapter 2940 may include a rectangular bar-shaped magnet 2944 disposed along an upper portion of the rectangular magnet holding adapter 2940. Accordingly, since the magnets 2942 and 2943 may be considered to be relatively oriented within the rectangular magnet holding adapters 2940, addition adjustments may be made regarding the location of the repulsive magnet forces between adjacent pairs of the magnets 2942 and or between adjacent pairs of the magnets 2943. For example, the magnet 2942 within the rectangular magnet holding adapter 2940 may be placed within the rectangular magnet mounting adapter portion 2930 of the rectangular magnet holding member 2900 (in FIGS. 26A-C) at any one of four different clock-like orientations. Thus, the repulsive magnet forces may be positioned toward the first end of the body portion 2910, the second end of the body portion 2910, the first surface 2912, or the second surface 2914.

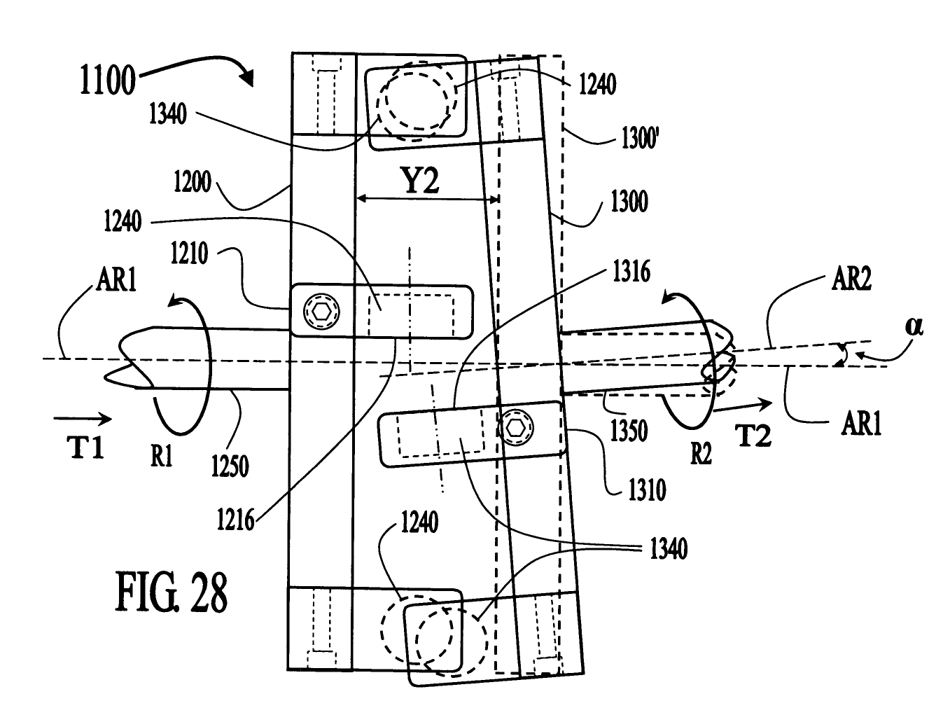

FIG. 28 is a side view of an exemplary torque transfer system operating in a first angular misalignment configuration in a forward-convention mode of operation according to the present invention. In FIG. 28, a left side rotary assembly 1200 may be coupled to a first rotational member 1250 to rotate along a first rotational direction R1 about a first axis of rotation AR1, and a right side rotary assembly 1300 may be coupled to a second rotational member 1350 to rotate along a second rotational direction R2 about a second axis of rotation AR2 angularly misaligned from the first axis of rotation AR1 by a misalignment angle a. For example, the misalignment angle a may be within a range of more than 0° to about 12°. In addition, although the misalignment angle a may be shown to extend above the first axis of rotation AR1, the misalignment angle α may also extend below the first axis of rotation AR1. Accordingly, opposing magnet faces 1216 and 1316 of the left and right side assemblies 1200 and 1300, respectively, may similarly be angularly misaligned by the misalignment angle α. However, due to the configuration of the interdigitated magnet holding members 1210 and 1310, a first torque T1 supplied to the first rotational member 1250 may be completely transferred to the second rotational member 1350 and transmitted to the second rotational member 1350 at a second torque T2.

In FIG. 28, the left side assembly 1200 may be spaced apart from an original orientation of the right side assembly 1300′ by an axial alignment distance Y2. Accordingly, the axial alignment distance Y2 may be varied (i.e., misaligned) by as much as 0.250 inches. Of course, in FIG. 28, the distance Y2 and the misalignment angle a may be increased or decreased depending upon an overall size of the torque transfer system 1100, as well as the size of the magnets 1240 and 1340. Moreover, each of the physical dimensions of the individual components of the exemplary torque transfer system of FIG. 28 may be proportionally scaleable. Furthermore, an upper limit of the axial misalignment Y2 may be determined by the physical geometry of the magnets and/or the magnet holding members 1210 and 1310.

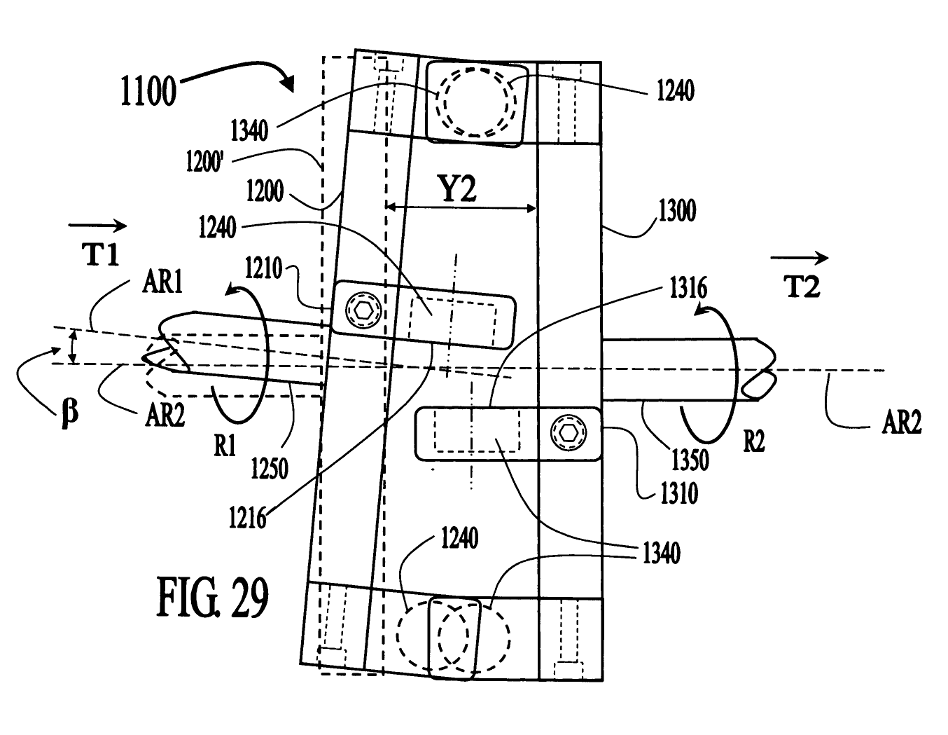

FIG. 29 is a side view of an exemplary torque transfer system operating in a second angular misalignment configuration in a forward-convention mode of operation according to the present invention. In FIG. 29, a right side rotary assembly 1300 may be coupled to a second rotational member 1350 to rotate along a second rotational direction R2 about a second axis of rotation AR2, and a left side rotary assembly 1200 may be coupled to a first rotational member 1250 to rotate along a first rotational direction R1 about a first axis of rotation AR1 angularly misaligned from the second axis of rotation AR2 by a misalignment angle β. For example, the misalignment angle β may be within a range of more than 0° to about 12°. In addition, although the misalignment angle β may be shown to extend above the second axis of rotation AR2, the misalignment angle β may also extend below the second axis of rotation AR2. Accordingly, opposing magnet faces 1216 and 1316 of the left and right side assemblies 1200 and 1300, respectively, may similarly be angularly misaligned by the misalignment angle β. However, due to the configuration of the interdigitated magnet holding members 1210 and 1310, a first torque T1 supplied to the first rotational member 1250 may be completely transferred to the second rotational member 1350 and transmitted to the second rotational member 1350 at a second torque T2.

In FIG. 29, the right side assembly 1300 may be spaced apart from an original orientation of the left side assembly 1200′ by an axial alignment distance Y2. Accordingly, the axial alignment distance Y2 may be varied (i.e., misaligned) by as much as 0.250 inches. Of course, in FIG. 29, the distance Y2 and the misalignment angle β may be increased or decreased depending upon an overall size of the torque transfer system 1100, as well as the size of the magnets 1240 and 1340. Moreover, each of the physical dimensions of the individual components of the exemplary torque transfer system of FIG. 29 may be proportionally scaleable. Furthermore, an upper limit of the axial misalignment Y2 may be determined by the physical geometry of the magnets and/or the magnet holding members 1210 and 1310.

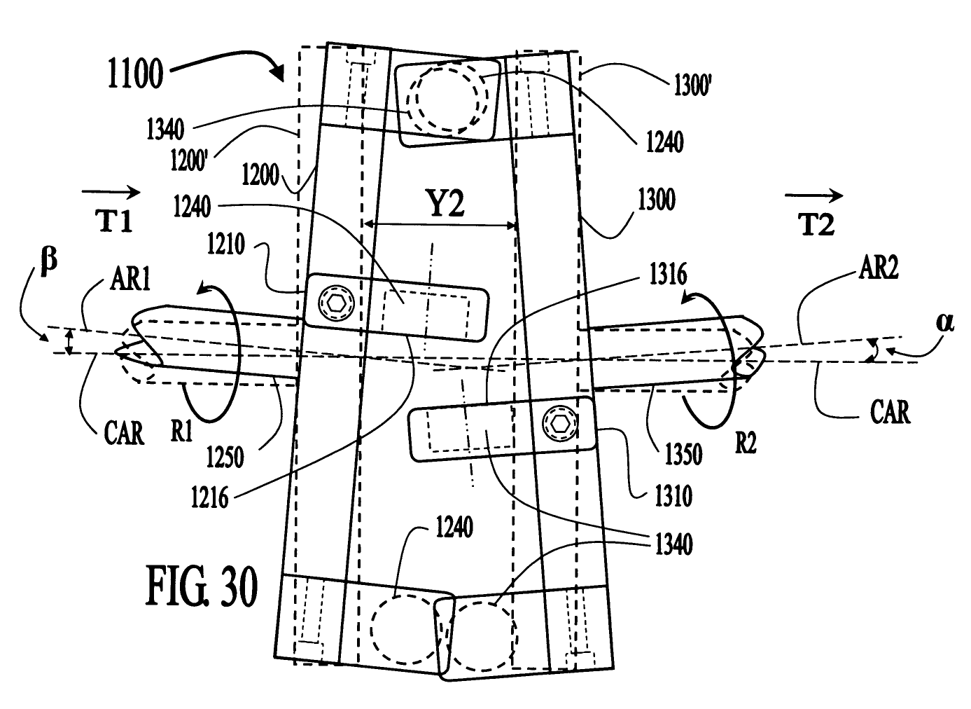

FIG. 30 is a side view of another exemplary torque transfer system operating in a third angular misalignment configuration in a forward-convention mode of operation according to the present invention. In FIG. 30, a right side rotary assembly 1300 may be coupled to a second rotational member 1350 to rotate along a second rotational direction R2 about a second axis of rotation AR2, and a left side rotary assembly 1200 may be coupled to a first rotational member 1250 to rotate along a first rotational direction R1 about a first axis of rotation AR1. In addition, the second axis of rotation AR2 is angularly misaligned from a central axis of rotation CAR by a misalignment angle β, and the first axis of rotation AR1 is angularly misaligned from a central axis of rotation CAR by a misalignment angle α. For example, the misalignment angle β may be within a range of more than 0° to about 12°, and the misalignment angle a may be within a range of more than 0° to about 12°. In addition, although the misalignment angles α and β may be shown to extend above the central axis of rotation CAR, the misalignment angles α and β may also extend below the central axis of rotation CAR. Moreover, either of the misalignment angles α and β may also extend above and below the central axis of rotation CAR. Accordingly, opposing magnet faces 1216 and 1316 of the left and right side assemblies 1200 and 1300, respectively, may similarly be angularly misaligned by the misalignment angles α and β. However, due to the configuration of the interdigitated magnet holding members 1210 and 1310, a first torque T1 supplied to the first rotational member 1250 may be completely transferred to the second rotational member 1350 and transmitted to the second rotational member 1350 at a second torque T2.

In FIG. 30, an original orientation of the left side assembly 1200′ may be spaced apart from an original orientation of the right side assembly 1300′ by an axial alignment distance Y2. Accordingly, the axial alignment distance Y2 may be varied (i.e., misaligned) by as much as 0.250 inches. Of course, in FIG. 30, the distance Y2 and the misalignment angles α and β may be increased or decreased depending upon an overall size of the torque transfer system 1100, as well as the size of the magnets 1240 and 1340. Moreover, each of the physical dimensions of the individual components of the exemplary torque transfer system of FIG. 30 may be proportionally scaleable. Furthermore, an upper limit of the axial misalignment Y2 may be determined by the physical geometry of the magnets and/or the magnet holding members 1210 and 1310.

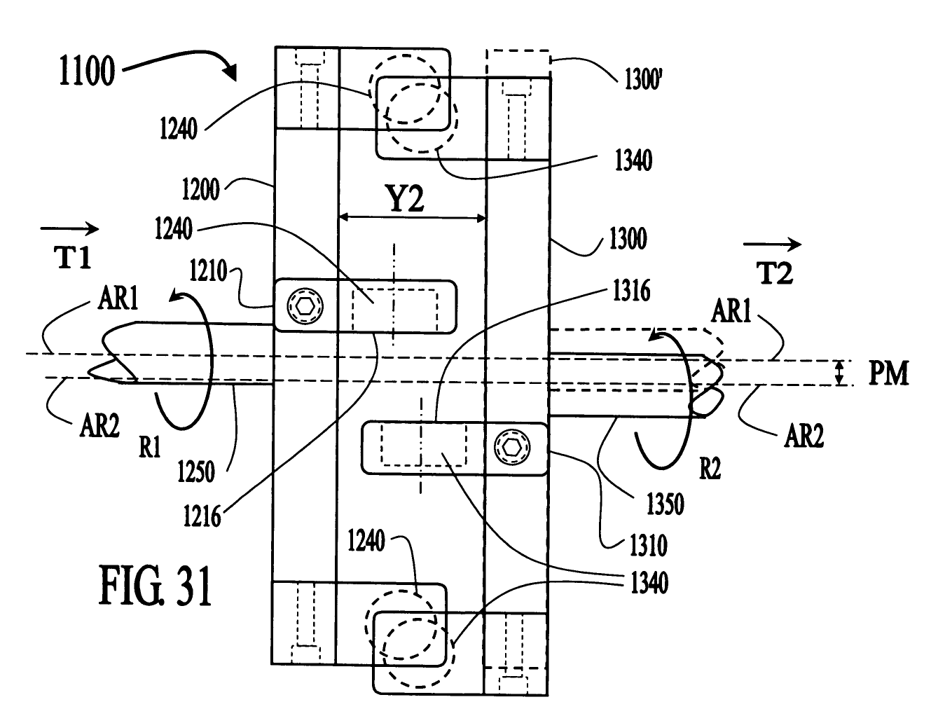

FIG. 31 is a side view of an exemplary torque transfer system operating in a first parallel misalignment configuration in a forward-convention mode of operation according to the present invention. In FIG. 31, a left side rotary assembly 1200 may be coupled to a first rotational member 1250 to rotate along a first rotational direction R1 about a first axis of rotation AR1, and a right side rotary assembly 1300 may be coupled to a second rotational member 1350 to rotate along a first rotational direction R1 about a second axis of rotation AR2 parallel misaligned from the first axis of rotation AR1 by an parallel misalignment PM. For example, the parallel misalignment PM may be up to about 0.200″. Of course, the amount of parallel misalignment PM is dependent upon an overall size of the torque transfer system, such that the amount of parallel misalignment PM is scalable.

In addition, although the parallel misalignment PM is shown such that the first axis of rotation AR1 is disposed above the second axis of rotation AR2, the parallel misalignment PM may include the second axis of rotation AR2 being disposed above the first axis of rotation AR1. Accordingly, opposing magnet faces 1216 and 1316 of the left and right side assemblies 1200 and 1300, respectively, may similarly be axially offset by the parallel misalignment PM. However, due to the configuration of the interdigitated magnet holding members 1210 and 1310, a first torque T1 supplied to the first rotational member 1250 may be completely transferred to the second rotational member 1350 and transmitted to the second rotational member 1350 at a second torque T2.

In FIG. 31, the left side assembly 1200 may be spaced apart from an original orientation of the right side assembly 1300′ by an axial alignment distance Y2. Accordingly, the axial alignment distance Y2 may be varied (i.e., misaligned) by as much as 0.250 inches. Of course, in FIG. 31, the distance Y2 and the parallel misalignment PM may be increased or decreased depending upon an overall size of the torque transfer system 1100, as well as the size of the magnets 1240 and 1340. Moreover, each of the physical dimensions of the individual components of the exemplary torque transfer system of FIG. 31 may be proportionally scaleable. Furthermore, an upper limit of the axial misalignment Y2 may be determined by the physical geometry of the magnets and/or the magnet holding members 1210 and 1310.

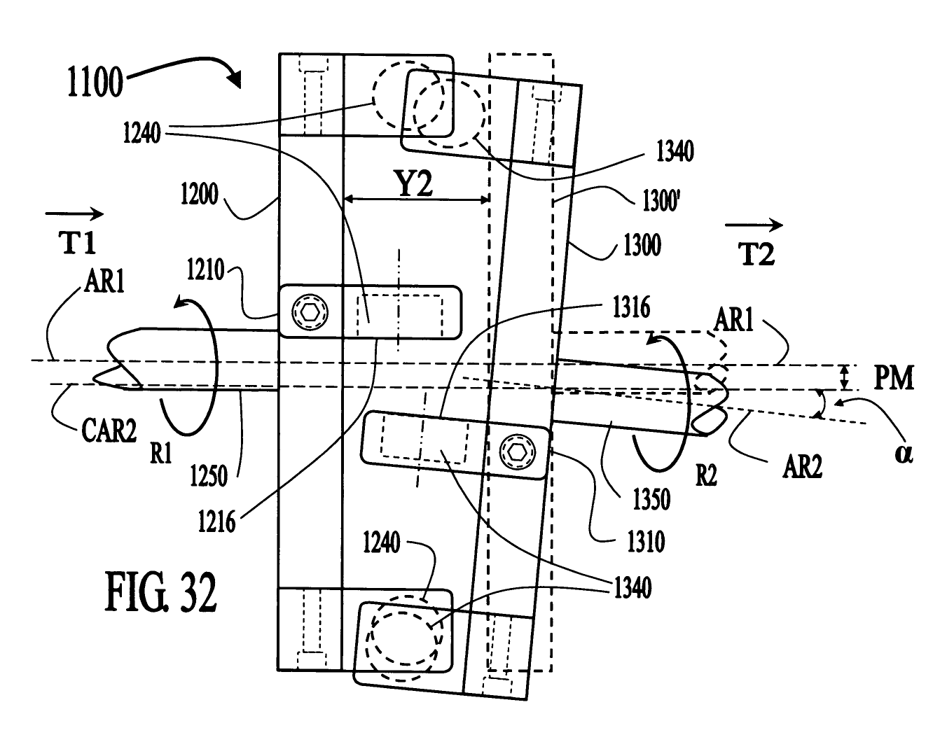

FIG. 32 is a side view of an exemplary torque transfer system operating in a first angular misalignment and parallel misalignment configuration in a forward-convention mode of operation according to the present invention. FIG. 32 may include a combination of the angular misalignment configuration of FIG. 28 and parallel misalignment configuration of FIG. 31. In FIG. 32, a left side rotary assembly 1200 may be coupled to a first rotational member 1250 to rotate along a first rotational direction R1 about a first axis of rotation AR1, and a right side rotary assembly 1300 may be coupled to a second rotational member 1350 to rotate along a second rotational direction R2 about a second axis of rotation AR2 parallel misaligned from the first axis of rotation AR1 by a parallel misalignment PM. For example, the parallel misalignment PM may be up to about 0.200″. Of course, the amount of parallel misalignment PM is dependent upon an overall size of the torque transfer system, such that the amount of parallel misalignment PM is scalable.

In addition, the second axis of rotation AR2 is angularly misaligned from the central axis of rotation CAR2 of the second axis of rotation AR2 by a misalignment angle α. For example, the misalignment angle α may be within a range of more than 0° to about 12°. Although the parallel misalignment PM is shown such that the first axis of rotation AR1 is disposed above the second axis of rotation AR2, the parallel misalignment PM may include the second axis of rotation AR2 being disposed above the first axis of rotation AR1. Moreover, although the misalignment angle a may be shown to extend below the central axis of rotation CAR2 of the second axis of rotation AR2, the misalignment angle α may also extend above central axis of rotation CAR2 of the second axis of rotation AR2. Accordingly, opposing magnet faces 1216 and 1316 of the left and right side assemblies 1200 and 1300, respectively, may similarly be misaligned in parallel by the parallel misalignment PM and angularly misaligned by the misalignment angle α. However, due to the configuration of the interdigitated magnet holding members 1210 and 1310, a first torque T1 supplied to the first rotational member 1250 may be completely transferred to the second rotational member 1350 and transmitted to the second rotational member 1350 at a second torque T2.

In FIG. 32, the left side assembly 1200 may be spaced apart from an original orientation of the right side assembly 1300′ by an axial alignment distance Y2. Accordingly, the axial alignment distance Y2 may be varied (i.e., misaligned) by as much as 0.250 inches. Of course, in FIG. 32, the distance Y2, the misalignment angle α, and the parallel misalignment PM may be increased or decreased depending upon an overall size of the torque transfer system 1100, as well as the size of the magnets 1240 and 1340. Moreover, each of the physical dimensions of the individual components of the exemplary torque transfer system of FIG. 32 may be proportionally scaleable. Furthermore, an upper limit of the axial misalignment Y2 may be determined by the physical geometry of the magnets and/or the magnet holding members 1210 and 1310.

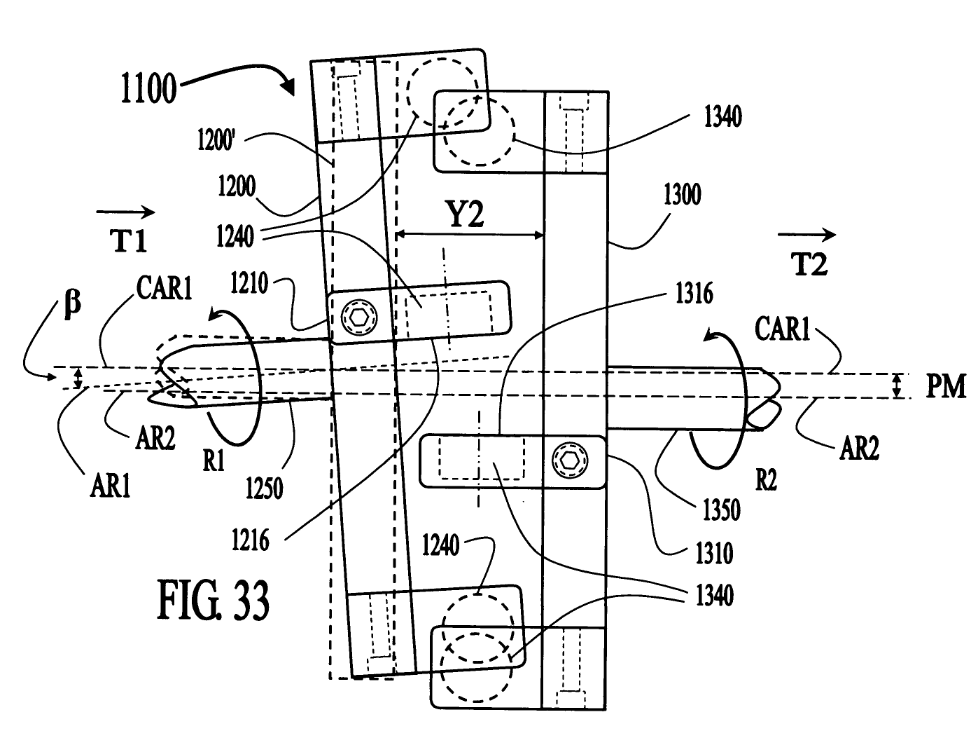

FIG. 33 is a side view of an exemplary torque transfer system operating in a second angular misalignment and parallel misalignment configuration in a forward-convention mode of operation according to the present invention. FIG. 33 may include a combination of the angular misalignment configuration of FIG. 29 and the parallel misalignment configuration of FIG. 31. In FIG. 33, a right side rotary assembly 1300 may be coupled to a second rotational member 1350 to rotate along a second rotational direction R2 about a second axis of rotation AR2, and a left side rotary assembly 1200 may be coupled to a first rotational member 1250 to rotate along a first rotational direction R1 about a first axis of rotation AR1 axially offset from the second axis of rotation AR2 by a parallel misalignment PM. For example, the parallel misalignment PM may be up to about 0.200″. Of course, the amount of parallel misalignment PM is dependent upon an overall size of the torque transfer system, such that the amount of parallel misalignment PM is scalable.

In addition, the first axis of rotation AR1 is angularly misaligned from the central axis of rotation CAR1 of the first axis of rotation AR1 by a misalignment angle β. For example, the misalignment angle β may be within a range of more than 0° to about 12°. Although the parallel misalignment PM is shown such that the second axis of rotation AR2 is disposed below the central axis of rotation CAR1 of the first axis of rotation AR1, the parallel misalignment PM may include the second axis of rotation AR2 being disposed above the central axis of rotation CAR1 of the first axis of rotation AR1. Moreover, although the misalignment angle β may be shown to extend below the central axis of rotation CAR1 of the first axis of rotation AR1, the misalignment angle β may also extend above central axis of rotation CAR1 of the first axis of rotation AR1. Accordingly, opposing magnet faces 1216 and 1316 of the left and right side assemblies 1200 and 1300, respectively, may similarly be misaligned by the parallel misalignment PM and angularly misaligned by the misalignment angle β. However, due to the configuration of the interdigitated magnet holding members 1210 and 1310, a first torque T1 supplied to the first rotational member 1250 may be completely transferred to the second rotational member 1350 and transmitted to the second rotational member 1350 at a second torque T2.

In FIG. 33, the right side assembly 1300 may be spaced apart from an original orientation of the left side assembly 1200′ by an axial alignment distance Y2. Accordingly, the axial alignment distance Y2 may be varied (i.e., misaligned) by as much as 0.250 inches. Of course, in FIG. 33, the distance Y2, the misalignment angle β, and the parallel misalignment PM may be increased or decreased depending upon an overall size of the torque transfer system 1100, as well as the size of the magnets 1240 and 1340. Moreover, each of the physical dimensions of the individual components of the exemplary torque transfer system of FIG. 33 may be proportionally scaleable. Furthermore, an upper limit of the axial misalignment Y2 may be determined by the physical geometry of the magnets and/or the magnet holding members 1210 and 1310.

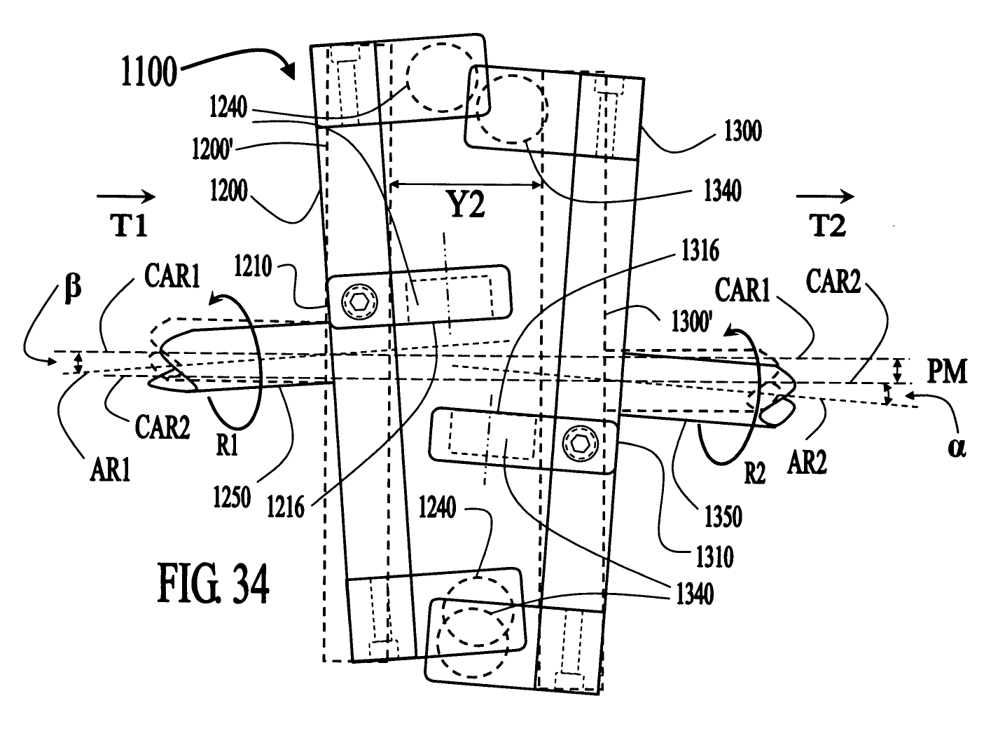

FIG. 34 is a side view of an exemplary torque transfer system operating in a second angular misalignment and parallel misalignment configuration in a forward-convention mode of operation according to the present invention. FIG. 34 may include a combination of the angular misalignment configurations of FIGS. 28 and 29 and the parallel misalignment configuration of FIG. 31. In FIG. 34, a left side rotary assembly 1200 may be coupled to a first rotational member 1250 to rotate along a first rotational direction R1 about a first axis of rotation AR1 angularly misaligned from a central axis of rotation CAR1 of the first axis of rotation AR1 by a misalignment angle β. In addition, a right side rotary assembly 1300 may be coupled to a second rotational member 1350 to rotate along a second rotational direction R2 about a second axis of rotation AR2 angularly misaligned from a central axis of rotation CAR2 of the second axis of rotation AR2 by a misalignment angle α. Moreover, the central axis of rotation CAR1 of the first axis of rotation AR1 is parallel misaligned from the central axis of rotation CAR2 of the second axis of rotation AR2 by a parallel misalignment PM. For example, the parallel misalignment PM may be up to about 0.200″, and the misalignment angles α and β may both be within a range of more than 0° to about 12°.

In FIG. 34, although the parallel misalignment is shown such that the central axis of rotation CAR1 of the first axis of rotation AR1 is disposed above the central axis of rotation CAR2 of the second axis of rotation AR2, the parallel misalignment PM may include the central axis of rotation CAR2 of the second axis of rotation AR2 above the central axis of rotation CAR1 of the first axis of rotation AR1. Moreover, although the misalignment angle a may be shown to extend below the central axis of rotation CAR2 of the second axis of rotation AR2, the misalignment angle a may also extend above central axis of rotation CAR2 of the second axis of rotation AR2. Furthermore, although the misalignment angle β may be shown to extend below the central axis of rotation CAR1 of the first axis of rotation AR1, the misalignment angle β may also extend above central axis of rotation CAR1 of the first axis of rotation AR1. Accordingly, opposing magnet faces 1216 and 1316 of the left and right side assemblies 1200 and 1300, respectively, may similarly be parallel misaligned by the parallel misalignment PM and angularly misaligned by the misalignment angles α and β3. However, due to the configuration of the interdigitated magnet holding members 1210 and 1310, a first torque T1 supplied to the first rotational member 1250 may be completely transferred to the second rotational member 1350 and transmitted to the second rotational member 1350 at a second torque T2.

In FIG. 34, an original orientation of the left side assembly 1200′ may be spaced apart from an original orientation of the right side assembly 1300′ by an axial alignment distance Y2. Accordingly, the axial alignment distance Y2 may be varied (i.e., misaligned) by as much as 0.250 inches. Of course, in FIG. 34, the distance Y2, the misalignment angles α and β, and the parallel misalignment PM may be increased or decreased depending upon an overall size of the torque transfer system 1100, as well as the size of the magnets 1240 and 1340. Moreover, each of the physical dimensions of the individual components of the exemplary torque transfer system of FIG. 34 may be proportionally scaleable. Furthermore, an upper limit of the axial misalignment Y2 may be determined by the physical geometry of the magnets and/or the magnet holding members 1210 and 1310.

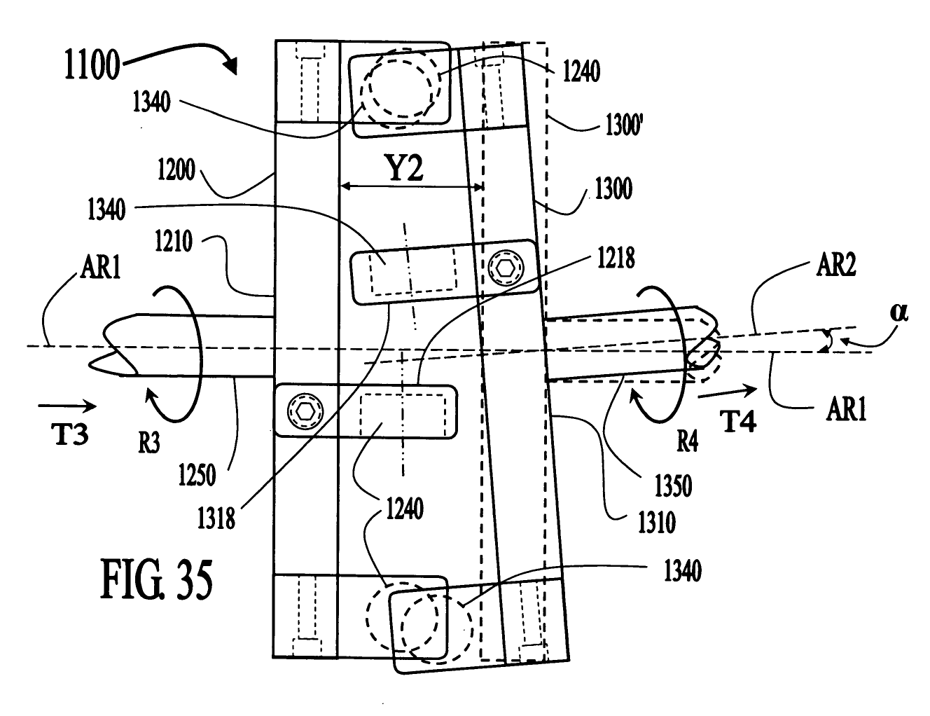

FIG. 35 is a side view of an exemplary torque transfer system operating in a first angular misalignment configuration in a reverse-convention mode of operation according to the present invention. In FIG. 35, a left side rotary assembly 1200 may be coupled to a first rotational member 1250 to rotate along a third rotational direction R3 about a first axis of rotation AR1, and a right side rotary assembly 1300 may be coupled to a second rotational member 1350 to rotate along a fourth rotational direction R4 about a second axis of rotation AR2 angularly misaligned from the first axis of rotation AR1 by a misalignment angle α. For example, the misalignment angle α may be within a range of more than 0° to about 12°. In addition, although the misalignment angle α may be shown to extend above the first axis of rotation AR1, the misalignment angle a may also extend below the first axis of rotation AR1. Accordingly, opposing magnet faces 1218 and 1318 (i.e., cover faces) of the left and right side assemblies 1200 and 1300, respectively, may similarly be angularly misaligned by the misalignment angle α. However, due to the configuration of the interdigitated magnet holding members 1210 and 1310, a third torque T3 supplied to the first rotational member 1250 may be completely transferred to the second rotational member 1350 and transmitted to the second rotational member 1350 at a fourth torque T4.

In FIG. 35, the left side assembly 1200 may be spaced apart from an original orientation of the right side assembly 1300′ by an axial alignment distance Y2. Accordingly, the axial alignment distance Y2 may be varied (i.e., misaligned) by as much as 0.250 inches. Of course, in FIG. 35, the distance Y2 and the misalignment angle α may be increased or decreased depending upon an overall size of the torque transfer system 1100, as well as the size of the magnets 1240 and 1340. Moreover, each of the physical dimensions of the individual components of the exemplary torque transfer system of FIG. 35 may be proportionally scaleable. Furthermore, an upper limit of the axial misalignment Y2 may be determined by the physical geometry of the magnets and/or the magnet holding members 1210 and 1310.

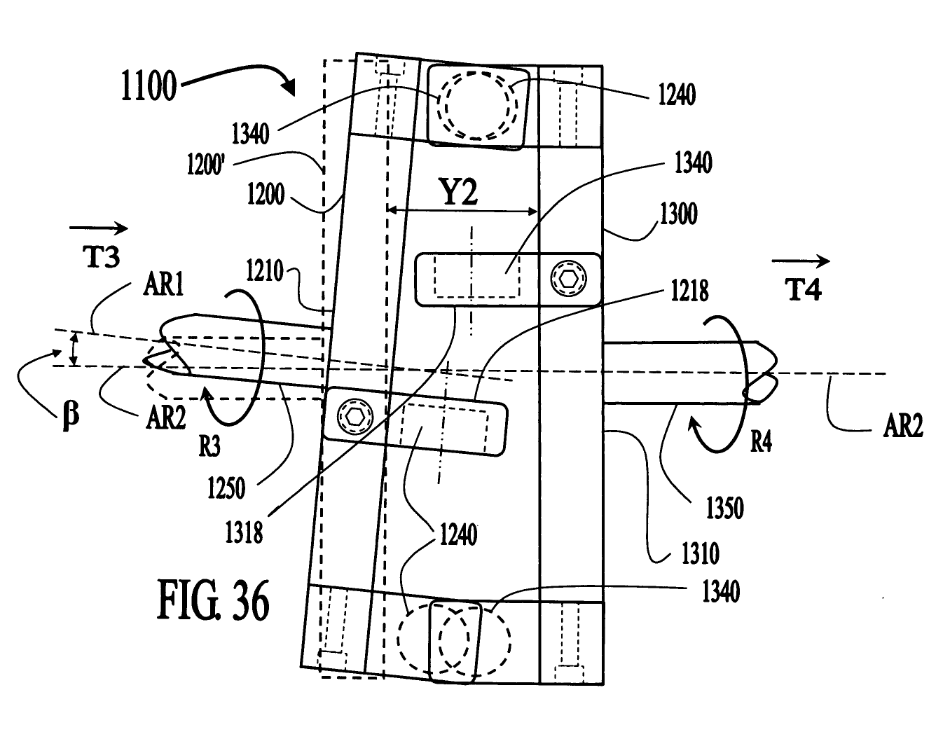

FIG. 36 is a side view of another exemplary torque transfer system operating in a second angular misalignment configuration in reverse-convention mode of operation according to the present invention. In FIG. 36, a right side rotary assembly 1300 may be coupled to a second rotational member 1350 to rotate along a fourth rotational direction R4 about a second axis of rotation AR2, and a left side rotary assembly 1200 may be coupled to a first rotational member 1250 to rotate along a third rotational direction R3 about a first axis of rotation AR1 angularly misaligned from the second axis of rotation AR2 by a misalignment angle β. For example, the misalignment angle β may be within a range of more than 0° to about 12°. In addition, although the misalignment angle β may be shown to extend above the second axis of rotation AR2, the misalignment angle β may also extend below the second axis of rotation AR2. Accordingly, opposing magnet faces 1218 and 1318 (i.e., covered faces) of the left and right side assemblies 1200 and 1300, respectively, may similarly be angularly misaligned by the misalignment angle β. However, due to the configuration of the interdigitated magnet holding members 1210 and 1310, a third torque T3 supplied to the first rotational member 1250 may be completely transferred to the second rotational member 1350 and transmitted to the second rotational member 1350 at a fourth torque T4.

In FIG. 36, the right side assembly 1300 may be spaced apart from an original orientation of the left side assembly 1200′ by an axial alignment distance Y2. Accordingly, the axial alignment distance Y2 may be varied (i.e., misaligned) by as much as 0.250 inches. Of course, in FIG. 36, the distance Y2 and the misalignment angle β may be increased or decreased depending upon an overall size of the torque transfer system 1100, as well as the size of the magnets 1240 and 1340. Moreover, each of the physical dimensions of the individual components of the exemplary torque transfer system of FIG. 36 may be proportionally scaleable. Furthermore, an upper limit of the axial misalignment Y2 may be determined by the physical geometry of the magnets and/or the magnet holding members 1210 and 1310.

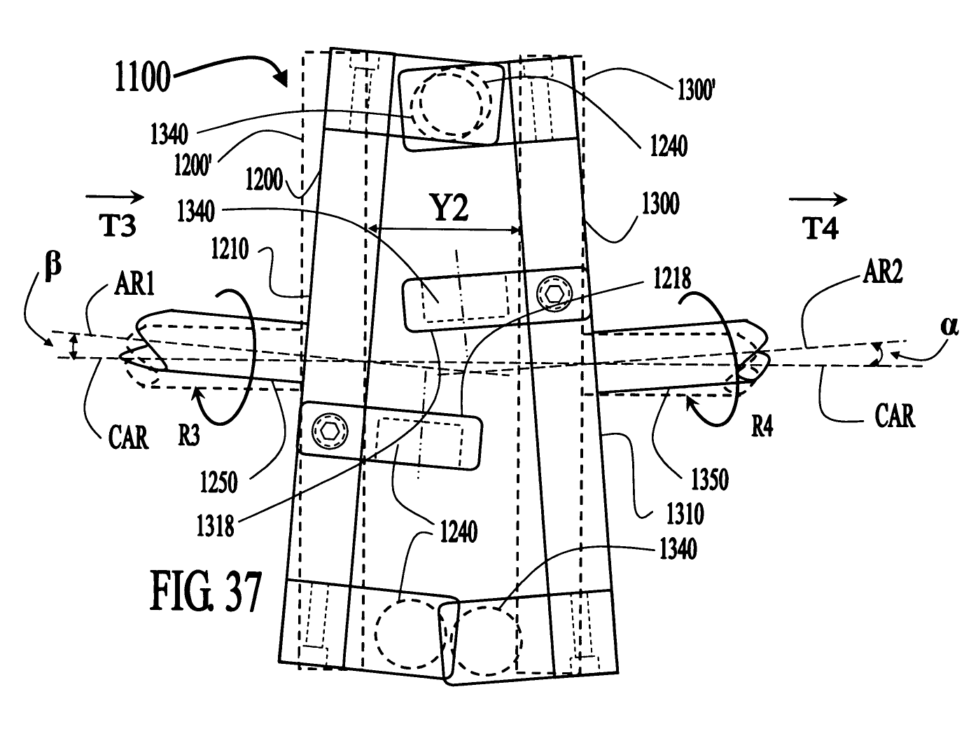

FIG. 37 is a side view of another exemplary torque transfer system operating in a third angular misalignment configuration in a reverse-convention mode of operation according to the present invention. In FIG. 37, a right side rotary assembly 1300 may be coupled to a second rotational member 1350 to rotate along a fourth rotational direction R4 about a second axis of rotation AR2, and a left side rotary assembly 1200 may be coupled to a first rotational member 1250 to rotate along a third rotational direction R3 about a first axis of rotation AR1. In addition, the second axis of rotation AR2 is angularly misaligned from a central axis of rotation CAR by a misalignment angle β, and the first axis of rotation AR1 is angularly misaligned from a central axis of rotation CAR by a misalignment angle α. For example, the misalignment angle β may be within a range of more than 0° to about 12°, and the misalignment angle α may be within a range of more than 0° to about 12°. In addition, although the misalignment angles α and β may be shown to extend above the central axis of rotation CAR, the misalignment angles α and β may also extend below the central axis of rotation CAR. Moreover, either of the misalignment angles α and β may also extend above and below the central axis of rotation CAR. Accordingly, opposing magnet faces 1218 and 1318 (i.e., covered faces) of the left and right side assemblies. 1200 and 1300, respectively, may similarly be angularly misalignment by the misalignment angles α and β. However, due to the configuration of the interdigitated magnet holding members 1210 and 1310, a third torque T3 supplied to the first rotational member 1250 may be completely transferred to the second rotational member 1350 and transmitted to the second rotational member 1350 at a fourth torque T4.

In FIG. 37, an original orientation of the left side assembly 1200′ may be spaced apart from an original orientation of the right side assembly 1300′ by an axial alignment distance Y2. Accordingly, the axial alignment distance Y2 may be varied (i.e., misaligned) by as much as 0.250 inches. Of course, in FIG. 37, the distance Y2 and the misalignment angles α and β may be increased or decreased depending upon an overall size of the torque transfer system 1100, as well as the size of the magnets 1240 and 1340. Moreover, each of the physical dimensions of the individual components of the exemplary torque transfer system of FIG. 37 may be proportionally scaleable. Furthermore, an upper limit of the axial misalignment Y2 may be determined by the physical geometry of the magnets and/or the magnet holding members 1210 and 1310.

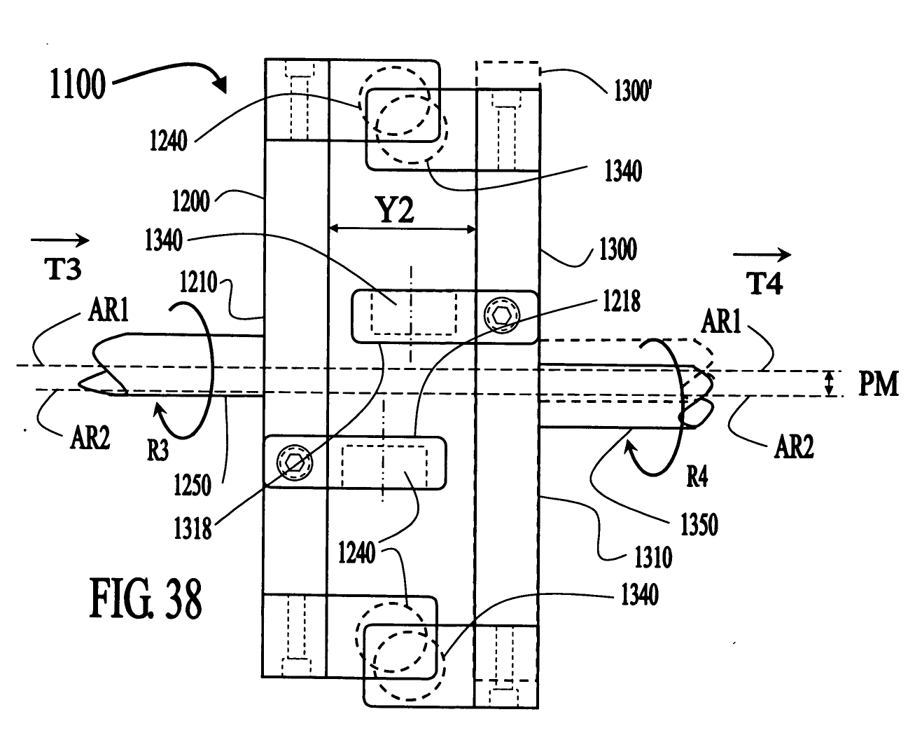

FIG. 38 is a side view of an exemplary torque transfer system operating in a first parallel misalignment configuration in a reverse-convention mode of operation according to the present invention. In FIG. 38, a left side rotary assembly 1200 may be coupled to a first rotational member 1250 to rotate along a third rotational direction R3 about a first axis of rotation AR1, and a right side rotary assembly 1300 may be coupled to a second rotational member 1350 to rotate along a fourth rotational direction R4 about a second axis of rotation AR2 parallel misaligned from the first axis of rotation AR1 by a parallel misalignment PM. For example, the parallel misalignment PM may be up to about 0.200″.

In addition, although the parallel misalignment PM is shown such that the first axis of rotation AR1 is disposed above the second axis of rotation AR2, the parallel misalignment PM may include the second axis of rotation AR2 being disposed above the first axis of rotation AR1. Accordingly, opposing magnet faces 1218 and 1318 (i.e., covered faces) of the left and right side assemblies 1200 and 1300, respectively, may similarly be parallel misaligned by the parallel misalignment PM. However, due to the configuration of the interdigitated magnet holding members 1210 and 1310, a third torque T3 supplied to the first rotational member 1250 may be completely transferred to the second rotational member 1350 and transmitted to the second rotational member 1350 at a fourth torque T4.

In FIG. 38, the left side assembly 1200 may be spaced apart from an original orientation of the right side assembly 1300′ by an axial alignment distance Y2. Accordingly, the axial alignment distance Y2 may be varied (i.e., misaligned) by as much as 0.250 inches. Of course, in FIG. 38, the distance Y2 and the parallel misalignment PM may be increased or decreased depending upon an overall size of the torque transfer system 1100, as well as the size of the magnets 1240 and 1340. Moreover, each of the physical dimensions of the individual components of the exemplary torque transfer system of FIG. 38 may be proportionally scaleable. Furthermore, an upper limit of the axial misalignment Y2 may be determined by the physical geometry of the magnets and/or the magnet holding members 1210 and 1310.

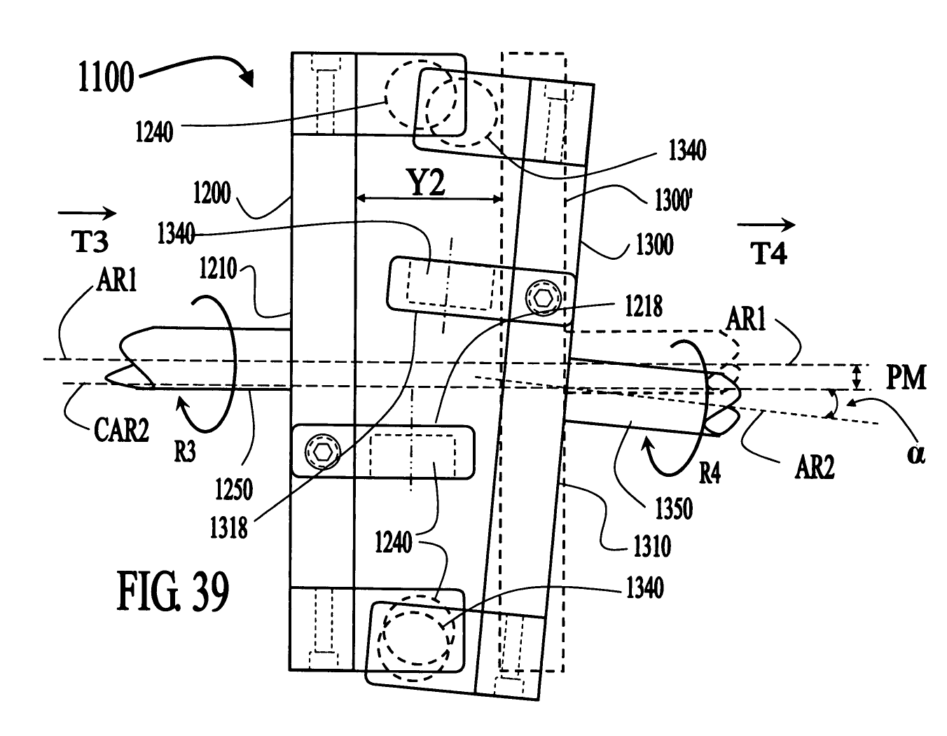

FIG. 39 is a side view of an exemplary torque transfer system operating in a first angular misalignment and parallel misalignment configuration in a reverse-convention mode of operation according to the present invention. FIG. 39 may include a combination of the angular misalignment configuration of FIG. 35 and the parallel misalignment configuration of FIG. 38. In FIG. 39, a left side rotary assembly 1200 may be coupled to a first rotational member 1250 to rotate along a third rotational direction R3 about a first axis of rotation AR1, and a right side rotary assembly 1300 may be coupled to a second rotational member 1350 to rotate along a fourth rotational direction R4 about a second axis of rotation AR2 parallel misaligned from the first axis of rotation AR1 by a parallel misalignment PM. For example, the parallel misalignment PM may be up to about 0.200″.

In addition, the second axis of rotation AR2 is angularly misaligned from the central axis of rotation CAR2 of the second axis of rotation AR2 by a misalignment angle α. For example, the misalignment angle α may be within a range of more than 0° to about 12°. Although the parallel misalignment PM is shown such that the first axis of rotation AR1 is disposed above the second axis of rotation AR2, the parallel misalignment PM may include the second axis of rotation AR2 being disposed above the first axis of rotation AR1. Moreover, although the misalignment angle a may be shown to extend below the central axis of rotation CAR2 of the second axis of rotation AR2, the misalignment angle α may also extend above central axis of rotation CAR2 of the second axis of rotation AR2. Accordingly, opposing magnet faces 1218 and 1318 (i.e., covered faces) of the left and right side assemblies 1200 and 1300, respectively, may similarly be parallel misaligned by the parallel misalignment PM and angularly misaligned by the misalignment angle α. However, due to the configuration of the interdigitated magnet holding members 1210 and 1310, a third torque T3 supplied to the first rotational member 1250 may be completely transferred to the second rotational member 1350 and transmitted to the second rotational member 1350 at a fourth torque T4.

In FIG. 39, the left side assembly 1200 may be spaced apart from an original orientation of the right side assembly 1300′ by an axial alignment distance Y2. Accordingly, the axial alignment distance Y2 may be varied (i.e., misaligned) by as much as 0.250 inches. Of course, in FIG. 39, the distance Y2, the misalignment angle α, and the parallel misalignment PM may be increased or decreased depending upon an overall size of the torque transfer system 1100, as well as the size of the magnets 1240 and 1340. Moreover, each of the physical dimensions of the individual components of the exemplary torque transfer system of FIG. 39 may be proportionally scaleable. Furthermore, an upper limit of the axial misalignment Y2 may be determined by the physical geometry of the magnets and/or the magnet holding members 1210 and 1310.

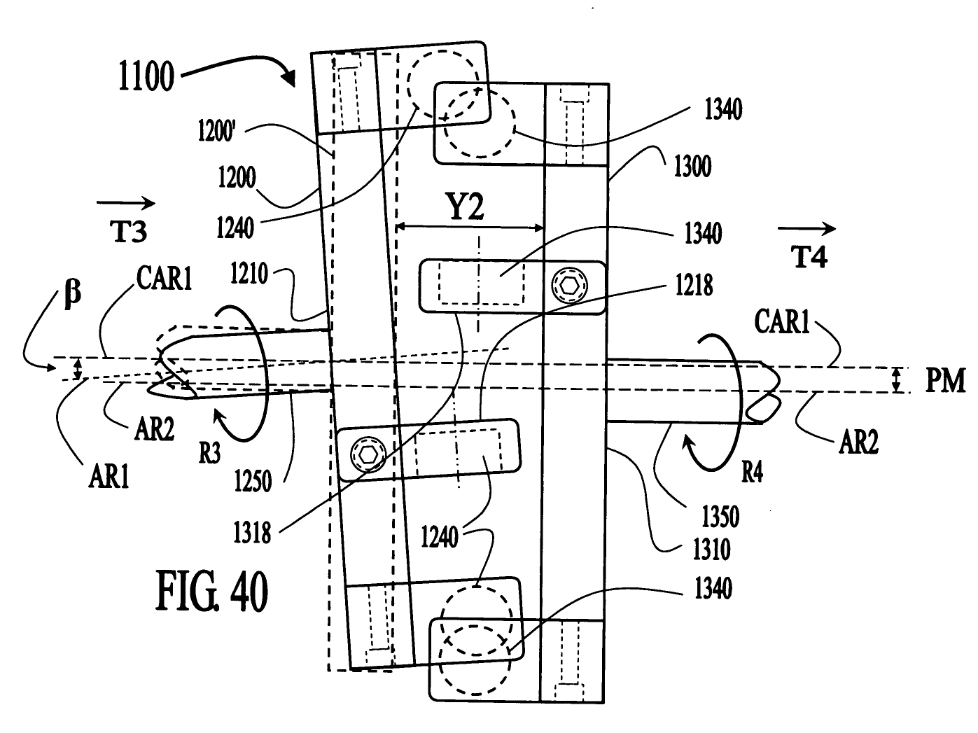

FIG. 40 is a side view of an exemplary torque transfer system operating in a second angular misalignment and parallel misalignment configuration in a reverse-convention mode of operation according to the present invention. FIG. 40 may include a combination of the angular misalignment configuration of FIG. 36 and the parallel misalignment configuration of FIG. 35. In FIG. 40, a right side rotary assembly 1300 may be coupled to a second rotational member 1350 to rotate along a fourth rotational direction R4 about a second axis of rotation AR2, and a left side rotary assembly 1200 may be coupled to a first rotational member 1250 to rotate along a third rotational direction R3 about a first axis of rotation AR1 parallel misaligned from the second axis of rotation AR2 by a parallel misalignment PM. For example, the parallel misalignment PM may be up to about 0.200″.

In addition, the first axis of rotation AR1 is angularly misaligned from the central axis of rotation CAR1 of the first axis of rotation AR1 by a misalignment angle β. For example, the misalignment angle β may be within a range of more than 0° to about 12°. Although the parallel misalignment PM is shown such that the second axis of rotation AR2 is disposed below the central axis of rotation CAR1 of the first axis of rotation AR1, the parallel misalignment PM may include the second axis of rotation AR2 being disposed above the central axis of rotation CAR1 of the first axis of rotation AR1. Moreover, although the misalignment angle β may be shown to extend below the central axis of rotation CAR1 of the first axis of rotation AR1, the misalignment angle β may also extend above central axis of rotation CAR1 of the first axis of rotation AR1. Accordingly, opposing magnet faces 1218 and 1318 (i.e., covered faces) of the left and right side assemblies 1200 and 1300, respectively, may similarly be parallel misaligned by the parallel misalignment PM and angularly misaligned by the misalignment angle β. However, due to the configuration of the interdigitated magnet holding members 1210 and 1310, a third torque T3 supplied to the first rotational member 1250 may be completely transferred to the second rotational member 1350 and transmitted to the second rotational member 1350 at a fourth torque T4.

In FIG. 40, the right side assembly 1300 may be spaced apart from an original orientation of the left side assembly 1200′ by an axial alignment distance Y2. Accordingly, the axial alignment distance Y2 may be varied (i.e., misaligned) by as much as 0.250 inches. Of course, in FIG. 40, the distance Y2, the misalignment angle β, and the parallel misalignment PM may be increased or decreased depending upon an overall size of the torque transfer system 1100, as well as the size of the magnets 1240 and 1340. Moreover, each of the physical dimensions of the individual components of the exemplary torque transfer system of FIG. 40 may be proportionally scaleable. Furthermore, an upper limit of the axial misalignment Y2 may be determined by the physical geometry of the magnets and/or the magnet holding members 1210 and 1310.

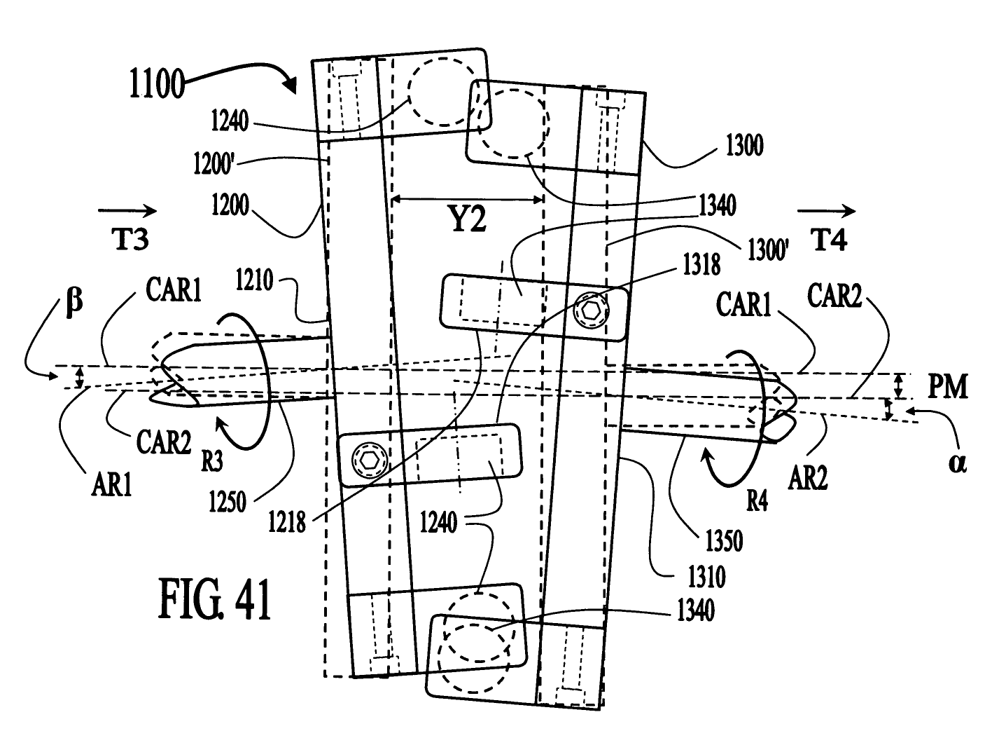

FIG. 41 is a side view of an exemplary torque transfer system operating in a third angular misalignment and parallel misalignment configuration in a reverse-convention mode of operation according to the present invention. FIG. 41 may include a combination of the angular misalignment configurations of FIG. 37 and the parallel misalignment configuration of FIG. 38. In FIG. 41, a left side rotary assembly 1200 may be coupled to a first rotational member 1250 to rotate along a third rotational direction R3 about a first axis of rotation AR1 angularly misaligned from a central axis of rotation CAR1 of the first axis of rotation AR1 by a misalignment angle β. In addition, a right side rotary assembly 1300 may be coupled to a second rotational member 1350 to rotate along a fourth rotational direction R4 about a second axis of rotation AR2 angularly aligned from a central axis of rotation CAR2 of the second axis of rotation AR2 by a misalignment angle a. Moreover, the central axis of rotation CAR1 of the first axis of rotation AR1 is parallel misaligned from the central axis of rotation CAR2 of the second axis of rotation AR2 by a parallel misalignment PM. For example, the parallel misalignment PM may be up to about 0.200″, and the misalignment angles α and β may both be within a range of more than 0° to about 12°.

In FIG. 41, although the parallel misalignment PM is shown such that the central axis of rotation CAR2 of the second axis of rotation AR2 is disposed above the central axis of rotation CAR1 of the first axis of rotation AR1, the parallel misalignment PM may include the central axis of rotation CAR1 of the first axis of rotation AR1 above the central axis of rotation CAR2 of the second axis of rotation AR2. Moreover, although the misalignment angle a may be shown to extend below the central axis of rotation CAR2 of the second axis of rotation AR2, the misalignment angle a may also extend above central axis of rotation CAR2 of the second axis of rotation AR2. Furthermore, although the misalignment angle β may be shown to extend below the central axis of rotation CAR1 of the first axis of rotation AR1, the misalignment angle β may also extend above central axis of rotation CAR1 of the first axis of rotation AR1. Accordingly, opposing magnet faces 1218 and 1318 (i.e., covered faces) of the left and right side assemblies 1200 and 1300, respectively, may similarly be parallel misaligned by the parallel misalignment PM and angularly misaligned by the misalignment angles α and β. However, due to the configuration of the interdigitated magnet holding members 1210 and 1310, a third torque T3 supplied to the first rotational member 1250 may be completely transferred to the second rotational member 1350 and transmitted to the second rotational member 1350 at a fourth torque T4.

In FIG. 41, an original orientation of the left side assembly 1200′ may be spaced apart from an original orientation of the right side assembly 1300′ by an axial alignment distance Y2. Accordingly, the axial alignment distance Y2 may be varied (i.e., misaligned) by as much as 0.250 inches. Of course, in FIG. 41, the distance Y2, the misalignment angles α and β, and the parallel misalignment PM may be increased or decreased depending upon an overall size of the torque transfer system 1100, as well as the size of the magnets 1240 and 1340. Moreover, each of the physical dimensions of the individual components of the exemplary torque transfer system of FIG. 41 may be proportionally scaleable. Furthermore, an upper limit of the axial misalignment Y2 may be determined by the physical geometry of the magnets and/or the magnet holding members 1210 and 1310.

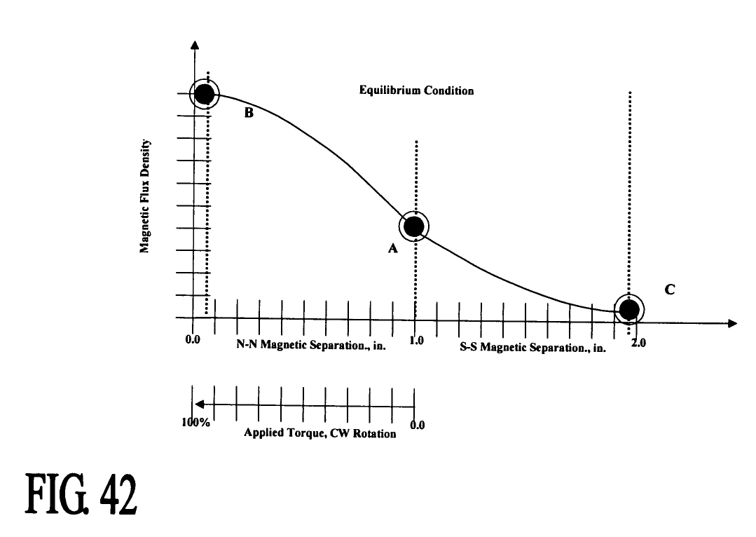

FIG. 42 is a graphical representation of the magnetic flux density as a function of magnet separation during a forward-convention mode of operation of an exemplary torque transfer system according to the present invention. In FIG. 42, at reference point B, a magnetic separation of N—N exposed magnetic faces of adjacent magnets is about 0.030 inches at a condition of maximum overload (i.e., 300%) applied torque for transfer between input and output shafts in the forward-convention mode of operation. Accordingly, the magnetic flux density between the North magnetic pole faces of adjacent magnets is also at a maximum.

Correspondingly, at reference point C in FIG. 42, a magnetic separation of S—S exposed magnetic faces of adjacent magnets is about 2.0 inches at a condition of maximum torque transfer between input and output shafts. Accordingly, the magnetic flux between the North magnetic pole faces of adjacent magnets is at a minimum. In other words, the magnetic flux density of the S—S exposed magnetic faces of adjacent magnets is insignificant (almost zero) to the transfer of applied torque between the input and output shafts in the forward-convention mode of operation.

Similarly, at reference point A in FIG. 42, a point of equilibrium exists under condition of minimum torque, such that both the N—N exposed magnet faces and S—S covered magnet faces of adjacent magnets is about 1.0 inches separation distance and the magnetic flux is similar.

Of course, the actual distances between the N—N exposed magnetic faces of adjacent magnets will be varied based upon an overall size of the torque transfer system, as well as the size and strength of the magnets used. Thus, the graphical representation of FIG. 42 shows that a maximum applied torque is transferred between input and output shafts when spacings between N—N exposed magnetic faces of adjacent magnets is minimized. Moreover, the graphical representation of FIG. 40 demonstrates that as the spacing between adjacent N—N exposed magnetic faces of adjacent magnets is increased, the applied torque decreases in a non-linear fashion such that a point of inflection exists a point where the adjacent N—N exposed magnetic faces of adjacent magnets are at a place of magnetic equilibrium. In other words, the point of inflection is a place of magnetic equilibrium where no torque is being applied to the input shaft.

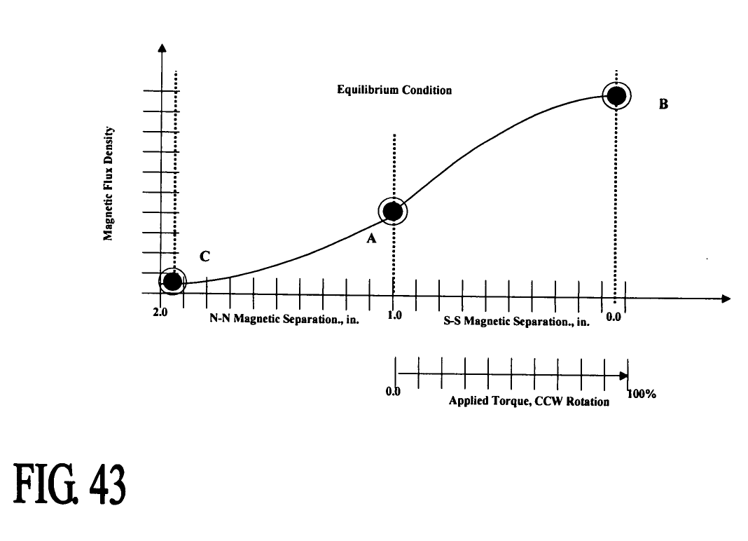

FIG. 43 is a graphical representation of the magnetic flux density as a function of magnet separation during a reverse-convention mode of operation of an exemplary torque transfer system according to the present invention. In FIG. 43, at reference point B, a magnetic separation of S—S covered magnetic faces of adjacent magnets is about 0.030 inches at a condition of about 300% applied torque for transfer between input and output shafts in the reverse-convention mode of operation. Accordingly, the magnetic flux density between the South magnetic pole faces of adjacent magnets is a maximum, such as the exemplary torque transfer system of FIG. 17 when Z2 is about 0.030 inches. In other words, when the S—S covered faces of adjacent magnets are almost touching, then the maximum magnetic flux density is achieved, and thus, 100% of the applied torque is transferred between input and output shafts.

Correspondingly, at reference point C, a magnetic separation of S—S covered magnetic faces of adjacent magnets is about 2.0 inches at a condition of no torque transfer between input and output shafts due to the interaction of the S—S covered magnet faces of the adjacent magnets. Accordingly, the magnetic flux between the South magnetic pole faces of adjacent magnets is a minimum, such as the exemplary torque transfer system of FIG. 17 when Z2 is about 2.0 inches. In other words, the magnetic flux density of the S—S covered magnetic faces of adjacent magnets is insignificant (almost zero) to the transfer of applied torque between the input and output shafts in the reverse-convention mode of operation.

Similarly, at reference point A, a magnetic separation of S—S exposed magnetic faces of adjacent magnets is about 1.0 inches at a condition of about minimum applied torque for transfer between input and output shafts in the reverse-convention mode of operation. Accordingly, the magnetic flux density between the South magnetic pole faces of adjacent magnets is a minimum, such as the exemplary torque transfer system of FIG. 17 when Z2 is about 1.0 inches.

Of course, the actual distances between the S—S covered magnetic faces of adjacent magnets will be varied based upon an overall size of the torque transfer system, as well as the size and strength of the magnets used. Thus, the graphical representation of FIG. 43 merely shows that a maximum applied torque may be transferred between input and output shafts when spacings between S—S covered magnetic faces of adjacent magnets is minimized. Moreover, the graphical representation of FIG. 41 demonstrates that as the spacing between adjacent S—S covered magnetic faces of adjacent magnets is increased, the applied torque decreases in a non-linear fashion such that a point of inflection exists a point where the adjacent S—S exposed magnetic faces of adjacent magnets are at a place of magnetic equilibrium. In other words, the point of inflection is a place of magnetic equilibrium where no torque is being applied to the input shaft.

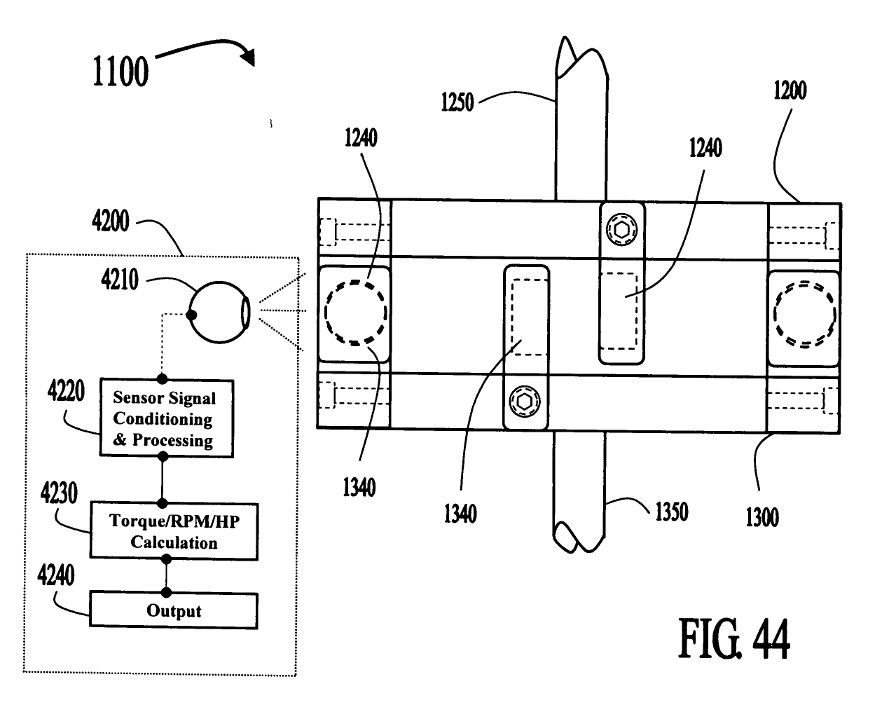

FIG. 44 is a schematic diagram of an exemplary monitoring system for a torque transfer system according to the present invention. In FIG. 44, performance parameters of a torque transfer system 1100 may be monitored using a monitoring system 4200. The monitoring system 4200 may include a sensor portion 4210, a signal conditioner and processor portion 4220, a calculator portion 4230, and an output portion 4240. The sensor portion 4210 may include a Hall Effect sensor or a solenoid pick-up to sense the magnets 1240/1340 as they pass by during rotation of the rotary plates 1200/1300. Accordingly, the frequency of the passing magnets 1240/1340 may be measured by a plurality of pulse signals, as well as the time between the passing magnets 1240 and 1340 may be measured by a plurality of pulse signals. Next, the pulse signals may be processed by the signal conditioner and processor portion 4220. Then, the processed pulse signals may be output to the calculator portion 4230 to continually calculate various performance parameters, such as torque and speed directly and horsepower via calculation, of the torque transfer system 1100.

In FIG. 44, the calculator portion 4230 may use the processed pulse signals to calculate torque being transmitted between the first and second rotational shafts 1250 and 1350. In addition, the processed pulse signals may be used to calculate revolutions per minute of the torque transfer system 1100, as well as to calculate horsepower. Finally, the calculated performance parameters may be output via the output portion 4240. The output performance parameters may be remotely sent to a control center to monitor the performance parameters of the torque transfer system 1100, or may be displayed directly adjacent to the torque transfer system 1100. Any significant changes in any of the torque, RPM, and/or horsepower may be indicative of problems associated with the torque transfer system 1100, or problems associated with the load and/or drive source connected to the torque transfer system 1100. Moreover, the performance parameters of the torque transfer system 1100 may be used as feedback for automated direct control of the load and/or drive source.

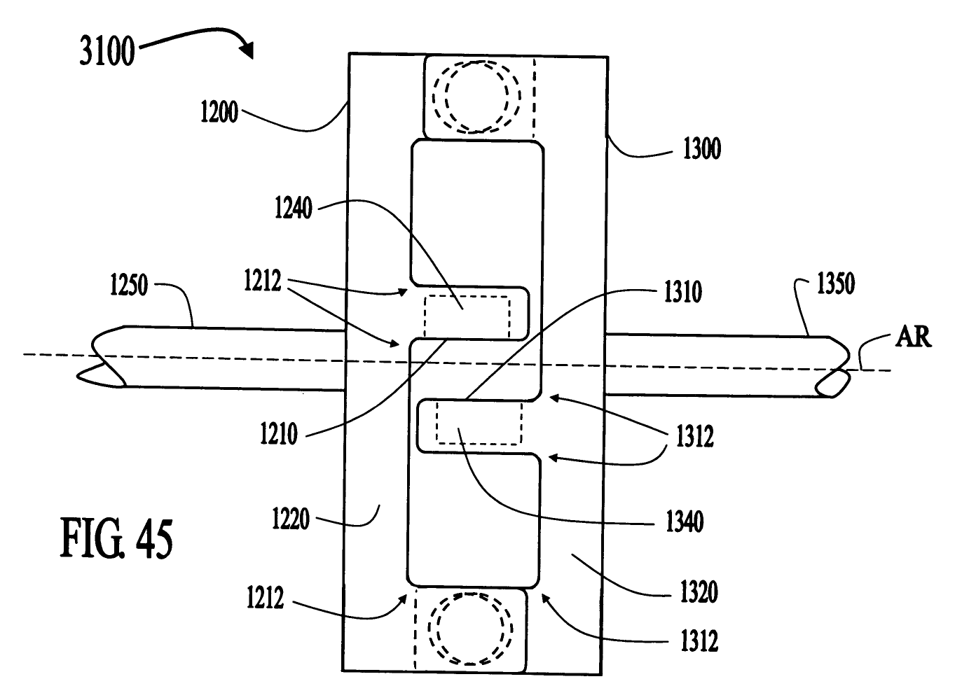

FIG. 45 is a side view of another exemplary torque transfer system according to the present invention. In FIG. 45, the exemplary torque transfer system 3100 may be similar to each of the torque transfer systems shown in FIGS. 17 and 28-41, including attachment to first and second rotational shafts 1250 and 1350. However, in FIG. 45, each of the rotary assemblies 1200 and 1300 may be formed as a unitary structure, wherein each of the fingers 1210 may be integrally formed with a body 1220 and each of the fingers 1310 may be integrally formed with a body 1320. Accordingly, in order to increase the structure integrity of the rotary assemblies 1200 and 1300 and to compensate for shearing forces imparted to the fingers 1210 and 1310, each of the fingers 1210 are formed with the body 1220 with fillets 1212 and each of the fingers 1310 are formed with the body 1320 with fillets 1312.

In FIG. 45, each of the rotary assemblies 1200 and 1300 may be formed from a single non-magnetic material, such as polymers, aluminum, and carbon fiber. Accordingly, each of the rotary assemblies 1200 and 1300 may be cast, machined, or fabricated using a single material. In addition, each of the magnets 1240 and 1340 may be bonded into the fingers 1210 and 1320 after machining of the rotary assemblies 1200 and 1300, or may be molded into the fingers 1210 and 1310 during casting or fabrication of the rotary assemblies 1200 and 1300. Moreover, although round magnets 1240 and 1340 are shown, other magnet geometries may be used. Furthermore, any of the finger/adapter configurations, as shown in FIGS. 25A-C and 27A-D, may be used. Thus, one rotary assembly 1200/1300 may be fabricated, whereby the specific geometry of the magnets 1240/1340 may be provided mounted within the fingers 1210 and 1310 using one the adapters shown in FIGS. 25A-C and 27A-D.

According to the present invention, each of the magnets may be relatively high powered magnets, such as neodymium-iron-boron (NdFeB) magnets. However, other magnet materials may be implemented, as well as geometries other than circular and rectilinear shapes. For example, oval magnet geometries may be implemented, as well as mixtures of different geometries. Furthermore, each of the magnets may be energized prior to mounting within the fingers of the rotary assemblies. Alternatively, each of the magnets may be mounted within the finger of the rotary assemblies in a relatively unenergized state (i.e., not magnetized or not significantly magnetized to constitute a magnet). Accordingly, the un-energized magnets may be subsequently energized after the rotary assemblies have been constructed. Thus, mounting un-energized magnets may reduce and simplify construction of the rotary assemblies.

According to the present invention, magnets are provided on an end regions of finger structures that are coupled, or integrally formed with, rotary plates. However, each of the single magnets, i.e., circular, square, or rectangular, may be substituted with a plurality of smaller magnet geometries to achieve the same magnetic strength as the single magnets. For example, since the present invention is proportionally scalable, if the torque transfer system is relatively large, and a corresponding size of magnets is unavailable, then a plurality of smaller magnets may be provided with the finger structures to achieve the necessary proportional magnet strength of the torque transfer system.

According to the present invention, the rotary plates of the exemplary torque transfer systems may be fabricated from non-magnetic material(s), such as polymers, metals or metal alloys, or carbon fiber/composites. In addition, each of the fingers may be fabricated from a first non-magnetic material that may be different from the non-magnetic material(s) of the rotary plates.

According to the present invention, any or all of the magnet holding members of the exemplary torque transfer systems may be interchanged without decoupling the rotary assemblies from the rotational shafts. Thus, depending upon the estimated required torque to be transferred from the rotational shafts, an operator could simply replace any or all of the magnet holding members to accommodate the estimated change in required torque. For example, if the rotational shaft 1250 (in FIG. 8) was connected to a first load (machine) having a first required torque for operation, and the load was to be substituted for a second load (machine) having a second required torque for operation, then an operator could simply change the magnet holding members having the magnets for other magnet holding members having magnets of a second magnetic strength to accommodate for the change in the required torque of the second load. Accordingly, the “down time” for the first load may be significantly reduced over the known method of completely dismantling the entire coupling system to change-out different loads, and thereby, increase productivity and reduce costs.

According to the present invention, since the magnets of the exemplary torque transfer systems are placed with facing like poles to produce magnetic repulsive forces, then the strength of the bonding/attachment of the individual magnets within the magnet holders may be increased. In other words, the magnets may be further seated within each of the magnet holding members due to the repulsive forces between the magnets. Accordingly, the problem of the magnets being drawn out of the magnet holding members is rendered moot. Thus, the potential danger of the magnets energetically discharging from the magnet holding members during operation of the torque transfer system is significantly reduced, if not completely mitigated.

As shown in FIG. 8, for example, the torque transfer system 1100 includes the left and right side rotary plates 1200 and 1300 disposed in an interdigitated configuration, wherein the magnet holding members 1210 and 1310 are disposed in repulsing pairs. However, in order to dispose the left and right side rotary plates 1200 and 1300 in the interdigitated configuration, the left and right side rotary plates 1200 and 1300 must be forced into position due to the repulsion forces of each of the repulsing pairs of magnets 1230 and 1330. Accordingly, before the torque transfer system 1100 may be installed into an actual torque transferring mode between the rotational shafts 1250 and 1350, the left and right side rotary plates 1200 and 1300 must be assembled together. Thus, an apparatus may be used to assemble the left and right side rotary plates 1200 and 1300.

Although not shown, the left and right side rotary plates 1200 and 1300 may be pressed together using a system of guide rods inserted into the alignment holes 130, in FIG. 1, to ensure that each of the magnet holding members 1210 and 1310, in FIG. 8, are properly interdigitated to align the magnets 1230 and 1300. Accordingly, once the left and right side rotary plates 1200 and 1300 have been assembled, the guide rods may be locked into position, and the assembled torque transfer system 1100 may be installed. Once the torque transfer system 1100 has been installed and attached to the rotational shafts 1250 and 1350, or to additional coupling mechanisms, then the guide rods may be unlocked and removed from the alignment holes 130, in FIG. 1. Since the magnetic strength of the individual magnets is very powerful, the amount of force necessary to disassemble the torque transfer system 1100 is similarly very large. Accordingly, the torque transfer system 1100 may be considered a stable configuration once installation has been successfully completed.

According to the present invention, the exemplary torque transfer systems may be operated in a forward-convention mode, wherein exposed faces of adjacent magnets may repel each other, and may be operated in a reverse-convention mode, wherein covered faces of adjacent magnets may repel each other. Thus, when the exemplary torque transfer systems of the present invention operate in either one of the forward-convention mode or the reverse-convention mode, a sudden decrease (or instant stop) of the applied rotational torque will prevent any damage to the magnet holding members due to the repulsive magnetic forces implemented during the forward- and reverse-convention modes. Accordingly, the exemplary torque transfer systems of the present invention include an inherent operational safety due to use of the repulsive magnetic forces.

According to the present invention, since the physical dimensions of the individual components of the exemplary torque transfer systems may be varied based, among many things, the overall size of the torque transfer system, as well as the power of the individual magnets, the total number of magnet holding members may be increased or decreased depending on a desired transmitted torque and horsepower. Accordingly, although the exemplary rotary assemblies are shown having eight magnet holding members, other rotary assemblies may be contemplated.

According to the present invention, since the physical dimensions of the individual components of the exemplary torque transfer systems may be varied based, among many things, the overall size of the torque transfer system, as well as the power of the individual magnets, the total number of magnet holding members may be increased or decreased depending on a desired transmitted torque and horsepower. Accordingly, although the exemplary rotary assemblies are shown having eight magnet holding members, other rotary assemblies may be contemplated. For example, without limiting to the present invention, a rotary plate having a major diameter on a micrometer scale may have magnet holding members to transmit a torque and horsepower on a corresponding scale. Moreover, according to the present invention, a torque transfer system may be fabricated on a nanometer scale for medical applications, such as vascular procedures and medicine delivery platforms. Accordingly, fabrication of the torque transfer systems may be fabricating using known semiconductor manufacturing techniques, such as deposition, implantation, and lithography processes.

It will be apparent to those skilled in the art that various modifications and variations can be made in the torque transfer system of the present invention without departing from the spirit or scope of the invention. Thus, it is intended that the present invention cover the modifications and variations of this invention provided they come within the scope of the appended claims and their equivalents.

1. A system for transferring torque, comprising:
a first rotary plate coupled to a first rotational shaft extending along a first axial direction from a first plane of rotation of the first rotary plate, the first rotary plate having a plurality of first magnet holding members holding a plurality of first magnets; and
a second rotary plate coupled to a second rotational shaft disposed along a second axial direction from a second plane of rotation of the second rotary plate, the second rotary plate having a plurality of second magnet holding members holding a plurality of second magnets and being spaced apart from the first rotary plate,
wherein the first rotary plate is magnetically coupled to the second rotary plate by magnetic fields between the first magnets and the second magnets, such that the torque applied to one of the first rotational shaft and the second rotational shaft is transferred to the other of the first rotational shaft and the second rotational shaft.

2. The system according to claim 1, wherein the first rotary plate includes a plurality of first mounting regions for mounting the first magnet holding members to the first rotary plate.

3. (canceled)

4. The system according to claim 2, wherein the second rotary plate includes a plurality of second mounting regions for mounting the second magnet holding members to the second rotary plate.

5. (canceled)

6. The system according to claim 4, wherein each of the first magnet holding members has a first end attached to one of the first mounting regions and a second end which extends from the first rotary plate toward the second rotary plate, and
each of the second magnet holding members has a first end attached to one of the second mounting regions and a second end extending from the second rotary plate.

7. The system according to claim 6, wherein the second ends of the first magnet holding members hold the first magnets and the second ends of second magnet holding members hold the second magnets.

8. The system according to claim 7, wherein each of the first magnets induces a repulsive force to at least one of the second magnets to provide the magnetic coupling of the first and second rotary plates.

9. (canceled)

10. The system according to claim 1 wherein opposing face portions of the first and second magnets are spaced apart from one another.

11-17. (canceled)

18. A torque transfer system, comprising:
a first rotary plate coupled to a first rotational shaft extending along a first axial direction from a first plane of rotation of the first rotary plate, the first rotary plate having a plurality of first magnet holding members extending from the first rotary plate, each first magnet holding member holding a first magnet; and
a second rotary plate coupled to a second rotational shaft disposed along a second axial direction from a second plane of rotation of the second rotary plate, the second rotary plate having a plurality of second magnet holding members extending from the second rotary plate toward the first rotary plate, each second magnet holding member holding a second magnet,
wherein the first and second rotary plates are spaced apart from each other, the first and second magnet holding members are interdigitated, and a torque applied to the first rotational shaft is transferred to the second rotational shaft by repulsive magnetic forces between the first and second magnets.

19-23. (canceled)

24. The system according to claim 10, wherein the face portion of each of the first magnets opposes the face portion of one of the second magnets at a position exterior to an outer perimeter of the first rotary plate and an outer perimeter of the second rotary plate.

25. The system according to claim 10, wherein the face portion of each of the first magnets opposes the face portion of one of the second magnets at a position within the second plane of rotation.

26. (canceled)

27. The system according to claim 132, wherein the second end of each of the second magnet holding members holds a fourth magnet.

28-29. (canceled)

30. The system according to claim 7, wherein each of the first magnets opposes one of the second magnets and each of the third magnets opposes one of the fourth magnets, providing the repulsive magnetic forces between the first and second magnet holding members.

31-36. (canceled)

37. The system according to claim 1, wherein each of the first magnets opposes one of the second magnets at a position exterior to an outer perimeter of the first rotary plate and exterior to an outer perimeter of the second rotary plate.

38-90. (canceled)

91. A method of transferring torque, comprising:
rotating a first rotary assembly about a first rotational axis within a first plane of rotation, the first rotary assembly including a first plurality of magnets extending from the first plane of rotation; and
providing a second rotary assembly rotatable about a second rotational axis within a second plane of rotation, the second rotary assembly including a second plurality of magnets extending from the second plane of rotation,
wherein the first plurality of magnets are interdigitated with the second plurality of magnets in opposition to produce a plurality of repulsive magnet forces between the first and second pluralities of magnets to transfer the torque from the first rotary assembly to the second rotary assembly.

92-103. (canceled)

104. The apparatus system according to claim 6, wherein each of the first magnet holding members includes a chambered edge at the second end, and each of the second of magnet holding members includes a chambered edge at the second end.

105-117. (canceled)

118. An apparatus for monitoring performance parameters of a system for transferring torque, the apparatus comprising:
a sensor portion for positioning adjacent to the system for transferring torque, the system including:
a first rotary plate coupled to a first rotational shaft extending along a first axial direction from a first plane of rotation of the first rotary plate; and
a second rotary plate coupled to a second rotational shaft disposed along a second axial direction from a second plane of rotation of the second rotary plate, the second rotary plate spaced apart from the first rotary plate,
wherein the first rotary plate is magnetically coupled to the second rotary plate by respective magnet holding members on each of the first rotary plate and the second rotary plate, such that the torque applied to one of the first rotational shaft and the second rotational shaft is transferred to the other of the first rotational shaft and the second rotational shaft;
a sensor signal processor for conditioning and processing an output of the sensor;
a calculator portion for calculating performance parameters of the torque transfer system using the processed output of the sensor; and
an output portion for outputting the calculated output of the sensor,
wherein the sensor measures a passing of the magnet holding members as the first and second rotational shafts rotate.

119. The apparatus according to claim 118, wherein the sensor includes a Hall Effect sensor or a solenoid pick-up sensor.

120. The apparatus according to claim 118, wherein the performance parameters include the torque, RPM, or horsepower.

121. (canceled)

122. A method of fabricating a system for transferring torque, comprising:
forming a first rotary plate having
a plurality of first magnet holding members, each first magnet holding member extending from the first rotary plate along a first direction, and
a plurality of first locating and retaining features;
forming a second rotary plate having
a plurality of second magnet holding members, each second magnet holding member extending from the second rotary plate along a second direction and
a plurality of second locating and retaining features; and
assembling the first rotary plate with the second rotary plate using the first and second locating and retaining features.

123-127. (canceled)

128. The method according to claim 122, further comprising
providing an un-energized magnet at an end region of each of the first and second magnet holding members; and
energizing the magnets before the step of assembling the first and second rotary plates.

129-130. (canceled)

131. The system according to claim 6, wherein the second ends of the second magnet holding members extend from the second rotary plate toward the first rotary plate.

132. The system according to claim 131, wherein the second end of each of the first magnet holding members holds a third magnet.

133. The system according to claim 1, wherein the first magnet holding members are replaceably detachable from the first rotary plate and the second magnet holding members are replaceably detachable from the second rotary plate.

134. The method according to claim 91, wherein the first rotary assembly has a first rotary plate and the second rotary assembly has a second rotary plate, the method further comprising
providing the first rotary plate with a plurality of first mounting regions;
providing the first rotary assembly with a plurality of first magnet holding members, each of the first magnet holding members holding one of the first magnets, each of the first magnet holding members having a first end attached to one of the first mounting regions and a second end which extends from the first rotary plate toward the second rotary plate;
providing the second rotary plate with a plurality of second mounting regions; and
providing the second rotary assembly with a plurality of second magnet holding members, each of the second magnet holding members holding one of the second magnets, each of the second magnet holding members having a first end attached to one of the second mounting regions and a second end extending from the second rotary plate.

135. The method according to claim 122, wherein the first locating and retaining features are holes in the first rotary plate, the second locating and retaining features are holes in the second rotary plate, and the first and second rotary plates are assembled by temporarily placing rods through corresponding pairs of the first and second locating and retaining features.
